(19) United States
(12) Patent Application Publication
(10) Pub. No.: US 2005/0256802 A1
(43) Pub. Date: Nov. 17, 2005

(54) Payment protocol and data transmission method and data transmission device for conducting payment transactions

(76) Inventors: Dirk Ammermann, Bellheim (DE); Gero Offer, Stuttgart (DE); Andreas Marra, Stuttgart (DE); Stephan Kruppa, Stuttgart (DE); Denis Bouceka, Stuttgart (DE); Andreas Schulze, Stuttgart (DE); Damian Hackett, Omagh (GB); Bernd Biechele, Stuttgart (DE); Manfred Mannle, Stuttgart (DE); Holger Zimmermann, Hartha (DE); Ove Blumert, Bernhausen (DE); Michael Weber, Reutlingen (DE); Lysann Most, Markt Schwaben Feder (DE); Frank Kohntopp, Hochstetten-Dhann (DE)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 10/495,221

(22) PCT Filed: Nov. 14, 2002
(86) PCT No.: PCT/EP02/12782

§ 371 Date: Apr. 18, 2005

Related U.S. Application Data
(60) Provisional application No. 60/389,617, filed on Jun. 17, 2002.

(30) Foreign Application Priority Data
Nov. 14, 2001 (EP) 01127042.8
Mar. 13, 2002 (EP) 02005762.6
Mar. 13, 2002 (EP) 02005763.4
May 8, 2002 (EP) 02010457.6

(51) Int. Cl. G06F 17/60

(52) U.S. Cl. 705/44

(57) ABSTRACT

Method for carrying out a transaction on a system that includes at least one central processing platform, at least issuer server and at least one acquirer server, wherein the central processing platform includes a routing engine coupled by a communication connection to the issuer server and the acquirer server, and the method includes the steps of receiving a transaction inquiry at the acquirer server or the issuer server, routing of the inquiry from the acquirer server or from the issuer server to the central processor platform, and operating the central processor platform, in order to implement the transaction.

### CROSS REFERENCE TO RELATED APPLICATIONS

This application claims the benefit of European Patent Application Serial No.: 01127042.8, filed Nov. 14, 2001; of European Patent Application Serial No.: 02005762.6, filed Mar. 13, 2002; of European Patent Application Serial No.: 02005763.4, filed Mar. 13, 2002; of European Patent Application Serial No.: 02010457.6, filed May 8, 2002; of International Patent Cooperation Treaty Patent Application, Serial No.: PCT/EP02/12782, filed, Mar. 14, 2002; and of U.S. Provisional Patent Application, Ser. No.: 60/389,617, filed Jun. 17, 2002, which are all hereby incorporated by reference in their entirety.

### BACKGROUND OF THE INVENTION

This invention relates substantially to payment systems and in particular to a protocol for organizing the transmission of messages between several wallet servers and payment servers of many different offerers.

Merchants and service suppliers are becoming involved to an ever greater extent in business transactions that are carried out over multiple channels. In the traditional situation, for instance, a customer visits a shop, selects the objects to be purchased, and checks out, i.e. buys the objects at the merchant's cash register. The customer typically pays for the objects in cash or by credit card or check.

However, in principle it is possible for a merchant to increase turnover by improving customer convenience during the purchase of merchandise and services. For example, customers who order objects over the internet may also want use the internet to complete the whole transaction. The fact that customers can purchase merchandise over the internet with no need to make a physical visit to a shop can benefit the merchant by increasing turnover and creating more good will. However, if the transaction is not implemented correctly and on time, the merchant can suffer a loss of both turnover and good will.

Another means by which a merchant can be more customer-friendly is to enable customers to make purchases even when they are not currently in possession of cash, a credit card or a check. For instance, known systems allow a customer to complete purchases by means of wireless devices (e.g., a mobile telephone or a PDA (personal digital assistant)). As in the case of the internet, making such conveniences available to the customers can enhance both turnover and good will—but again, if the transaction is not implemented correctly and on time, turnover and good will may be sacrificed.

Therefore merchants would usually like to give customers several payment options and several forms of access, by way of which merchandise and services can be bought. These merchants, however, are hesitant to offer such flexibility until they are sure that the transaction can be completed correctly and on time.

Furthermore, some systems for implementing transactions are out of date, and considerable investments are needed to reconstruct the old system infrastructure.

Merchants are typically reluctant to invest in systems that make it necessary to replace such old elements, if too much expenditure of time is required to achieve a return on such investments. This means that when a merchant must replace an existing old system by a completely new system in order to enable payments by way of a wireless device, the merchant will not be willing to undertake such an investment.

### BRIEF DESCRIPTION OF THE INVENTION

The invention is thus directed toward the objective of disclosing a method and an arrangement for simplifying the organization of payment transactions by employing a telecommunications network that complies with the legal regulations that apply in various countries and conforms to the established and approved payment sequences for financial transactions.

To a considerable extent private payment processes carried out by way of a commercial service provider must also conform to these established rules. There is an increasing need for organization of such private payment processes with the most modem technical means that is, in particular by way of the Internet and/or telecommunications networks especially in connection with the further implementation of electronic monetary transactions and with the non-commercial sale of products or services (including information) between private parties. The data-transfer methods for this purpose that have been previously proposed, some of which have also tentatively been applied in practice, are not yet suitable because they are insufficiently reliable and secure and/or are too inconvenient to satisfy an appropriately large number of users.

The invention is thus also directed toward the objective of disclosing a method and an arrangement to simplify the organization of private payment transactions (P2P =person to person) by way of a telecommunications network that complies with the legal regulations that apply in various countries and conforms to the established and approved payment sequences for financial transactions.

In one respect the present invention relates to a protocol for carrying out transactions between several customers and merchants. The protocol controls the flow of messages and the performance of instructions contained in these messages by way of a payment system that enables conventional as well as unconventional payment methods. The protocol offers a large number of advantages including the fact that complex transactions can be concluded in a reasonable amount to time and with the customer undergoing an acceptable experience.

In particular, and in a specific embodiment, the protocol comprises various subprotocols. Each subprotocol has its own specified scope, and is clearly delimited from other subprotocols. In one exemplary embodiment the protocol contains two subprotocols. One subprotocol is the wallet server, central processing platform and payment server protocol, sometimes also called the interoperable mobile payment protocol (IMPP). The other subprotocol is the payment server and merchant server protocol, sometimes also called the open payment protocol (OPP). The OPP controls the information exchange between a wallet server, a merchant system and a payment server. In the exemplary embodiment a merchant system can alternatively have access to a payment server by way of the merchant API rather than by way of the OPP.

The IMPP is supported by a central processing platform (CPP), which utilizes a central element for routing messages and other payment-related processing. The CPP administers central offer data and in certain scenarios finds out the wallet server of a customer while payment is being initiated. Furthermore, the CPP makes available the routing of payment messages in both directions between a wallet server and a payment server.

The wallet server contains core customer data that are required for authentication and payment, as well as a transaction history. In agreement with the IMPP the wallet server is triggered during the payment-initiation phase, and subsequently sends payment messages to the payment server through the CPP. If the transaction state at an acquirer changes, the payment server sends notification messages to the wallet server through the CPP. Moreover, each party can send request messages in order to update and check the state of a transaction.

The payment server holds the core customer data related to payment as well as transaction-history data. The payment server also receives payment messages from the CPP and processes these messages. In particular, the payment server in agreement with the IMPP sends a message to the authorized participants on the acquirer side and communicates the result to the CPP and the merchant system. The payment server sends and receives the required information to/from the merchant system during the various phases of the payment process.

Not all transaction-related messages and message attachments are stored in each of the three servers, i.e. the wallet server, the payment server and the CPP. For instance, data on generation of the OfferID are stored only in the CPP.

The term “merchant system” refers to a shopping system (e.g., a commercially available merchandising (commerce) server) and payment plug-in components that are available in a local merchant domain of a payment system conforming to a 3D model. In agreement with the OPP the merchant system sends and receives the required information to/from the payment server during the various phases of the payment process. The transfer of messages between the CPP and the payment server is mediated by the IMPP.

The IMPP makes it easier for merchants and customers know what options are available for making payments reliably, correctly and on time by employing mobile devices. In addition, it enables integration with existing older systems by providing a gateway through which standardized, open protocols (e.g., the IUTP protocol) can be used to communicate with the system. For instance, the gateway uses the IUTP protocol to translate IUTP messages into IMPP messages and data flows. Therefore merchants do not need to replace older systems and can simply plug into the platform on which the IMPP is implemented.

In a further aspect the invention includes the essential idea of disclosing a substantially universal payment method based on a conventional bank account (“postpaid”) or electronic balance (“prepaid”), which in particular can be used for organizing payment in the so-called B2C (business to consumer) area as well as in the P2P (person to person) area. That is, it enables purchasing in real and virtual businesses, payments to gastronomic or cultural installations etc., and the “transmission” of monetary amounts between private individuals.

It also includes the idea that for this purpose the possibilities presented by a telecommunications network can be exploited, in particular the possibility of organizing widely distributed procedures in almost real time. The invention also incorporates the central idea of making available and employing an unambiguous identification code—the offer identifier—which identifies the merchandise or services made available by an offerer (in particular, a whole “shopping basket”) to assist the subsequent progress through all the data-transfer and processing events associated with the offer and the payment therefor, in particular the reliable authorization of payment.

In a first embodiment of the invention the generation of the offer identifier (OfferID) does not involve any specification of a duration of validity, so that the identifier is potentially indefinitely valid. For this situation the term “static OfferID” can be used. It is employed in particular to pay for merchandise or services offered for sale on television channels (“TV shopping”) and for the products sold at vending machines (VM) by way of a telecommunications network employing a telecommunications terminal.

In an alternative embodiment of the invention, along with generation of the offer identifier a duration of validity is specified, at the end of which the OfferID is automatically rendered invalid. In this case the term “dynamic OfferID” is appropriate. It can be used for various other purchasing and payment events, in particular for individual purchasing situations in virtual shopping sites or real shops or warehouses.

In both cases the OfferID can be cancelled or destroyed on demand by the offerer of the merchandise or services. In order to make the OfferID invalid, either when its validity duration has expired or on demand of the offerer, an elimination signal is sent to the offerer as notification that the identifier in question is no longer valid.

The transfer of information about the OfferID to the—potential—purchaser or customer occurs in a first variant as an invariant optical display, in particular as lettering on a show-window display or vending machine or printed in a prospectus, catalogue or the like. In other variants the OfferID is communicated to potential purchasers as a variable optical display on an electro-optical display device, or by spoken output or an acoustic signal. These different kinds of communication allow for the specific purchasing situations in industrialized society, where the traditional method of buying from a shop or from vending machines, which are used in particular to sell drinks, cigarettes and sweets, has long since been joined by internet and TV shopping.

For most of the existing commercial channels it is advantageous for the OfferID to be transmitted during its period of validity to a large number of potential purchasers in a broadcast procedure apart from the telecommunications network, in particular by radio or television or by sending out or distributing printed documents or by e-mail broadcasting. Recently, however, the possibilities for obtaining merchandise or services (information!) offered directly by way of a telecommunications network have become considerably more significant. In a variant that is advantageous for this purpose the OfferID is transmitted, in particular in a broadcast procedure, as a short message or by WAP, through the telecommunications network to the telecommunications terminal of the purchaser and displayed there.

Preferably the steps involved in requesting an OfferID from the offerer and in sending it to the offerer or merchant proceed as substantially automated data transfers between the system-management server and a merchant server or offerer data terminal, by way of a data and/or telecommunications network, in particular the internet. This applies both to internet shopping and also to making use of the proposed system by way of “classical” installations.

In a typical scenario, after the step of transmitting the OfferID to the purchaser, the OfferID is transmitted by the purchaser over the telecommunications network to a customer server of the network operator or a service provider in the telecommunications network, then a request message to obtain a binding offer is sent through the customer server, service-provider server or merchant server to the offerer, an offer data set is sent by the offerer to the customer server and the offer data set is transmitted from the customer server to the telecommunications terminal of the potential purchaser, where it is displayed under menu guidance to confirm the transaction. In this process the data transfer involved in the steps of requesting a binding offer and transmission of the offer data is performed by way of the system-management server, which in particular carries out search and routing functions between network operator or service provider and offerer.

The OfferID can be generated entirely by a suitable generator in a system-management server belonging to the proposed system, but alternatively It can also be generated entirely externally and in the course of the request be transmitted from the offerer to the system management server for confirmation. In particular for “catalogue” offerers an advantageous variant is one in which the OfferID comprises a first and a second section, such that the first section identifies the offerer and is generated on managed by the system-management server and the second section identifies the merchandise or group of merchandise and is generated or managed by the offerer, and the method comprises transmission of the second section to the system-management server, linkage of first and second sections in the system-management server, and sending the entire OfferID to the purchaser or confirming it with respect to the purchaser.

Thus “number strips”, so to speak, can be allocated to the offerer, so that the offerer's own catalogue number can continue to be used, after a section (the prefix) that represents the offerer's identity. By this means the employment of OfferID in the case of catalogue scenarios can be considerably simplified. The combination of the first section (prefix) with the second section (catalogue number) can—after assignment of the prefix by the system management—also be done by the offerer itself, in which case the offerer of course is responsible for making sure that the OfferID is unambiguous.

Customarily a purchaser who has been informed about the OfferID will input it himself, either manually at his telecommunications terminal or, where appropriate, also by speaking. The above-mentioned possibilities for output of the identifier to the purchaser can, however, feed into an automatic input procedure, which of course is more resistant to error than a manual input. For this purpose, in or at the purchaser's telecommunications terminal and in particular by a camera or scanner connected thereto, the identifier is converted from an optical or acoustic signal into an electrical signal.

The essential aspects of the apparatus in accordance with the invention and their advantageous further developments can largely be derived from the methodical aspects explained above inasmuch as they represent system structure, so that they need not be explained again in detail here.

With respect to organization, the proposed system can be implemented in a plurality of different configurations, which technically are fundamentally centered around a system-management server with which are normally associated a customer server (in the following also termed Valid Server) and a merchant server (or Payment Server), and to which these are connected by way of information-transfer channels. When reference is made to “a” merchant or customer server in this connection, in the following this should be understood to also include a plurality of servers belonging to various service providers, financial institutions etc., which have a corresponding function In the overall system.

In a first version of the system, all the above-mentioned servers belong to a telecommunications company or client-oriented service provider, which connects both offerer and purchasers to the system. In a second system configuration the telecommunications company (hereinafter also abbreviated to “Telco”) or customer service provider likewise operates customer and merchant servers, but the system-management server is operated by a separate company (hereinafter also termed “OpCo”) and is needed substantially only for generating the OfferID and determining which of the merchant servers is involved at any time. The items of information relevant to associating with one another the merchant and customer servers involved in a particular transaction are in this case situated in particular in the system-management server.

In a third configuration there are separate customer and merchant service providers, each of which operates only the associated server, whereas the system-operating company (OpCo) operates the system-management server. In this case a first scenario is conceivable in which (as in the previously mentioned variant) the system-management server generates or confirms substantially only the OfferID, and later finds out the merchant server. In a second scenario the system-management server is substantially responsible for the transaction regarding the technology for processing as well as transmission. Finally, a system configuration is also reasonable in which the operating company operates both the system management server and the merchant server, while only customer servers are operated by the TeICo or customer service provider.

The second and third of the system configurations given above, in which there is an independent system-management company and hence a so-called “OpCo domain”, are advantageous for implementing a very large, in particular global system that binds together very many offerers and purchasers. That is, they enable centralized storage of the relevant data (OfferID and server addresses) for a very large number of users, who engage in electronic transactions by way of many merchant servers and/or customer servers.

To implement one of its most important functions, the system-management server has a code generating unit to generate the OfferID in response to a received request and a code-sending device to transmit the generated OfferID directly or indirectly to the offerer terminal from which the request originated. In a modification of a special kind of procedure already mentioned above (“catalogue offerer”) the code-generating unit serves merely to generate a first identifier section, which identifies an offerer, and in a second modification instead of the code generating unit means are provided to receive an externally generated code and check that it contains no ambiguities as well as to send out a confirmation signal to confirm that an externally generated OfferID is unambiguous (and hence usable).

Especially for generating and manipulating the above-mentioned dynamic OfferID, the system-management server has timing means associated with the code-generating unit and duration-memory means to assign a duration of validity to every OfferID and store it, as well as a duration-comparator unit connected to the timing means and duration memory, which checks whether an assigned period of validity has reached its end and sends out an elimination signal to invalidate the OfferID when it has expired. When static OfferIDs are used, of course, these components are replaced by an erasure unit that responds to an erasure demand of external origin by eliminating the identifier.

Mother essential functional component of the proposed system architecture is a data filing system (OfferID repository) to store and manage all valid OfferIDs and items of information associated therewith in the system, in particular data relevant to payment transactions and the codes that identify data-transfer events that have occurred. With its help, for example, it is possible to find out which customer/merchant servers were responsible for each transaction. The components for managing dynamic OfferIDs mentioned in the preceding paragraph, which in that case were assigned to the system-management server, can also be assigned to the repository. To the telecommunications network are connected, according to another essential aspect of the invention, on one hand the telecommunications terminals of the purchasers or customers using the network and, on the other hand, at least one customer server belonging to the operator of the network or to a customer-oriented service provider. The invention further includes the idea that a system-management server is made available for managing and routing the data needed for a transaction with reference to both the purchaser and the offerer side, which by way of the network is coupled to at least one merchant server of a merchant-oriented service provider. Here it will typically be a matter of data-network connections, which can—but need not necessarily—be coupled to the telecommunications network for connecting the customers. Finally, the invention incorporates the idea of making available suitable data-traffic-conducting means, for routing the data sets that are to be exchanged between the participants in the course of offer and payment processes.

The main component of the proposed system is thus a system-management server, which in a sensible practical design is connected, substantially permanently, to a plurality of customer servers in several telecommunications networks, in particular mobile wireless networks. In addition, in a practicable system configuration the system-management server can be connected to a plurality of merchant servers, each of which in turn is or can be connected to a plurality of offerer terminals, and it comprises a merchant memory to store the identification and address data of the attached offerers.

In another preferred embodiment the system-management servers and/or the merchant server or servers are disposed in a telecommunications network, in particular mobile wireless network, and one or several of them form a functional unit with the customer server or servers.

With respect to organization, the proposed system can otherwise be implemented in a plurality of different configurations, which technically are fundamentally centered around a system management server with which are normally associated a customer server (in the following also termed Valid Server) and a merchant server (or payment server), and to which these are connected by way of information-transfer channels. When reference is made to “a” merchant or customer server in this connection, in the following this should be understood to also include a plurality of servers belonging to various service providers, financial institutions etc., which have a corresponding function in the overall system.

In a first version of the system, all the above-mentioned servers belong to a telecommunications company or customer-oriented service provider, which connects both offerer and purchasers to the system. In a second system configuration the telecommunications company (hereinafter also abbreviated to “Telco”) or customer service provider likewise operates customer and merchant servers, but the system-management server is operated by a separate company (hereinafter also termed “OpCo”) and is needed substantially only for generating the OfferID and determining which of the merchant servers is involved at any time. The items of information relevant to associating with one another the merchant and customer servers involved in a particular transaction are in this case situated in particular in the system-management server.

In a third configuration there are separate customer and merchant service providers, each of which operates only the associated server, whereas the system-operating company (OpCo) operates the system-management server. In this case a first scenario is conceivable in which (as in the previously mentioned variant) the system-management server generates or confirms substantially only the OfferID, and later finds out the merchant server. In a second scenario the system-management server is substantially responsible for the transaction regarding the technology for processing as well as transmission. Finally, a system configuration is also reasonable in which the operating company operates both the system-management server and the merchant server, while only customer servers are operated by the Telco or client-service provider.

The second and third of the system configurations given above, in which there is an independent system-management company and hence a so-called “OpCo domain”, are advantageous for implementing a very large, in particular global system that binds together very many offerers and purchasers. That is, they enable centralized storage of the relevant data (OfferID and server addresses) for a very large number of users, who engage in electronic transactions by way of many merchant servers and/or customer servers.

To implement one of its most important functions, the system-management server has a code generating unit to generate the OfferID in response to a received request and a code-sending device to transmit the generated OfferID directly or indirectly to the offerer terminal from which the request originated. In a modification of a special kind of procedure already mentioned above (“catalogue offerer) the code-generating unit serves merely to generate a first identifier section, which identifies an offerer; and in a second modification instead of the code generating unit means are provided to receive an externally generated code and check that it contains no ambiguities as well as to send out a confirmation signal to confirm that an externally generated OfferID is unambiguous (and hence usable).

Especially for generating and manipulating the above-mentioned dynamic OfferID, the system-management server has timing means associated with the code-generating unit and duration memory means to assign a duration of validity to every OfferID and store it, as well as a duration-comparator unit connected to the timing means and duration memory, which checks whether an assigned period of validity has reached its end and sends out an elimination signal to invalidate the OfferID when it has expired. When static OfferIDs are used, of course, these components are replaced by an erasure unit that responds to an erasure demand of external origin by eliminating the identifier.

Another essential functional component of the proposed system architecture is a data filing system (OfferID repository) to store and manage all valid OfferIDs and items of information associated therewith in the system, in particular data relevant to payment transactions and the codes that identify data-transfer events that have occurred. With its help, for example, it is possible to find out which customer/merchant servers were responsible for each transaction. The components for managing dynamic OfferIDs mentioned in the preceding paragraph, which in that case were assigned to the system-management server, can also be assigned to the repository.

In order to carry out the actual financial transaction appropriately and in a short time, in particular at least one account-management server is directly associated with the or one telecommunications network and cooperates with the system-management server and/or with the customer server to issue a payment, in particular with access to a prepaid balance. On the other hand, the or at least one account-management server can be disposed outside the control region internal to the or each telecommunications network and in particular can be connected directly to the purchasers telecommunications terminal.

To ensure that the system is self-sufficient in controlling all transactions (independently of external triggers, which can easily produce disturbances if a very large number of transactions are simultaneously in progress) the system-management server comprises a flow-program memory to store at least one transaction-flow program for data communication between the or each customer server and the offerer terminals or the or each merchant server.

Essential aspects of the most important methodological sequences in the proposed system are already derivable from the above explanations of the system structure, so that the corresponding methodological aspects need not again be exhaustively presented. In the following a few crucial methodological ideas underlying the invention and its preferred embodiments will be considered in greater detail.

An especially advantageous design of the system provides that an unambiguous identifying code—the OfferlID—is made available and used for identification of merchandise or services (in particular a whole “shopping basket”); it is not confined to an individual transaction, but is used for organizing all the data transfer and data processing events associated with offering and paying for these goods, in particular the reliable authorization of the payment.

In a first variant design of the invention no duration of validity is established when the OfferID is generated, so that it is potentially valid for an unlimited period. For this situation the term “static OfferID” can be used. It is employed in particular to pay for merchandise or services offered on television channels (“TV shopping”) and for the products offered at vending machines (VM), by way of a telecommunications network and by use of a telecommunications terminal.

In an alternative design of the invention, along with the generation of the OfferID a duration of validity is defined, and when this time is up the OfferID automatically becomes invalid. In this case one can speak of a “dynamic OfferID”. It is used for various other shopping and payment processes, in particular for individual purchasing actions in virtual shops on real retail establishments.

In both cases the OfferID can be erased or destroyed on demand by the offerer of the merchandise or services. To invalidate the OfferID when its duration of validity is exceeded or on demand by the offerer, an elimination signal is sent to the offerer in order to notify the latter that the identifier in question has become invalid.

The transfer of information about the OfferID to the—potential—purchaser or customer occurs in a first variant as an invariant optical display, in particular as lettering on a show-window display on vending machine or printed in a prospectus, catalogue or the like. In other variants the OfferID is communicated to potential purchasers as a variable optical display on an electro-optical display device, or by spoken output on an acoustic signal. These different kinds of communication allow for the specific purchasing situations in industrialized society, where the traditional method of buying from a shop or from vending machines, which are used in particular to sell drinks, cigarettes and sweets, has long since been joined by internet and TV shopping.

For most of the existing commercial channels it is advantageous for the OfferID to be transmitted during its period of validity to a large number of potential purchasers in a broadcast procedure apart from the telecommunications network, in particular by radio or television or by sending out or distributing printed documents or by e-mail broadcasting. Recently, however, the possibilities for obtaining merchandise on services (information!) offered directly by way of a telecommunications network have become considerably more significant. In a variant that is advantageous for this purpose the OfferID is transmitted, in particular in a broadcast procedure, as a short message on by WAP, through the telecommunications network to the telecommunications terminal of the purchaser and is displayed there.

Preferably the steps involved in requesting an OfferID from the offerer and in sending it to the offerer or merchant proceed as substantially automated data transfers between the system-management server and a merchant server or offerer data terminal, by way of a data and/or telecommunications network, in particular the internet. This applies both to internet shopping and also to making use of the proposed system by way of “classical” installations.

In a typical scenario, after the step of transmitting the OfferID to the purchaser, the OfferID is transmitted by the purchaser over the telecommunications network to a customer server of the network operator or a service provider in the telecommunications network, then a request to obtain a binding offer is sent through the customer server, service-provider server or merchant server to the offerer, an offer data set is sent by the offerer to the customer server and the offer data set is transmitted from the customer server to the telecommunications terminal of the potential purchaser, where it is displayed under menu guidance to confirm the transaction. In this process the data transfer involved in the steps of requesting a binding offer and transmission of the offer data is performed by way of the system-management server, which in particular carries out search and routing functions between network operator or service provider and offerer.

The OfferID can be generated entirely by a suitable generator in a system-management server belonging to the proposed system, but alternatively it can also be generated entirely externally and in the course of the request be transmitted from the offerer to the system-management server for confirmation. In particular for “catalogue” offerers an advantageous variant is one in which the OfferID comprises a first and a second section, such that the first section identifies the offerer and is generated or managed by the system-management server and the second section identifies the merchandise or group of merchandise and is generated or managed by the offerer, and the method comprises transmission of the second section to the system-management server, linkage of first and second sections in the system management server, and sending the entire OfferID to the purchaser or confirming it with respect to the purchaser.

Thus “number strips”, so to speak, can be allocated to the offerer, so that the offerers own catalogue number can continue to be used, after a section (the prefix) that represents the offerers identity. By this means the employment of OfferIDs in the case of catalogue scenarios can be considerably simplified. The combination of the first section (prefix) with the second section (catalogue number) can—after assignment of the prefix by the system management—also be done by the offerer itself, in which case the offerer of course is responsible for making sure that the OfferID is unambiguous.

Customarily a purchaser who has been informed about the OfferID will input it himself, either manually at his telecommunications terminal or, where appropriate, also by speaking. The above-mentioned possibilities for output of the identifier to the purchaser can, however, feed into an automatic input procedure, which of course is more resistant to error than a manual input. For this purpose, in or at the purchasers telecommunications terminal and in particular by a camera or scanner connected thereto, the identifier is converted from an optical or acoustic signal into an electrical signal.

In another respect the invention includes the essential idea of disclosing a practically universal system for organizing financial transactions on the basis of a conventional bank account (“postpaid”) on electronic balance (“prepaid”), which can be used in particular for organizing payment in the P2P area, allowing the “sending” of amounts of money in a private context.

It also includes the idea of using primarily a telecommunications network for this purpose, and in particular the possibility of proceeding through the sequence in almost real time. To the telecommunications network are attached on one hand the telecommunications terminals of the participants using the network, and on the other hand at least one transaction server belonging to the operator of the network or to a customer-oriented service provider.

A person-to-person payment in the sense of the present invention presupposes that an account suitable for electronic transfer of funds (“wallet account”) is available to both the payer and the payee. The implementation can occur on one hand in a two-step sequence, by (1) payment to a “merchant” (P2P engine) and (2) crediting to a payee account on the side of the “merchant” or on the other hand—in a more user-friendly manner—by integration of the P2P engine in an account-management server belonging to the payer. For the P2P engine the term “transaction server” will often be used in the following, whereas the likewise previously mentioned account-management server can also be termed “payment instrument” (PI). The sequence of events in the two variants of the method is described in greater detail in the figures.

To initiate the P2P payment process the payer uses his telecommunications terminal and a telecommunications network (in particular mobile wireless network), or data terminal and a data network (especially the Internet), to contact the transaction server or P2P engine, and specifies an address or another identifier of the payee and the amount of the payment. Optionally it is also possible—in the case of international payment transactions—to input the currency in which the payment is made and some text information (e.g., regarding the purpose of the payment). In the transaction server actuated by the payer or another transaction server connected thereto, from a first payment-order data set created from the payers input is formed a second payment-order data set that ultimately brings about the credit to the payee. During this process an OfferID of the payee is specified (insofar as this has not already been done at input).

If the electronically updated accounts of payer and payee are kept on different account-management servers, the transformation between first and second payment-order data sets typically includes finding out the server address of the (second) account-management server of the payee and directing to it an inquiry about the payee's account identifier. After this has been answered, the amount of the payment can be credited.

In the payment process there is in any case provided an authentication of the payer by accessing participant data that identify the payer as participant in a telecommunications network. Insofar as the payment process is organized by the payers telecommunications terminal (mobile wireless terminal), the authentication utilizes the payer's MSISDN for ab initio authentication. In contrast, if the payment process is initiated from a data terminal, a confirmation step is provided involving access to the telecommunications network in which the payer is a participant. A confirmation inquiry is also optionally provided as an additional step in the first-cited method.

In international payment transactions the first payment-order data set has a first currency code and the second payment-order data set has a second currency code that differs from the first code, and during production of the second payment-order data set the amount information in the first payment-order data set is converted to amount information in the second payment-order data set on the basis of a previously stored exchange rate. The hard- and software equipment required for this purpose is made available by the system operator or service provider, and it is conceivable for it to be implemented as a conversion server or as supplementary functionality of one of the participating account-management servers. The exchange rate to be used is made available by the transaction server of the system operator, or else that server itself carries out the conversion as supplementary functionality.

The data transmissions from and to the payers telecommunications terminal for payment are all done by short message according to SMS, data-file transfer according to WAP or by way of IVR speech communication. Here the SMS variant—especially without additional confirmation—is more reasonable for small amounts (including “micropayments”). In the WAP variant the P2P engine is designed in the nature of what is now known as a “WAP shop”. In any case it is likely to be advantageous to avoid changes in the access medium during the subordinate steps of initiating payment, authentication and confirmation that the amount has been transferred.

In addition to the authentication of the payer mentioned above, when the amounts of money are relatively large there is preferably also provided a means of authenticating the payee with reference to user data stored in the system (in particular the transaction server or second account-management server). This is an important measure to prevent misdirection of large payments. It is also advantageous to carry out the procedure in such a way that the payer can cancel the payment by initiating an erasure event with respect to the payment-data transfer by way of a suitable action in the first transaction server—or also in a special interface to his account-management server.

Another option provides for the payee to be notified of the intended transfer of funds, and in a special development thereof the payee can additionally specify a particular payment instrument (an account-management server) to which the electronic payment should be diverted. In this sense, therefore, the receiver of the payment can also intervene in the current stage of the payment process.

To achieve operation that is economical for the system operator or service provider, there is also provided an implementation of transaction fees (in the following collectively termed “implementation-amount information”). In this case the transaction costs can be charged to the payer or the payee, or be split between the two. To the second payment-order data set there is added, together with the implementation-amount information, an appropriate flag to indicate whether the account to be debited is that of the payer or the payee, or those of both.

To ensure that international payments involving currencies for which there is no fixed conversion rate are economically sustainable, a so-called spread should be implemented in the course of the data transfer. For this purpose, when the amount information (in the first currency) in the first payment-order data set is converted into that in the second payment-order data set (so that it is now in the second currency), the appropriate spread information is taken into account. This is stored in particular in a database assigned to the transaction server or the system-management server.

Essential aspects of the arrangement underlying the proposed system will already be evident from the methodological aspects emphasized above, so that repetition can be avoided in this regard. The above description makes clear that transaction servers represent an essential component of the proposed system and that depending on the particular design of the system they communicate with telecommunications terminals and optionally with additional data terminals of the payer as well as—directly or indirectly by way of other transaction servers—with account-management servers on the sides of both payer and payee. At the core of the system, in the preferred embodiment, is a system-management server that is substantially permanently connected to several transaction servers and also can form a functional unit with one transaction server. The system-management server is associated with a telecommunications network or also several telecommunications networks (in particular mobile wireless network(s). This also applies, in a preferred design of the system, to the (or at least one of the) account-management server(s).

The system-management server typically has a flow-program memory to store at least one transaction-flow program for the communication of data between a payer's telecommunications terminal and the account-management server or the transaction server or servers, and is advantageously associated with a dedicated data-filing system to store and manage all valid user data and, in particular, the data relevant to payment transactions and identification codes for data-transfer events that have previously occurred.

### BRIEF DESCRIPTION OF THE DRAWINGS

FIG. 1 shows a block diagram of an issuer-and-acquirer system.

FIG. 2 illustrates the payment flow in the system shown in FIG. 1.

FIG. 3 illustrates an embodiment of the interoperable mobile payment protocol (IMPP).

FIG. 4 illustrates an exemplary architecture of an IMPP subprotocol.

FIG. 5 illustrates processing of a WOPP message.

FIG. 6 illustrates processing of a Web-WAP macropayment.

FIG. 7 illustrates processing of a Web-WAP micropayment.

FIG. 8 illustrates processing of a WAP-WAP macropayment.

FIG. 9 illustrates processing of a Web-WAP address transfer without payment.

FIG. 10 illustrates processing of a vending-machine macropayment.

FIG. 11 illustrates processing to generate a static OfferID.

FIG. 12 illustrates an IMPP state model for direct macropayments.

FIG. 13 illustrates an IMPP state model for macropayment credits.

FIG. 14 illustrates an IMPP state model for delayed macropayments.

FIG. 15 illustrates an IMPP state model for partial macropayments.

FIG. 16 illustrates an IMPP state model for direct micropayments.

FIG. 17 illustrates an IMPP state model for delayed micropayments.

FIG. 18 illustrates an IMPP state model for micropayment credits.

FIG. 19 illustrates an IMPP message structure.

FIG. 20 illustrates processing for a version negotiation in the context of IMPP.

FIG. 21 illustrates an OfferID state diagram.

FIG. 22 illustrates processing for an exemplary currency conversion.

FIG. 23 illustrates processing for micropayment clearing and settlement.

FIG. 24 illustrates a clearing data-state diagram.

FIG. 25 illustrates processing for the distribution of fees.

FIG. 26 illustrates processing for issuance of an invoice.

FIG. 27 illustrates back-office processing.

FIG. 28 shows a schematic overview of essential components and layers as well as processing sequences in a system in accordance with the invention.

FIGS. 29A to 29C show a schematic sequence diagram as well as a list of the sequential steps in an embodiment of the method in accordance with the invention (Web-WAP scenario).

FIGS. 30A to 30C show a schematic sequence diagram as well as a list of the sequential steps in another embodiment of the method in accordance with the invention (WAP-WAP scenario).

FIGS. 31 A to 31C show a schematic sequence diagram as well as a list of the sequential steps in another embodiment of the method in accordance with the invention (push-fall-back scenario).

FIGS. 32A and 32B show a schematic sequence diagram as well as a list of the sequential steps in generating a static OfferID in the context of a vending-machine/TV-shopping scenario.

FIGS. 33A and 33B show a schematic sequence diagram as well as a list of the sequential steps in erasing a static OfferID in the same context.

FIGS. 34A to 34C show a schematic sequence diagram as well as a list of the sequential steps in another embodiment of the method in accordance with the invention (vending-machine/TV-shopping scenario).

FIGS. 35A and 35B show a schematic sequence diagram as well as a list of the steps in the course of a clearing procedure for the transfer of relatively large amounts of money (macropayment).

FIGS. 36A to 36C show a schematic sequence diagram as well as a list of the sequential steps in another embodiment of the method in accordance with the invention (micropayment scenario with stored-value accounts).

FIG. 37 is a diagram summarizing system structure and sequential steps in a first variant of the method.

FIG. 38 is a list of the steps in this first variant.

FIG. 39 is a diagram summarizing system structure and sequential steps in a second variant of the method.

FIG. 40 is a list of the steps in this second variant.

### DETAILED DESCRIPTION OF THE INVENTION

The present description relates to an interoperable mobile payment protocol (IMPP) in association with a system that provides for the transmission of information between an issuer domain and an acquirer domain. Both mobile devices and those that are not mobile can be used in connection with the IMPP. The IMPP is not limited to employment in association with the specific system described here, and can be utilized in other systems with architectures that differ from the system architecture described here.

The term “interoperable” refers to the interoperations carried out between the issuer domain and the acquirer domain. The term “issuer domain” (sometimes also shortened here to “issuer”) as used here refers to wallet issues. Payment instruments are authorized, e.g., by banks or are stored-value cards. An issuer declares a customer to be valid, and the customer has at his disposal the payment instruments in his wallet. In some transactions, e.g. micropayment, a Telco or ISP can be an issuer. The term “acquirer domain” (sometimes also shortened here to “acquirer”) as used here refers to institutions that acquire transaction-related data from merchants and send these data to a clearing network for authorization.

The terms “customer” and “buyer as used here refer to the possessors of payment instruments (e.g. credit cards) who undertake purchases from a merchant. The term “merchant” refers to those who offer merchandise for sale and/or make available services to a customer, in return for payment by the customer. The term “wallet server” refers to a secure repository for proof of payment authentications of customers possessing cards, which enable the customer to conclude a remote payment transaction from some one of several devices. The term “payment server” refers to a server that accepts payment inquiries from the issuer domain (e.g. of a customer or wallet server) to merchants. A payment server can also be capable of making things available to merchants.

The following text gives a general overview in the form of a description of a system that enables electronic transactions, including transactions performed by means of devices such as computers coupled to networks (e.g., wide area networks such as the internet) and wireless devices (e.g. mobile telephones). The overview of the system is followed by details regarding the IMPP. In addition there is provided a detailed description of the processing that occurs in the exemplary system under control of the IMPP.

It is a prerequisite of the system that an issuer has contracts with consumers and can deal with their account information. The account information comprises items related to payment and security. The merchant acquirer (acquirer domain) has contracts with merchants at its disposal and makes payment services available. A central processing platform (interop domain) manages the interoperability and offers central services such as the clearing and settlement of transactions. This architecture maintains conventional merchant and merchant acquirer work flows and extends the existing payment infrastructure to mobile payments.

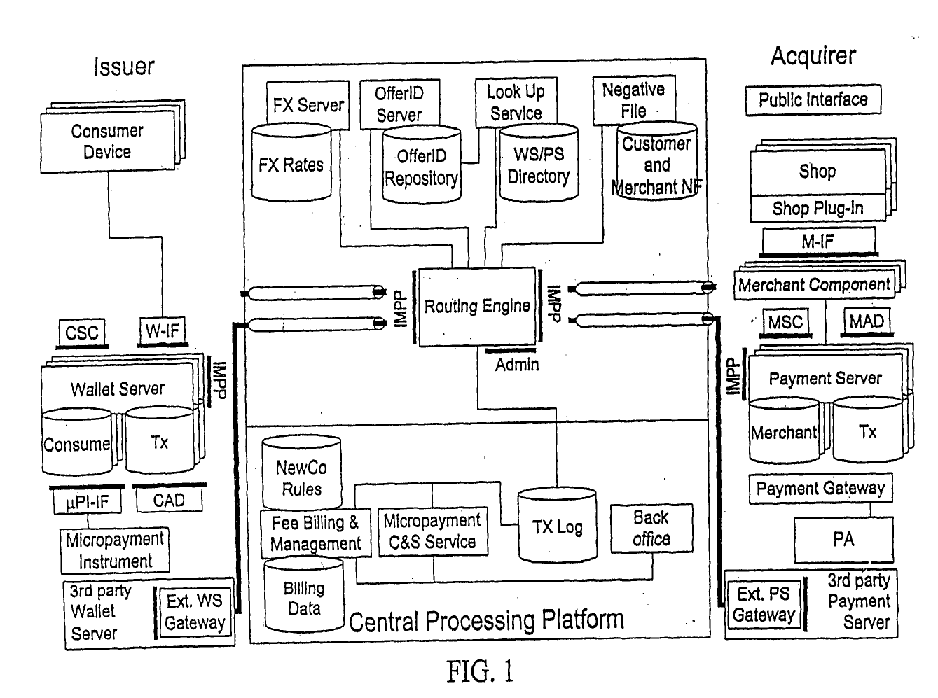

With particular reference to FIG. 1, the system comprises a central processing platform (CPP), which communicates with a wallet server and a payment server. The CPP carries out both real-time and non-real-time processing. For example, the CPP performs routing, offer-ID, look-up, currency-conversion and transaction-management functions in real time. Non-real-time processing comprises, e.g., micropayment settlement and clearing, fee processing and sending out invoices and distributing enclosures.

The CPP comprises a routing engine to route transaction-related messages between wallet servers and payment servers in accordance with the IMPP. In particular, the routing engine interrupts the IMPP and directs requests between external parties, including payment transactions as well as responses. Therefore transactions (macro- and micropayments) are carried out by way of the routing engine.

The CPP likewise comprises a currency-conversion server that is coupled to a conversion-rate file, an OfferID server that is connected to an OfferID repository, a look-up server that is connected to a wallet-server(WS)/payment-server(PS) directory, and a negative-file server connected to a customer and merchant negative file. The CPP further comprises a back-end processing functionality for processes such as the clearing and settlement of micropayments and the settlement and management of fees. In particular the CPP comprises a fee-settlement and fee-management server and a micropayment server, which are coupled to a transaction protocol (lock). The fee-settlement and -management server is coupled to a databank for new-company rules, which contains rules for fee settlement and the distribution of enclosures to companies that are new to the system. The fee-settlement and fee-management server is also coupled to a databank that contains settlement data. The routing engine of the CPP monitors IMPP messages, which enables several wallet servers to communicate with several payment servers by way of a central element. Because payment transactions are routed through the CPP, the addition of further participants has no effect on the existing installation and the process of adding these participants is simplified.

Mobile payments, requests and responses are routed between wallet-server and payment-server elements. Other CPP components that carry out centralized tasks, such as the OfferID generator, search service and FX server, are utilized by the routing engine to support the payment processes. The transaction-protocol entries are generated in such a way that they meet the legal requirements and enable coupled (offline mode) processes such as fee settlements. The CPP also processes questions regarding address changes, age checking and requests for a change of payment instrument. Quality identification keys are transferred together with requests/responses, to indicate the quality level of the underlying data.

The CPP routing engine receives external notifications of macropayment authentications and completes the transaction protocols and exchanges notifications about all state changes between the other involved parties, in order to keep consistent the transaction protocols of the WS, MS and Encorus processing platform.

In the case of micropayments the authentication is carried out between WI and the offerers of micropayment means. The authentications are therefore transferred with the payment-message flows to the payment servers. While a payment transaction is under way, the routing machine retains transaction records and stores all items of information about a transaction together with an unambiguous transaction ID.

The search for the payment server and for merchants involved in a transaction is performed on the basis of an OfferID (OID) or range ID. When the search is based on an OfferID, the basket ID is analyzed and transferred to the MC together with the OID, in order to obtain information about the shopping basket. The particular merchant determines whether the OID or the basket ID should be used to identify the shopping basket. When the search is based on a range ID, the combination of range ID and merchant catalogue number is transferred to the MC in order to obtain information about the shopping basket.

The list of participants contains all MSISDNs and aliases of the customers who have been listed for mobile payment. For each MSISDN/aliases the home wallet server ID is likewise stored. The MSISDNs/aliases that have not been entered into the records can be rejected by the CPP at an early stage of processing.

The OfferID identifies a shopping basket. In order to identify the basket information in a cross-WI/MA scenario, the OfferID is generated centrally. The OfferID can be used in mobile payment scenarios for both micro- and macropayments. In most cases OfferIDs are input by way of a mobile device with limited capacities regarding size of the display and usability of the keyboard.

The OfferID generator generates an Offer[D on request and the OfferID repository stores generated OfferIDs together with additional data to assist searching, and also manages the OfferID lifetime. Subsequent payment transactions can use the same OfferID for payment transactions (e.g., VM or TV shopping). Static OfferIDs can be “rented” by the merchants on a monthly or yearly basis. Dynamic OfferIDs characterize a temporary offer, have a specified lifetime and are used by a single customer. A dynamic OfferID is deleted automatically as soon as a transaction has been concluded or the maximal lifetime is exceeded.

The OfferID repository stores information about a requested OfferID. When age checks, an address change or GI data transfer are requested, the relevant identification keys are set within the OfferID repository. The OfferID repository also keeps track of the OfferIDs that have been issued and sets an OfferID state to “black-out” as soon as the associated lifetime has elapsed. In addition, the OfferID repository supports manual erasure requests. The search services utilize the OfferID repository to locate the payment servers coupled thereto.

The merchant negative file prevents listed merchants either from listing themselves for mobile payment at any merchant acquirer or from initiating any kind of transaction in the listed state. In the merchant negative file the ID, the URL and the name of the merchant are stored together with a time marker.

The buyer negative file prevents listed buyers either from listing themselves for mobile payment at any wallet server or from initiating amy kind of transaction in the listed state. In the buyer negative file are stored the ID, the name, the first name, the date of birth and the MSISDN, together with a time marker.

Because international transactions are organized by CPP, the CPP makes available a central means of foreign exchange (FX) rate acquisition, as well as spread management and a currency-conversion service. The CPP calculates amounts in the customer's currency (if this differs from the merchant's transaction currency). The FX server stores foreign-exchange rates and converts currencies in order to settle international micropayments and fee charges.

The wallet server (WS) communicates with buyer devices, e.g. by way of device-specific gateways such as WAP and SMS gateways, and stores buyer-related and transaction-related data such as MSISDN, billing and shipping addresses, and credit-card numbers. The wallet server makes available functionalities for customer assistance, and organizes the processing of payment protocols. The wallet server routes authentication inquiries to a micropayment instrument (μPI).

Each wallet issuer makes available at least one micropayment instrument, which is either operated by the issuer or taken over at the wallet server by a third party. The μPI can be of various types, for instance a dedicated stored value account system, a Telco prepaid account or a Telco-telephone market.

The payment server (PS) processes the IMPP protocol between CPP and merchant acquirer and processes an open payment protocol (OPP) in the direction of a merchant component. The PS is connected by way of a payment gateway to those qualifying for macropayments (e.g., credit-card payments) in order to route authentication inquiries. The merchant component (MC) is integrated into the merchant's buying system, in order to enable an OPP.

Customarily, and prior to the payment transaction, a buyer accesses a merchant's business, for instance by way of a specific shopping channel (e.g., WEB, WAP, IVR, TV), on reads instructions and product offers at a vending machine. To confirm the payments the buyer uses his mobile telephone to be connected to a wallet server (pull scenario) on is called up by a wallet server (push scenario). The mobile telephone network also mediates authentication, so that the authentication for payment by any type of payment means (e.g., micropayment means, credit card, debit card) can be implemented.

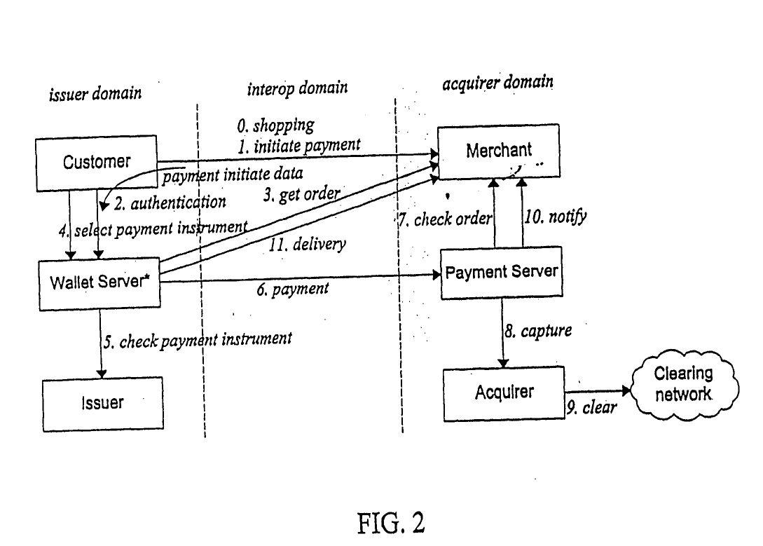

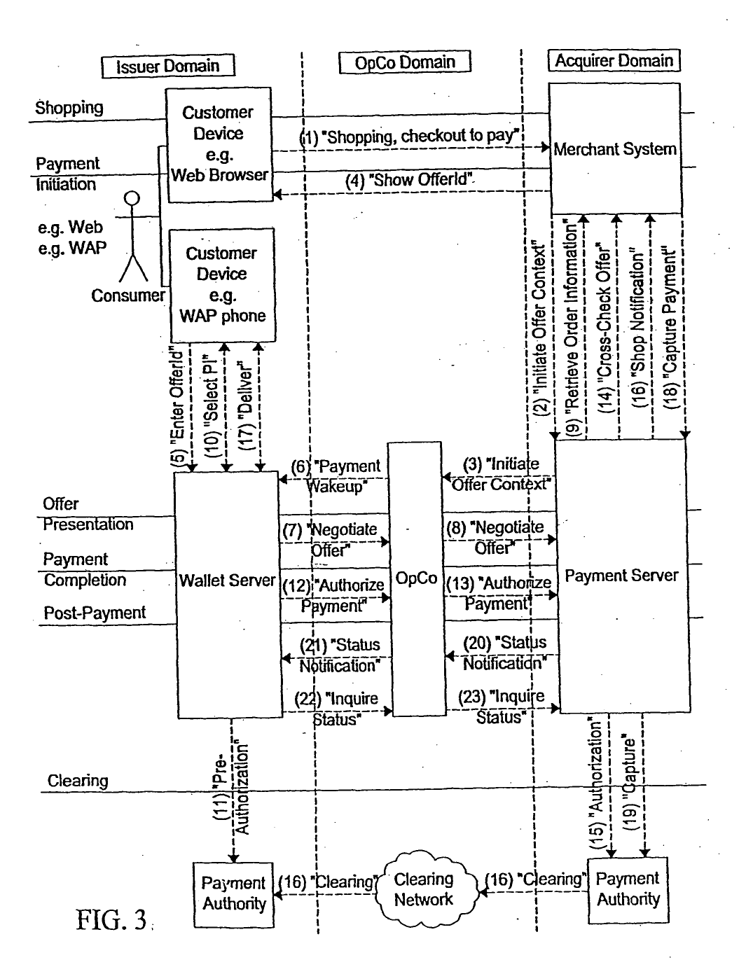

In particular, and with reference to FIG. 2, a 3-domain model establishes a process for electronic payments. The term “issuer domain” refers to the issuer and proprietor of bank cards or other payment means (e.g., issuers and customers) and to agents of the issuer (e.g., the wallet server). The term “acquirer domain” refers to those who acquire payments from an issuer domain. The term “interoperability (interop) domain” refers to the interface between the issuer and acquirer domains, to enable interoperations (i.e., interactions between the issuer domain and the acquirer domain) for electronic payments.

The customary payment flow is described further below as a sequence of steps and with reference to FIG. 2. The payment flow described below is based on a purchase carried out by way of a network such as a wide area network (e.g., the internet). Of course other payment flows are also possible, and the description continued below represents only one example.

Step 0. Shopping. A customer shops by examining an offer of merchandise/services from a merchant. As a result, an order is stored in the merchant's shopping system.

Step 1. Initiation of payment. Having completed the shopping, the customer clicks on a link in the shop, which routes the customer to the wallet server. The URL contains information that enables the wallet server to determine the context of the payment (e.g., merchant URL and order identification). The customer makes available to the merchant the URL of the wallet server (e.g., the customer can select the URL from a drop-down list), so that the merchant can assemble the correct URL for the link. As a result, the wallet server can identify at least the merchant and the order.

Step 2. Authentication. The customer logs onto the wallet server. The authentication is implemented by the wallet server (which in many cases is identical to the issuer). Once the customer has been authenticated, the customer retains access to the customer data.

Step 3. Obtaining the order information. The wallet server calls up the order information (description of the order, amount of payment) from the merchant. The merchant also returns the URL of its payment server and the acceptable forms of payment. The wallet server displays the order data to the customer.

Step 4. Selection of the payment instrument. The wallet server, on the basis of the list of payment forms accepted by the merchant and the stored information about the buyer's payment instruments, presents a list of available forms/instruments for payment, from which the buyer can choose. The wallet server reads out the order details and the accepted forms of payment.

Step 5. Checking the payment instrument. The wallet server first connects to the issuer in order to check whether the selected payment instrument is valid. The issuer can send back additional data (in addition to a simple yes-on-no response) at this point (e.g., in case of a single-use token employed specifically for the coming payment).

Step 6. Payment. The wallet server, on behalf of the customer, sends a payment request to the payment server.

Step 7. Checking the order. The payment server connects to the merchant's shopping system in order to check whether the order data received from the wallet server are authentic. The payment server receives all the data that are needed to process the payment.

Step 8. Capture. The payment server routes the payment data to the acquirer. The capture step can be carried out asynchronously if a delayed delivery is employed.

Step 9. Clearing. The acquirer effects a physical payment; that is, the acquirer implements the payment request by way of a financial institution in a back-end operation. The clearing can occur asynchronously (e.g., in batches). The clearing network processes the transaction and is the money is transferred to the merchant's account.

Step 10. Notification. The payment server notifies the merchant about the success of the transaction. The notification can also occur asynchronously.

Step 11. Delivery request. The wallet server provides the merchant with the delivery address. This step can be performed asynchronously at other points in the sequence of messages, for example before or after the payment.

Many messages can incorporate elements similar to authentication. For instance, during an SET capture request the SET gateway checks the signature of the card holder. Current payment systems can also omit some of these messages, or the manner in which certain items of information are processed may differ. For instance, the notification can be sent back to the merchant by way of the buyer, or in some cases can be omitted entirely. The steps can also be interwoven with one another or further subdivided.

Protocol

The protocol comprises various subprotocols. Each subprotocol operates within its own assigned region, which is clearly delimited from the regions assigned to other subprotocols.

In one exemplary embodiment, one subprotocol is termed the interoperable mobile payment protocol (IMPP) and is used for messages between and by way of the wallet-server OpCo and the payment-server protocol. The other subprotocol is the open payment protocol for the exchange of information between the payment server and the merchant system.

The IMPP establishes the communication between the following components through the OpCo domain.
Wallet server
OpCo
Payment server
Merchant system

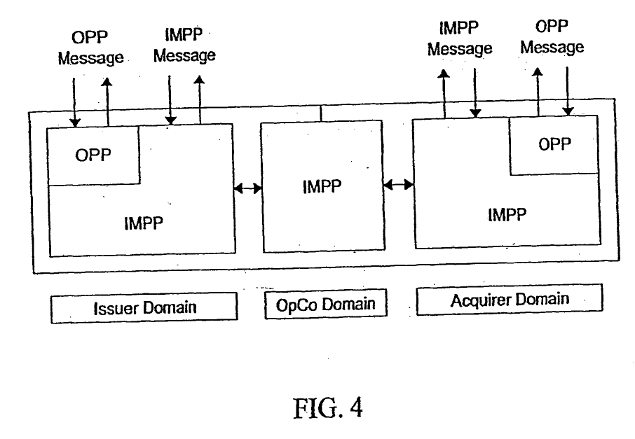

An exemplary embodiment of the IMPP is described in a model presented in FIG. 3. The IMPP introduces a central element for message-routing and other payment-related processing, which here are also referred to as the OpCo domain. The OpCo holds the central offer data and in certain scenarios finds out the customer's wallet server during the initiation of payment. Furthermore, the OpCo (by way of the CPP) provides the opportunity to route payment messages in both directions between a wallet server and a payment server.

With reference to FIG. 3, the wallet server contains core customer data that have priority for authentication and payment, as well as a transaction history.

The wallet server is triggered during the payment-initiation phase, and subsequently sends payment messages to the payment server by way of the OpCo. The wallet server is notified by the OpCo when the status of a payment transaction has changed, and can inquire about the status of a particular transaction in order to update the transaction history.

The payment server holds the merchant's core data for payment and the transaction history. The payment server also receives payment messages from the OpCo and processes the messages. In particular, the payment server sends messages to those responsible for payment on the side of the acquirer and causes result notifications to be sent to the OpCo and the merchant system. The payment server sends and receives the required information to/from the merchant system during the various phases of the payment process.

The term “merchant system” refers to a shopping system and payment plug-in components that are made available on the local domain of a merchant's payment system that conforms to a 3D model. The merchant system sends and receives the required information to/from the payment server during the various phases of the payment process. The merchant system makes available a local technical indication of the payment system into the merchant's shopping system, often supplemented by a shopping plug-in.

The following description relates to the method on protocol used in connection with the messages sent between the wallet server and the payment server in association with a transaction, as shown in FIG. 3.

Step 1. Shopping. A customer shops for merchandise/services and an order is stoned in the merchant's shopping system.

Steps 2 and 3. Initiation of the offer context. When shopping is completed, the customer clicks on a link in the shop, which causes the offer context to be sent from the shopping system to the payment server. The request is routed through the payment server to the OpCo. The offer is context is stored and in response, the relevant OfferID is sent back to the payment server and to the merchant system. The offer context comprises items of information that indicate whether an age check should be performed and whether a delivery address has been requested by the merchant.

Step 4. Show OfferID. Either the OfferID is displayed to the buyer so that the interaction can be continued by way of the (various) payment channels, or the buyer is routed to his wallet server by way of the OpCo (with the same payment channel, not shown). The URL of the wallet/payment server is found by searching within the OpCo and URL, if necessary. The URL is not required if the wallet server does not need the address of the payment server. In the IMPP the payment channel can differ from the shopping channel. The buyer is provided with sufficient information to identify the order and to enable the CPP to generate a payment wakeup.

Step 5. Enter OfferID. The buyer is asked to enter the OfferID received from the shop into his wallet. In the payment channel of the wallet server the buyer is identified by the MSISDN of the buyer's mobile telephone and authenticated.

Step 6. Payment wakeup. The wallet server directs the OfferID to the OpCo and in return receives the payment wakeup information. This comprises whether an age check should be made and whether a delivery address is needed by the merchant. The buyer is authenticated and obtains access to his data.

Step 7. Negotiate offer. The wallet server seeks out the order information (e.g., order description, final amount of payment).

Step 8. The data are routed through the OpCo to the appropriate payment server.

Step 9. The payment server asks the merchant for order details. The merchant system likewise returns the accepted forms of payment. The wallet server then displays to the customer the final order data. The exchange of messages occurs by way of the OpCo, but does not go directly to the merchant as in the 3D model. The wallet server therefore does not need to know the merchant's network address. The wallet server likewise routes the delivery address to the merchant so that the final payment amount can be recalculated, and also sends the result of an age check if this has been requested by the merchant. The wallet server receives the order details and the kinds of payment that can be accepted. The payment instruments to be used are selected and declared valid.

Step 10. Selection of payment instrument. On the basis of the list of forms of payment accepted by the merchant and the stored payment instruments of the customer, the wallet server presents a list of available payment forms/instruments, from which the customer can choose.

Step 11. Pre-authorization. The wallet server makes connection with the payment authority on the side of the issuer in order to check whether the selected payment instruments are valid, to carry out limit checks and to pre-authorize a payment in the case of a new-company scheme that conforms to interoperable micropayment.

Steps 12 and 13. Authorization of payment. The wallet server on behalf of the customer sends a payment request to the OpCo. This can comprise the result of a pre-authorization in the case of micropayments in conformity with the scheme. The OpCo sends the request on to the appropriate payment server. The payment server receives all the data that are needed to process the payment.

Step 14. Cross-checking the offer. The payment server makes contact with the merchant's shopping system in order to check whether the order data received from the wallet server are authentic.

Step 15. Authorization. The wallet server routes the payment data, in the case of macropayments, to the payment authority in the acquirer domain or, in the case of micropayments in conformity with the scheme, checks the result of the pre-authorization. The two steps 11 or 16 are mutually exclusive, one on the other being carried out in order to authorize payment by OpCo. The clearing network processes the transaction.

Step 16. Clearing. The payment authority in the acquirer domain undertakes the physical payment, i.e. processes the request in the financial back-ends. The clearing can occur asynchronously (e.g., in batches). The wallet server notifies the merchant about the success of the transaction. Such notification can also occur asynchronously. The merchant therefore knows whether the payment was successful and is now in a position to begin delivering the merchandise.

Step 17. Delivery. The result of the payment is communicated to the customer. Once the current payment has been completed, the customer can continue the interaction with the shop. For the customer a payment receipt is typically important, in particular to begin accessing the digital content immediately after the payment. The purchased items are delivered in the shopping channel or asynchronously. The wallet server receives a payment receipt on order of the buyer.

Steps 18 to 19. Capture. Depending on the payment system on the side of the acquirer, postponed or split amounts can be captured and the payment is (partially) refunded on a balance is asynchronously paid out by the merchant. This action can be initiated by merchants in the shopping systems and is routed to the payment server. The capture request is routed through the payment server to the payment authority in the acquirer domain. The money is booked to the merchant and transferred after settlement.

Steps 20 to 23. Status notification and inquire status.

With reference now to FIG. 4, the OPP manages the exchange of information between the wallet server, the merchant system and the payment server. The IMPP manages the communication between these components. The OPP establishes additional messages for exchanging information by way of IMPP, and manages the exchange of information by way of the OpCo domain, which depends on the specific purchase and a payment channel or a combination of the two. The OPP depends in part on whichever payment and shopping scenario is being supported. The OPP determines the exchange of information between the components that are included by way of the OpCo domain, by employing the IMPP. The OPP does not manage the communication within the issuer and the acquirer domains. The OPP information flow is described in the “payment initiation” phase and the “post-payment” phase of the 3D model.

The “payment initiation” phase of the model describes the processes of locating the wallet server and sending the wakeup message. The “post-payment” phase describes the notification and delivery process. The OPP does not manage the communication between the customer and the merchant system, because this communication is determined by the merchant or the shopping system. The OPP hides the data specific to payment, shopping and scenario, so that the underlying IMPP need not take any account of these data.

The OPP utilizes the underlying protocol in order to exchange messages between the wallet server and the payment server. This means that the wallet server and the payment server cannot communicate with one another directly oven the network. All communication between the wallet server and the payment server is managed by the same IMPP that manages all the communication between the three components wallet server, processing platform and payment server. Therefore pairs of messages must be encapsulated in additional messages by the OPP, in order for them to be transferred by way of the underlying protocol. For exchange initiated by wallet server (WS transfer) and payment server (PS transfer), two new message pairs are needed. These message pains are described below.

Wakeup request and response message: the wakeup request is sent out by the merchant system in order to initiate a wallet-server search in particular payment scenarios. This request is sent to the processor platform in order to initiate payment by way of the relevant customer's home wallet server. The wakeup process depends on the combination of shopping and payment channels.

Delivery request and response message: the delivery request is sent out by the wallet server in order to inform the merchant system that a payment transaction has been concluded. The merchant system can utilize this information to initiate the delivery process. The delivery process depends on the payment and shopping scenario.

Resumption request and response message: the resumption request is sent out by the wallet server in order to conclude an interrupted delivery of online content.

The IMPP manages the payment-specific communication between the wallet server, the merchant system of the processing platform and the payment server. The OPP manages the exchange of information by way of the OpCo domain, which depends on a special shopping and payment channel or a combination of the two. The IMPP is independent of the payment and shopping scenario currently being supported.

The IMPP implements the following functions. It provides for transmission of brands or trademarks between customer and merchant, as well as recalculation of amounts by the merchant system; it makes available order-information exchange; it makes available age-checking facilities; it provides for the exchange of addresses with and without payment; it makes available an extension mechanism for the exchange of additional information within the established message flow; it makes available payment authentications including “capture now” devices for macropayments and micropayments; it provides for OfferID management; and it makes available an extension mechanism for the exchange of additional messages by way of the CPP. The integration and communication between a customer and the wallet server and between a merchant and the payment server is independent of the IMPP. The IMPP does not take into account the combination of various shopping and payment channels. Problems resulting from the combination of different shopping and payment channels are managed by the OPP part of the protocol stack. The IMPP provides a protocol layer in order to manage global communication between wallet servers and payment servers by way of a single processing platform.

The OPP and IMPP take into account payment, shopping, customer, merchant and Telco specific requirements. The IMPP contains a mechanism for transmitting messages from the upper protocol layers by way of the CPP. Various wallet servers or payment-server providers are capable of extending the function into a relatively high protocol layer without direct communication between wallet server and payment server outside the IMPP. Providers of wallet servers or payment servers implement the IMPP for communication by way of the CPP.

The IMPP handles the information exchange between all components included by way of the OpCo domain. This does not cover communication within the domains of issuer or acquirer. The IMPP processes the message flows described in the “order exchange” phase and “payment” phases of a 3D payment phase model.

IMPP messages are classified according to different kinds of regions. In particular, all message pairs in a single payment range are interpreted as OpCo. Normally these messages are sent out by the wallet server in order to carry out a payment transaction. The OpCo receives the message and interprets its content for purposes of transaction protocolling or fee management. Normally the messages are routed to the payment server for special processing. The corresponding response is sent to the wallet server by way of the CPP. In some special scenarios the CPP collects the arriving inquiry and sends an answer back to the wallet server. The CPP interprets all messages within this range. Other ranges include an extension range, a notification range and an offer range.

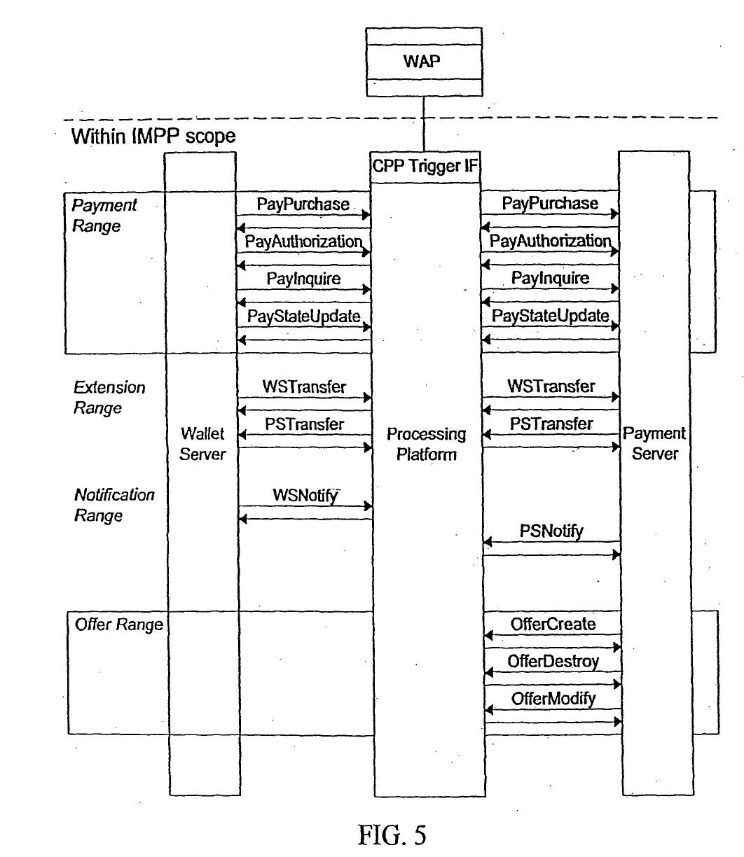

FIG. 5 illustrates IMPP messages, each type of which is explained below. In particular, the PayPurchase request is sent out by the wallet server in order to initiate a purchase by way of IMPP. This request is sent through the CPP to the payment server. The CPP acts as proxy for this message pair.

The PayInquire request is sent out by the wallet server in order to initiate an inquiry by way of IMPP. This request is sent through the CPP to the payment server. The CPP acts as proxy for this message pair.

The PayStateUpdate request is sent out by the payment server in order to update the transaction state on the wallet server. This request is sent through the CPP to the wallet server.

The WSTransfer request is sent out by the wallet server in order to initiate transfer of additional information by way of IMPP. This request is sent through the CPP to the wallet server. The CPP acts as proxy for this message pain. The WSTransfer message pair can be used to transfer messages from an upper protocol layer by way of IMPP. The content of this message pair is processed as an anonymous data item by the CPP.

The PSTransfer request is sent out by the wallet server in order to initiate transfer of additional information by way of IMPP. This request is sent through the CPP to the wallet server. The CPP acts as proxy for this message pair. This PSTransfer message pair can be used to transfer messages from an upper protocol layer by way of IMPP. The content of this message pair is processed as an anonymous data item by the CPP.

The WSNotify request is sent out by the wallet server in order to notify the CPP about additional items of information. The CPP processes the request and replies with an appropriate answer. For example, this request is used to inform the CPP about the interruption of message flow by the customer. By this means the CPP is enabled to perform what is needed within the CPP, e.g. to erase the dynamic OfferID in the context repository.

The PSNotify request is sent out by the payment server in order to notify the CPP about additional items of information. The CPP processes the request and replies with an appropriate answer. For example, this request is used to inform the CPP about an interruption of message flow.

The OfferCreate context inquiry is sent out by the payment server in order to generate a new OfferID in the context repository. After the request has been processed in the corresponding OfferID server, a response message is sent back to the payment server. This message pair is not visible to the wallet server.

The OfferDestroy context inquiry is sent out by the payment server in order to erase an OfferID entry in the context repository. After the request has been processed in the corresponding OfferID server, a response message is sent back to the payment server. This message pain is not visible to the wallet server.

The OfferModify context inquiry is sent out by the payment server in order to alter an OfferID entry in the context repository. After the request has been processed in the corresponding OfferID server, a response message is sent back to the payment server. This message pair is not visible to the wallet server.

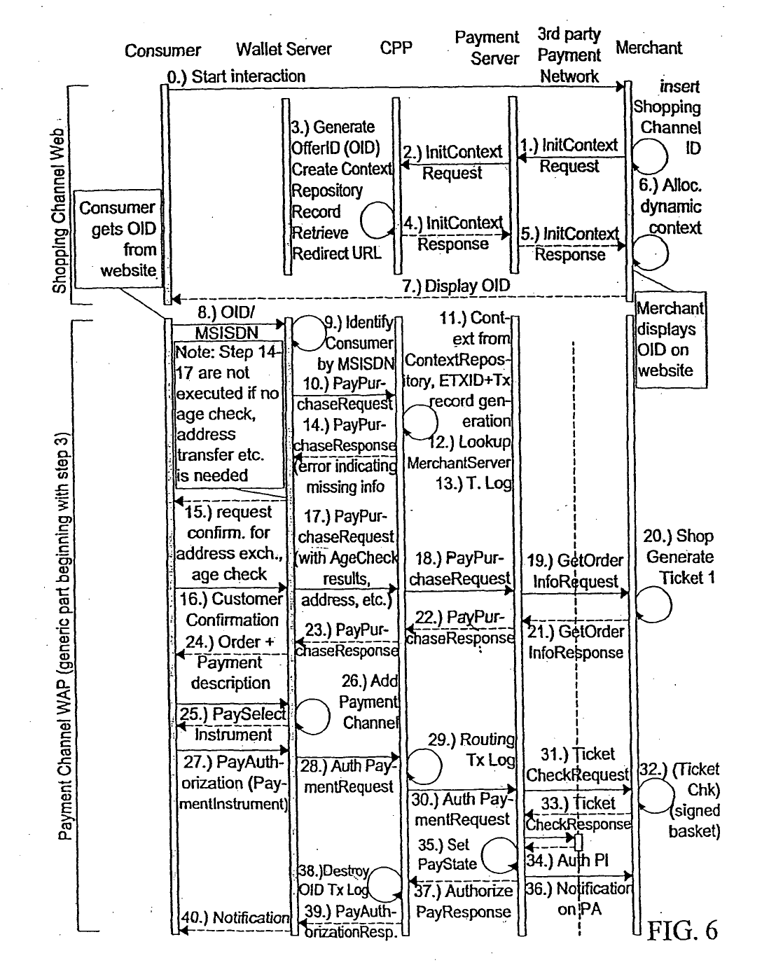

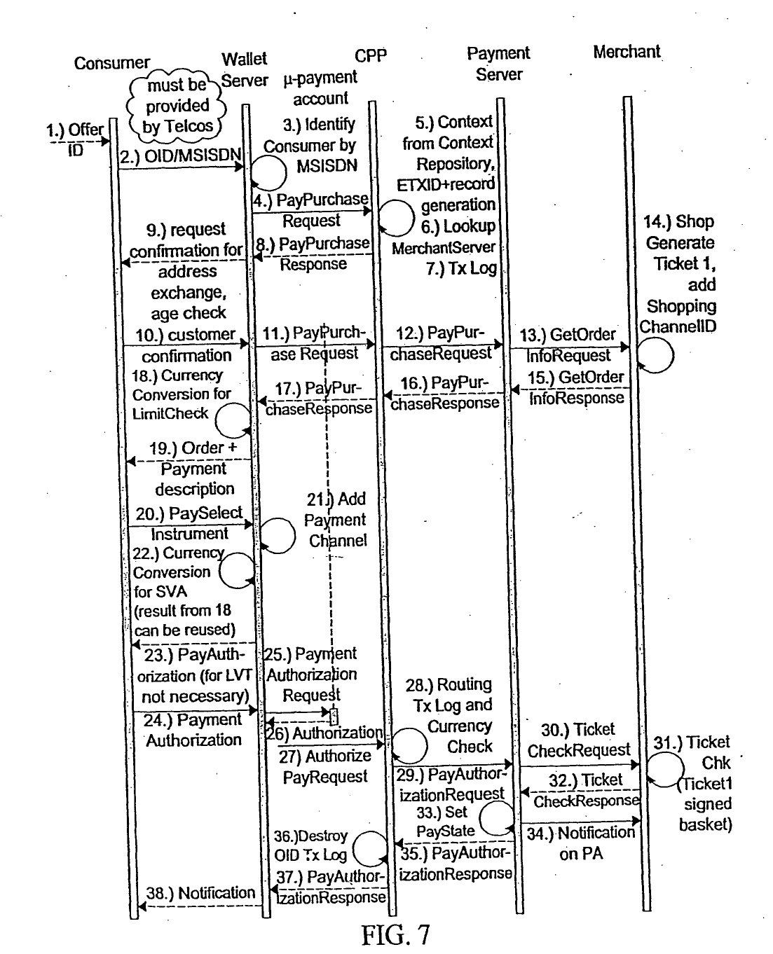

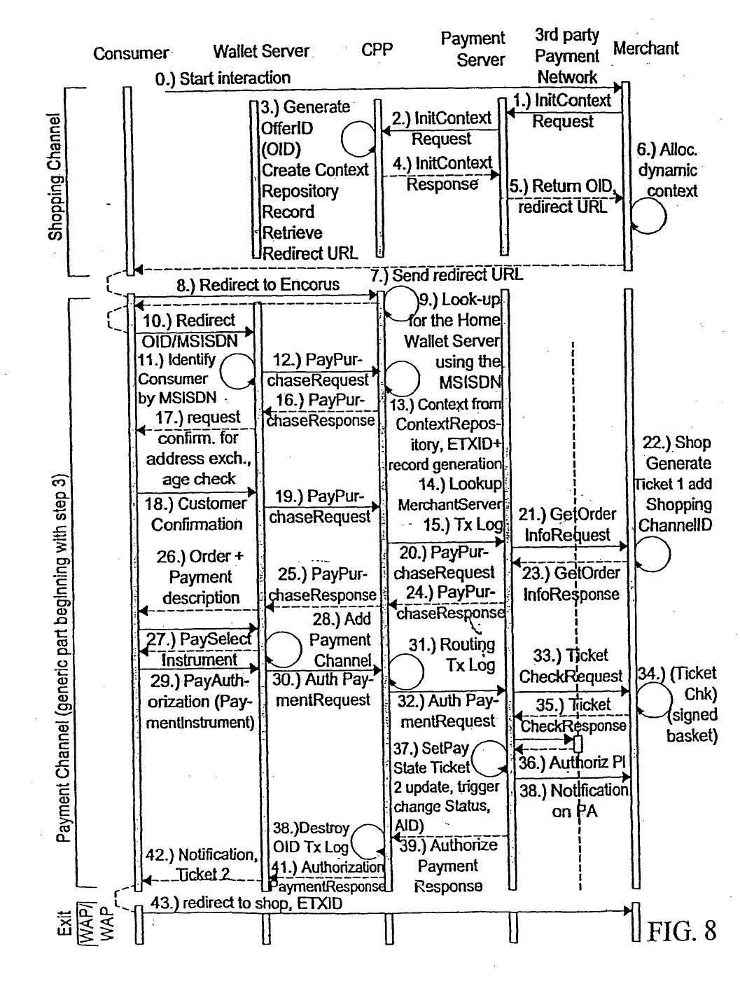

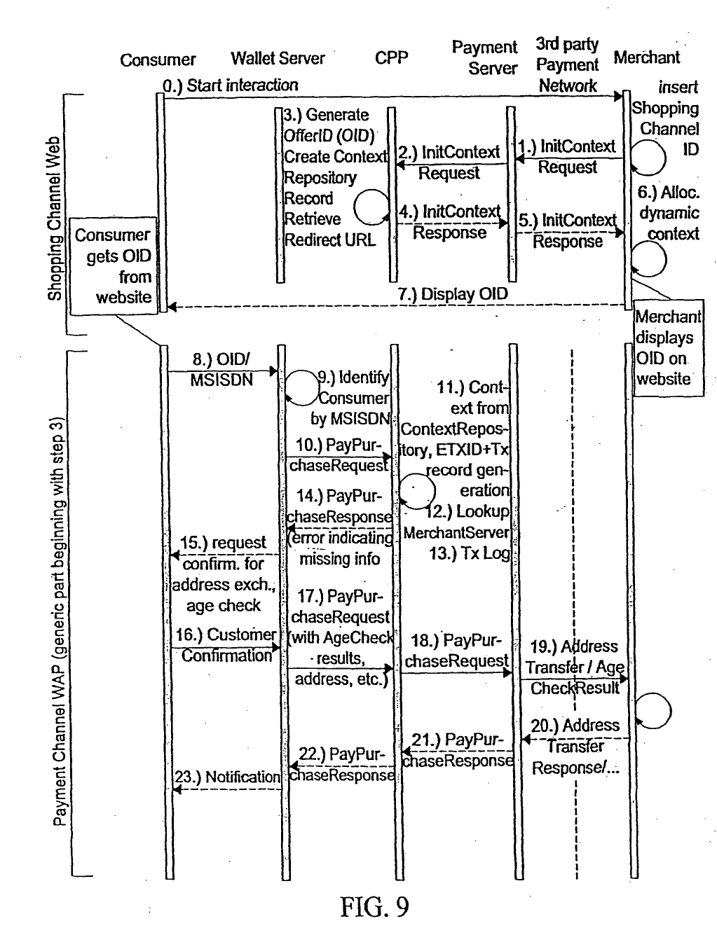

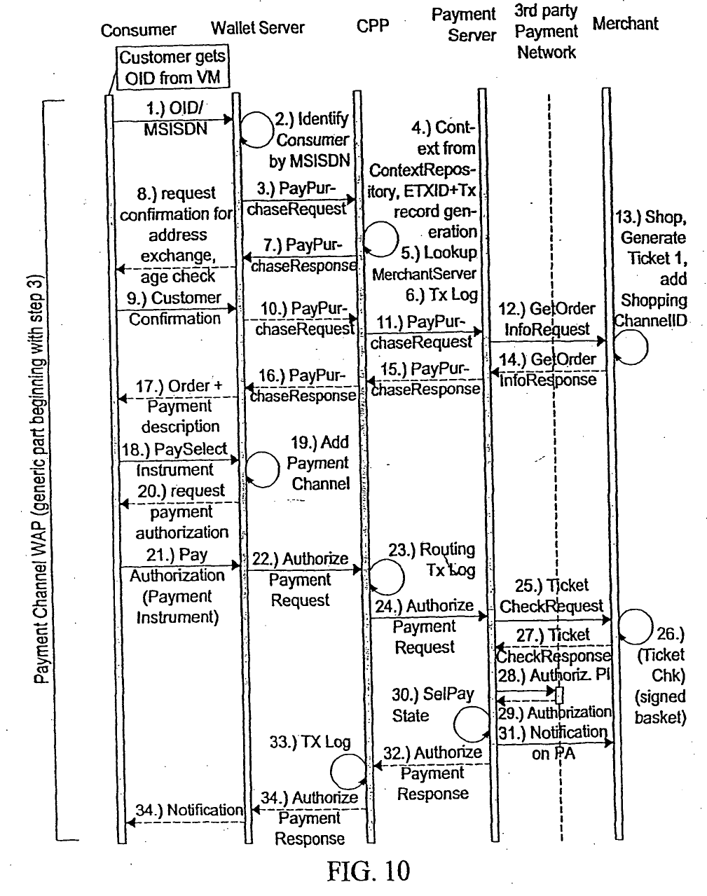

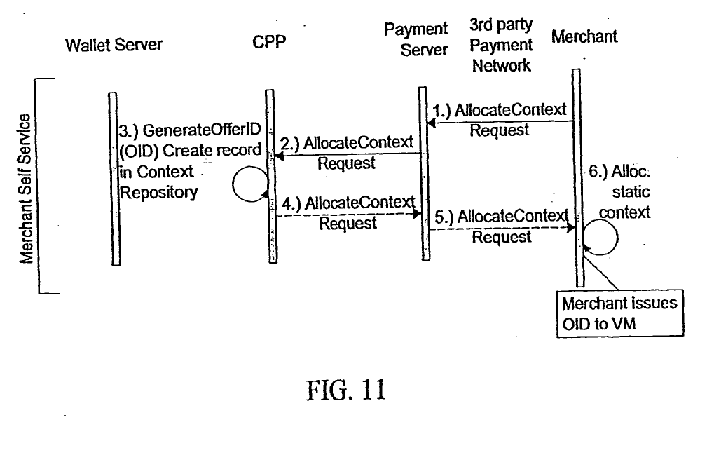

FIG. 6 illustrates a valid message sequence for the protocol. FIG. 7 illustrates an OfferID message sequence. The currency conversion is carried out on the side of the wallet server. FIG. 8 illustrates a WAP-WAP micropayment sequence. In FIG. 8 there are two redirections, in particular a redirection to the CPP, which was initiated by the merchant, and one to the home wallet server, which was initiated by the CPP. FIG. 9 illustrates a WAP-WAP address transfer without payment sequence and FIG. 10, a vending-machine macropayment sequence. FIG. 11 illustrates a static OfferID-generation sequence.

The OfferID can be in the following states.
Start state (SS);
Registered state (RS);
Created static state (CSS);
Created dynamic state (CDS);

Disabled state (DS):

| | SS | RS | CSS | CDS | DS |
|---|---|---|---|---|---|
| SS | — | R | CS | CD | — |
| RS | UR | M | CS | — | — |
| CSS | — | — | M | — | DA |
| CDS | D | — | — | M | — |
| DS | EA | — | — | — | — |

The following actions can be undertaken in order to change the OfferID state.
Registen (R);
Unregister (UR);
Create static (CS);
Create dynamic (CD);
Modify (M);
Destroy (D);
Enable (EA);
Disable (DA).

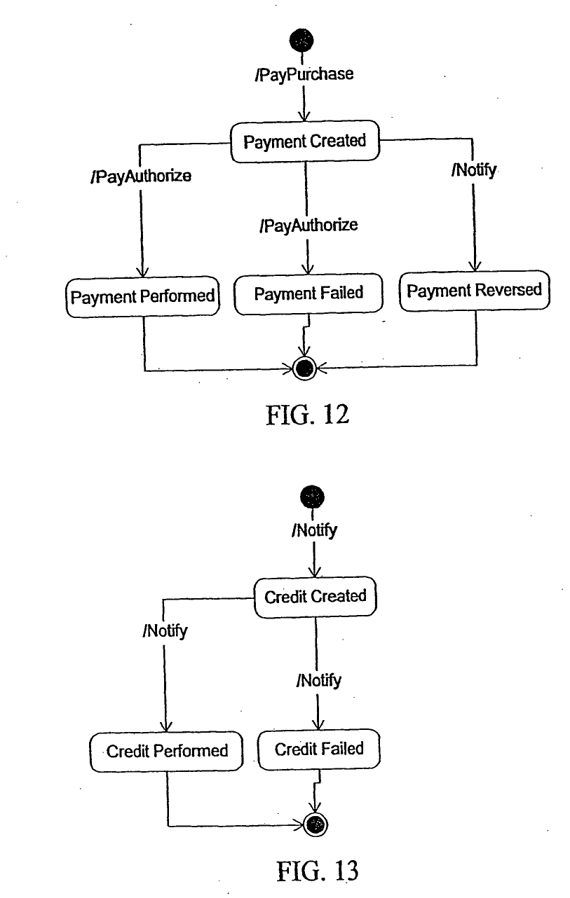

A feature shared by the dynamic transaction models for macropayment is that the proprietor of the transaction state is the payment server. In the state model shown in FIG. 12, the transaction states and transitions are used for a diverted macropayment, often termed “sales” transactions. No separate step for financing the payment is carried out on the side of the merchant/acquirer.

| State | WS | OpCo | PS |
|---|---|---|---|
| Payment created. | lnit: | Init: | Set: |
| | PayPurchaseReq( ) | PayPurchaseReq( ) | PayPurchaseReq( ) |
| | Notify: | Notify: | |
| | PayPurchaseRes( ) | PayPurchaseRes( ) | |
| | Ackn.: | Ackn.: | |
| | PayAuthorizeReq( ) | PayAuthorizeReq( ) | |
| Payment performed | Notify: | Notify: | Set: |
| | PayAuthorizeRes( ) | PayAuthorizeRes( ) | PayAuthonizeReq( ) |
| | Sync.: InquiryRes( ) | Sync.: InquiryRes( ) | |
| Payment failed | Notify: | Notify: | Set: |
| | PayAuthorizeRes( ) | PayAuthorizeRes( ) | PayAuthorizeReq( ) |
| | Sync.: InquiryRes( ) | Sync.: InquiryRes( ) | |
| Payment reversed | Notify: WSNotifyReq( ) | Notify: PSNotifyReq( ) | Set: internal |
| (by PS) | Ackn.: WSNotifyRes( ) | Ackn.: PSNotifyRes( ) | triggered |
| | or | or | or |
| (“Autoreversal” by | Init: WSNotifyReq( ) | Init: PSNotifyReq( ) | Set: |
| WS) | Notify: WSNotifyRes( ) | Notify: PSNotifyRes( ) | PSNotifyReq( ) |
| | Sync.: InquiryRes( ) | Sync.: InquiryRes( ) | |

The state model illustrated in FIG. 13 describes the transaction states and transitions used for a macropayment credit. It is used by merchants in order to issue a credit by a macropayment instrument. This is effected by merchants in order to refund a payment after the actual transaction has already been settled.

| State | WS | OpCo | PS |
|---|---|---|---|
| Credit | Notify: WSNotifyReq( ) | Notify: PSNotifyReq( ) | Set: |
| created | Ackn.: WSNotifyRes( ) | Ackn.: PSNotifyRes( ) | internal |
| | | | triggered |
| Credit | Notify: WSNotifyReq( ) | Notify: PSNotifyReq( ) | Set: |
| per- | Ackn.: WSNotifyRes( ) | Ackn.: PSNotifyRes( ) | internal |
| formed | | | triggered |
| Credit | Notify: WSNotifyReq( ) | Notify: PSNotifyReq( ) | Set: |
| failed | Ackn.: WSNotifyRes( ) | Ackn.: PSNotifyRes( ) | internal |
| | | | triggered |

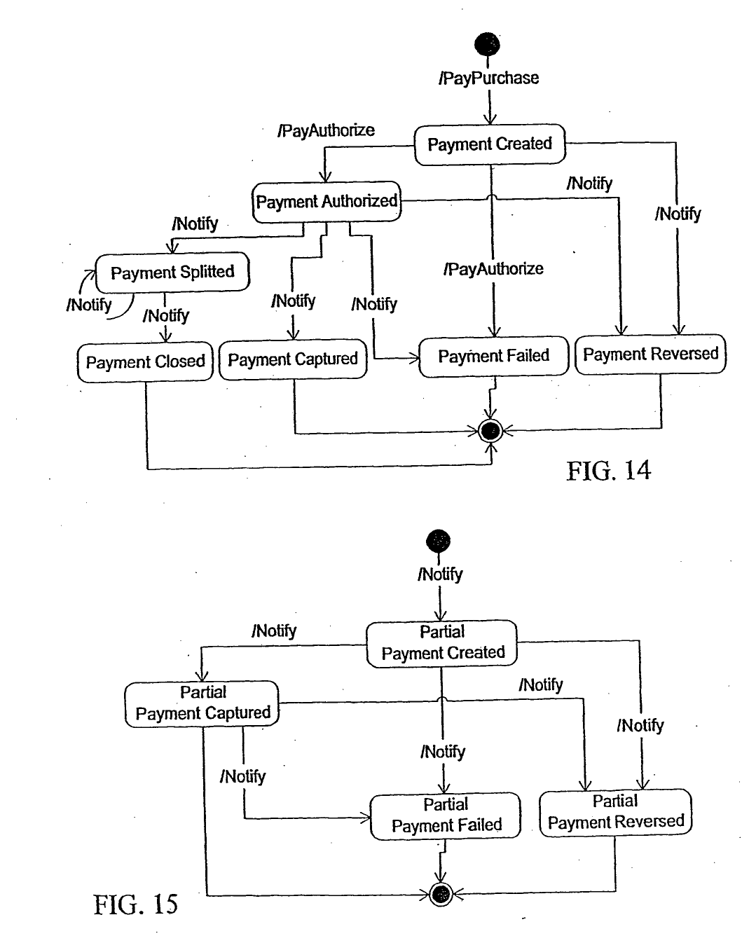

The state model illustrated in FIG. 14 describes the transaction states and transitions used in the case of delayed macropayments. This is employed when the merchant captures an authenticated payment with some delay, for instance when the merchandise is being delivered. If only a partial delivery is possible, the partial capture can be applied either once or continuously. The customer can keep track of the detailed payment state in his wallet. A state engine is made available for the duration of the initial transaction, and another state engine is made available for the duration of partial transactions.

| State | WS | OpCo | PS |
|---|---|---|---|
| Payment created | Init: | Init: | Set: |
| | PayPurchaseReq( ) | PayPurchaseReq( ) | PayPurchaseReq( ) |
| | Notify: | Notify: | |
| | PayPurchaseRes( ) | PayPurchaseRes( ) | |
| | Ackn.: | Ackn.: | |
| | PayAuthorizeReq( ) | PayAuthorizeReq( ) | |
| Payment performed | Notify: | Notify: | Set: |
| | PayAuthorizeRes( ) | PayAuthorizeRes( ) | PayAuthorizeReq( ) |
| | Sync.: InquiryRes( ) | Sync.: InquiryRes( ) | |
| Payment failed | Notify: | Notify: | Set: |
| | PayAuthorizeRes( ) | PayAuthorizeRes( ) | PayAuthorizeReq( ) |
| | Sync.: InquiryRes( ) | Sync.: InquiryRes( ) | or |
| | or | or | Set: internal |
| | Notify: WSNotifyReq( ) | Notify: WSNotifyReq( ) | triggered |
| | Ackn.: WSNotifyRes( ) | Ackn.: WSNotifyRes( ) | |
| Payment reversed | Notify: WSNotifyReq( ) | Notify: PSNotifyReq( ) | Set: internal |
| (by PS) | Ackn.: WSNotifyRes( ) | Ackn.: PSNotifyRes( ) | triggered |
| | or | on | or |
| (“Autoreversal” by | Init: WSNotifyReq( ) | Init: PSNotifyReq( ) | Set: |
| WS) | Notify: WSNotifyRes( ) | Notify: PSNotifyRes( ) | PSNotifyReq( ) |
| | Sync.: InquiryRes( ) | Sync.: InquiryRes( ) | |
| Payment captured | Notify: WSNotifyReq( ) | Notify: PSNotifyReq( ) | Set: internal |
| | Ackn.: WSNotifyRes( ) | Ackn.: PSNotifyRes( ) | triggered |
| Payment split | Notify: WSNotifyReq( ) | Notify: PSNotifyReq( ) | Set: internal |
| | Ackn.: WSNotifyRes( ) | Ackn.: PSNotifyRes( ) | triggered |
| Payment closed | Notify: WSNotifyReq( ) | Notify: PSNotifyReq( ) | Set: internal |
| | Ackn.: WSNotifyRes( ) | Ackn.: PSNotifyRes( ) | triggered |

FIG. 15 illustrates a state model for partial macropayment. A partial macropayment transaction has its own duration and the buyer's wallet is informed about all events relevant to partial payments.

| State | WS | OpCo | PS |
|---|---|---|---|
| Partial payment | Notify: WSNotifyReq( ) | Notify: PSNotifyReq( ) | Set: internal |
| created | Ackn.: WSNotifyRes( ) | Ackn.: PSNotifyRes( ) | triggered |
| Partial payment | Notify: WSNotifyReq( ) | Notify: PSNotifyReq( ) | Set: internal |
| captured | Ackn.: WSNotifyRes( ) | Ackn.: PSNotifyRes( ) | triggered |
| Partial payment failed | Notify: WSNotifyReq( ) | Notify: PSNotifyReq( ) | Set: internal |
| | Ackn.: WSNotifyRes( ) | Ackn.: PSNotifyRes( ) | triggered |
| Partial payment | Notify: WSNotifyReq( ) | Notify: PSNotifyReq( ) | Set: internal |
| reversed | Ackn.: WSNotifyRes( ) | Ackn.: PSNotifyRes( ) | triggered |

A feature shared by the dynamic transaction models for micropayment is that the proprietor of the transaction state is the wallet server, on the basis of the fact that the settlement system on the customer's side maintains the payment until settlement.

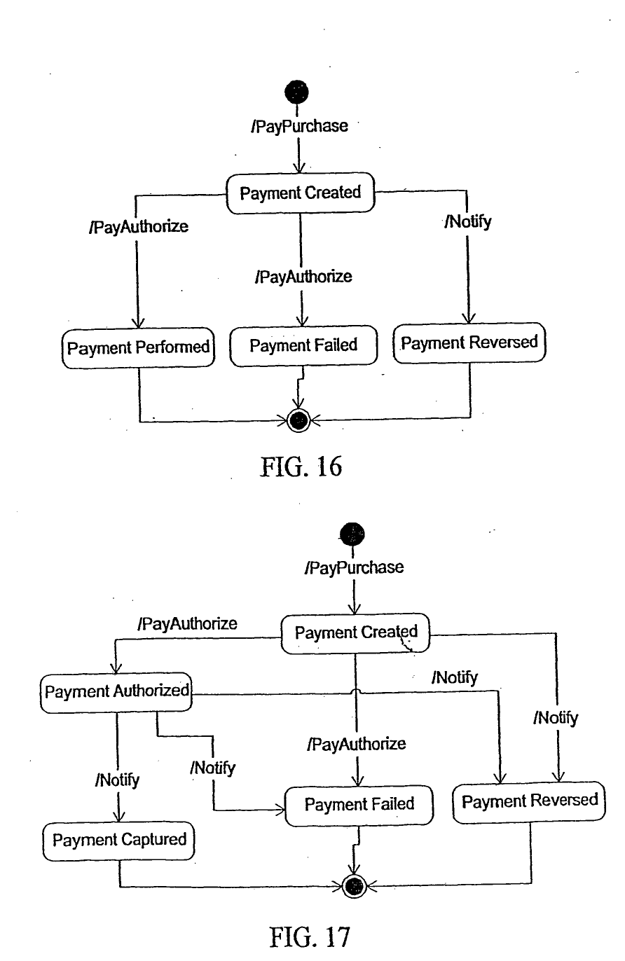

FIG. 16 illustrates the state model for the transaction states and transitions used for a diverted micropayment, e.g. a low-value transaction initiated at a vending machine.

| State | WS | OpCo | PS |
|---|---|---|---|
| Payment created | Set: internal | Notify: | Notify: |
| | triggered | PayPurchaseReq( ) | PayPurchaseReq( ) |
| | | Ackn.: PayPurchaseRes( ) | Ackn.: PayPurchaseRes( ) |
| Payment | Set: internal | Notify: | Notify: |
| performed | triggered | PayAuthorizeReq( ) | PayAuthorizeReq( ) |
| | | Ackn.: PayPurchaseRes( ) | Ackn.: PayPurchaseRes( ) |
| Payment failed | Set: internal | Notify: WSNotifyReq( ) | Notify: PSNotifyReq( ) |
| | triggered | Ackn.: WSNotifyRes( ) | Ackn.: PSNotifyRes( ) |
| | PayAuthorizeRes( ) | | |
| Payment reversed | Set: internal | Notify: WSNotifyReq( ) | Notify: PSNotifyReq( ) |
| | triggered | Ackn.: WSNotifyRes( ) | Ackn.: PSNotifyRes( ) |

FIG. 17 illustrates a state model for the transaction states and transitions used for delayed micropayments. This is used when the merchant captures only part of an authorized micropayment in conformity with the scheme, on captures it several times with very low capture amounts (for “instant” payment, e.g. “pay per time” or “pay per volume” business).

| State | WS | OpCo | PS |
|---|---|---|---|
| Payment created | Set: internal | Notify: | Notify: |
| | triggered | PayPurchaseReq( ) | PayPurchaseReq( ) |
| | | Ackn.: PayPurchaseRes( ) | Ackn.: PayPurchaseRes( ) |
| Payment | Set: internal | Notify: | Notify: |
| authorized | triggered | PayAuthorizeReq( ) | PayAuthorizeReq( ) |
| | | Ackn.: PayAuthorizeRes( ) | Ackn.: PayAuthorizeRes( ) |
| Payment captured | Set: WSNotifyReq( ) | Initiate: | Initiate: |
| | | PSNotifyReq( ) | PSNotifyReq( ) |
| | | Ackn.: WSNotifyRes( ) | Ackn.: PSNotifyRes( ) |
| | | Sync.: InquiryReq( ) | Sync.: InquiryReq( ) |
| Payment failed | Set: internal | Notify: | Notify: |
| | triggered, or | WSNotifyRes( ) | PSNotifyRes( ) |
| | Set: | Ackn: | Ackn: |
| | PayAuthorizeRes( ) | WSNotifyRes( ) | PSNotifyRes( ) |
| | | or | or |
| | | Notify: | Notify: |
| | | PayAuthorizeRes( ) | PayAuthorizeRes( ) |
| | | Sync.: InquiryReq( ) | Sync.: InguiryReq( ) |
| Payment reversed | Set: internal | Notify: | Notify: |
| | triggered or | WSNotifyReq( ) | PSNotifyReq( ) |
| | Set: | Ackn: | Ackn: |
| | PayAuthorizeRes( ) | WSNotifyRes( ) | PSNotifyRes( ) |
| | | or | or |
| | | Notify: | Notify: |
| | | PayAuthorizeRes( ) | PayAuthorizeRes( ) |
| | | Sync.: InquiryReq( ) | Sync.: InquiryReq |

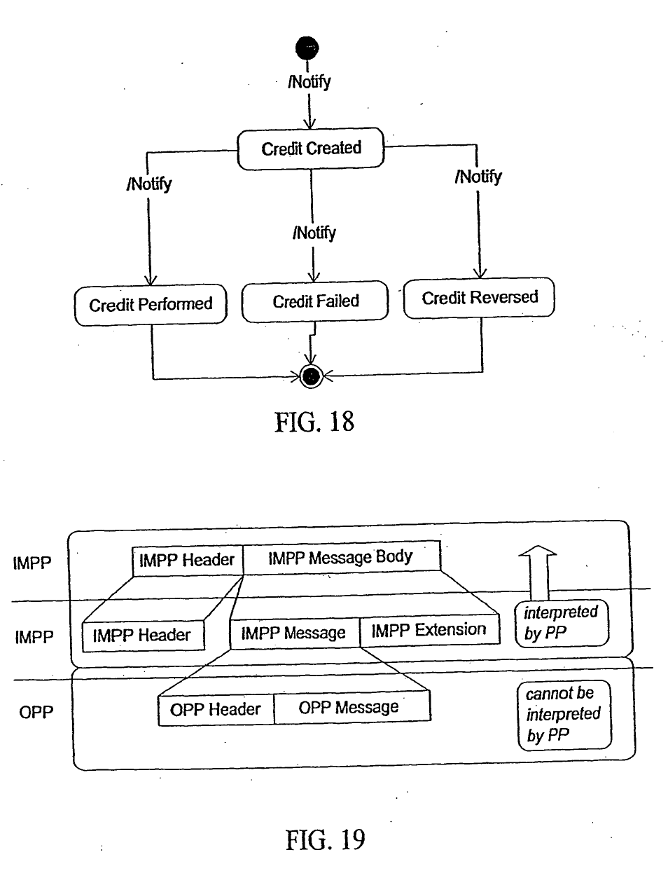

FIG. 18 illustrates a state model for transaction states and transitions that is used to carry out a micropayment credit This is used by merchants to transfer a credit to a customer micropayment instrument. The merchants need this in order to refund a payment after the actual transaction has already been settled.

| State | WS | OpCo | PS |
|---|---|---|---|
| Credit | Set: WSNotifyReq( ) | Initiate: | Initiate: |
| created | | PSNotifyReq( ) | PSNotifyReq( ) |
| | | Notify: | Notify: |
| | | WSNotifyRes( ) | PSNotifyRes( ) |
| | | Sync.: | Sync.: |
| | | InquiryReq( ) | InquiryReq( ) |
| Credit | Set: WSNotifyReq( ) | Initiate: | Initiate: |
| performed | | PSNotifyReq( ) | PSNotifyReq( ) |
| | | Notify: | Notify: |
| | | WSNotifyRes( ) | PSNotifyRes( ) |
| | | Sync.: | Sync.: |
| | | InquiryReq( ) | InquiryReq( ) |
| Credit | Set: WSNotifyReq( ) | Initiate: | Initiate: |
| reversed | | PSNotifyReq( ) | PSNotifyReq( ) |
| | | Notify: | Notify: |
| | | WSNotifyRes( ) | PSNotifyRes( ) |
| | | Sync.: | Sync.: |
| | | InquiryReq( ) | InquiryReq( ) |
| Credit failed | Set: WSNotifyReq( ) | Initiate: | Initiate: |
| | | PSNotifyReq( ) | PSNotifyReq( ) |
| | | Notify: | Notify: |
| | | WSNotifyRes( ) | PSNotifyRes( ) |
| | | Sync.: | Sync.: |
| | | InquiryReq( ) | InquiryReq( ) |

The IMPP message structure is a two-layered structure, consisting of a message wrapper (an HTTP request or response) and a message (an XML entity). An IMPP message is synchronously processed and comprises an XML message element (request/response pair), which is contained (wrapped) in the corresponding HTTP request and reply. This request/response pair constitutes a complete protocol conversion unit. When an IMPP message is simply routed to another unit by a particular technical function, only the message wrapper is processed by the routing unit. The message itself can remain unprocessed, in order to avoid extra processing beyond XML syntax analysis (parsing) and writing.

The message wrapper depends on the protocol in use, which is HTTP/1.0. Consequently the transport wrapper is a valid HTTP/1.0 request/response header according to RFC822. The HTTP request procedure (verb) is POST.

Request

| Attribute | M | # | Type | Format | Remarks |
|---|---|---|---|---|---|
| Request Line | X | 1 | RFC1945 | POST SP URI SP | URI is the path of one of the |
| | | | | HTTP/1.0 CRLF | following: PayPurchaseURL |
| | | | | | PayReqURL, InquiryURL |
| | | | | | NotifyURL etc. |
| Connection: | X | 1 | RFC822 | Keep-Alive CRLF | |
| Content type: | X | 1 | RFC822 | Application/xml; SP | |
| | | | | charset = “utf-8” CRLF | |
| Content length: | X | 1 | RFC822 | nn CRLF | nn is the length of the |
| | | | | | message following this |
| | | | | | request header, in bytes |
| Content-Transfer- | X | 1 | RFC822 | Binary CRLF | Binary for XML by way of |
| Encoding: | | | | | HTTP, can also be base64 |
| | | | | | for others, restricted transport |
| New line | X | 1 | RFC822 | CRLF | Separator between header |
| | | | | | and body |
| Body | X | 1 | RFC822 | | |

Response

| Attribute | M | # | Type | Format | Remarks |
|---|---|---|---|---|---|
| Status Line | X | 1 | RFC1945 | HTTP/1.0 CRLF | Status Code Reason is the |
| | | | | Status code SP | HTTP status code and |
| | | | | Reason CRLF | expresses the reason for the |
| | | | | | message, either 200 OK or |
| | | | | | 50x (in case of a transport |
| | | | | | error) |
| Connection: | X | 1 | RFC822 | Keep-Alive CRLF | |
| Content type: | X | 1 | RFC822 | Application/xml; SP | |
| | | | | charset = “utf-8” CRLF | |
| Content length: | X | 1 | RFC822 | nn CRLF | nn is the length of the |
| | | | | | message following this |
| | | | | | request header, in bytes |
| Content-Transfer- | X | 1 | RFC822 | Binary CRLF | Binary for XML by way of |
| Encoding: | | | | | HTTP, can also be base64 |
| | | | | | for others, restricted transport |
| New line | X | 1 | RFC822 | CRLF | Seperator between header |
| | | | | | and body |
| Body | X | 1 | RFC822 | | |

FIG. 19 illustrates an IMPP message structure. The request and the response to a message are both represented as a serialized XML structure. The XML root element <ImppMessage> contains an XML “element only” element <Header> and precisely one request or one response XML “element only” element. The <header> element contains the subelements id (for message idempotency) and version.

Document-type declaration
Element definition
<!ELEMENT ImppMessage (Header, (...))>
Element definition
<!ELEMENT Header, (id, version)>

A generic exemplary message is as follows:

```
<ImppMessage>
    <Header>
    </Header>
    <PayPurchaseRequest>
    <!--...-->
    </PayPurchaseRequest>
</ImppMessage>.
```

As a consequence of the message structure, once a connection has been made after exchange of a complete protocol conversion unit, it can be re-used in order to exclude a TCP connect/accept/close overhead and to enhance efficiency. The HTTP keep-alive protocol is used to reconcile the technical functions involved at the application level. A connection that has already been made can be re-used in the same direction, i.e. within the same client/server role allocation.

The applications of the wallet server and payment server process non-repudiation. Either corresponding attributes in the protocol elements or extended elements/attributes can be used. The VPN processes the encryption of every communication between wallet servers and OpCo as well as between payment servers and OpCo. The VPN creates connections between two parties only if those parties have implemented a successful mutual authentication. Before application data can be sent, the authentication process must have been concluded.

The protocol also specifies a mechanism for version negotiation between the technical functions, but is independent of the particular rules for version compatibility. The protocol comprises sending the protocol version being used as part of the message header.

Within a given protocol message sequence only one version is used. The version negotiation flow is symmetrical and it does not matter whether the sequence has been initiated by the wallet server, the payment server or the OpCo itself. Furthermore, an appropriate error code is specified in order to indicate version incompatibility. If the OpCo, as a consequence of version incompatibility, cannot route a message to the recipient, this is treated as a technical fault.

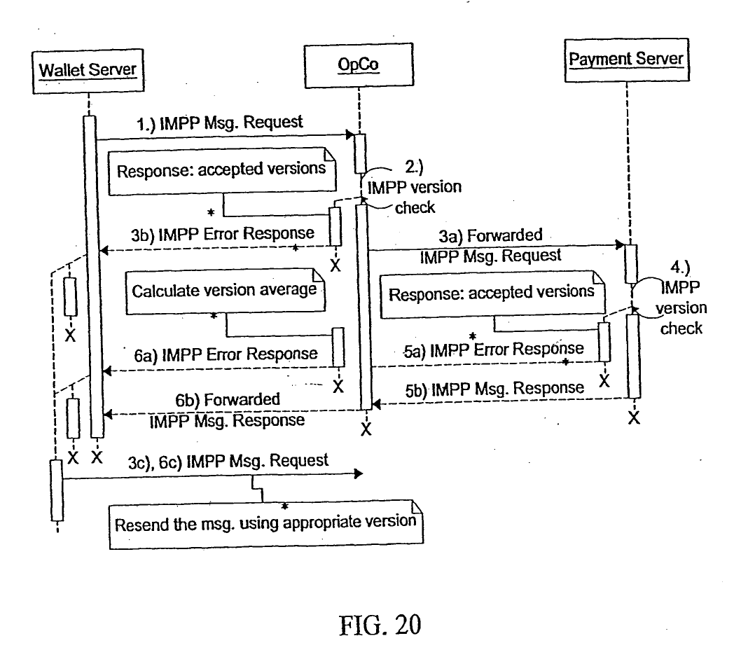

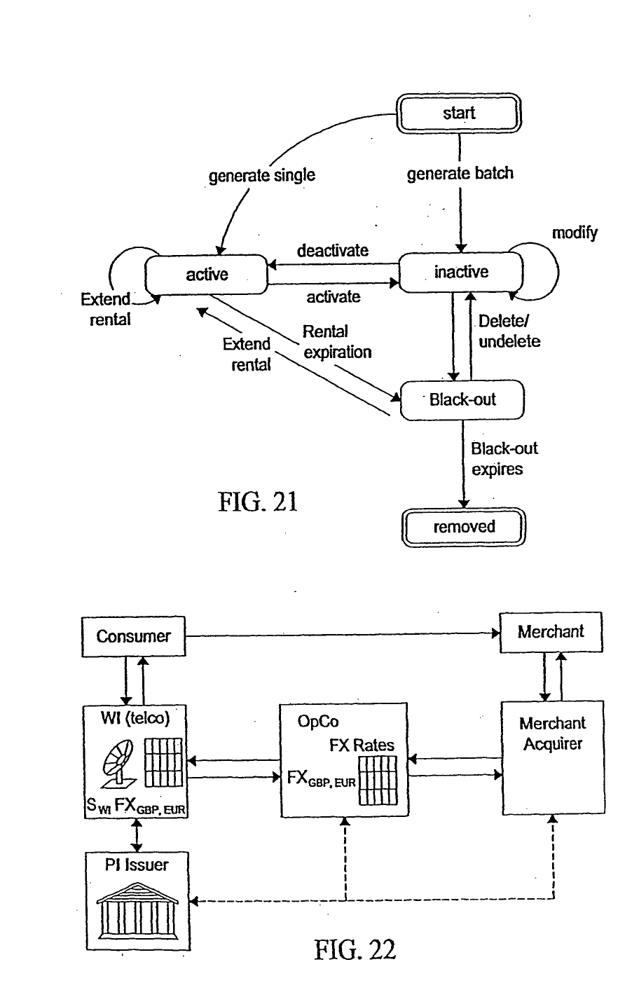

The version-negotiation process is illustrated in FIG. 20 and described in the following.

| | |
|---|---|
| Step 1. | A payment component sends an IMPP request to the |
| | OpCo, employing the highest IMPP version supported |
| | by the sender. |
| Step 2. | The OpCo checks the version and processes the result. |
| Step 3. | a) Check OK: the request is forwarded to the recipient |
| | b) Check not OK the OpCo sends back an error |
| | message, which contains the IMPP versions that the |
| | OpCo does support |
| | c) Re-sending: the payment component sends the IMPP |
| | request again, employing the highest common version, |
| | or stops with an error. |
| Step 4. | The payment component checks the version and |
| | processes the result. |
| Step 5. | a) Check OK: the response is sent back to the OpCo |
| | b) Check not OK: an error message containing the |
| | IMPP versions supported by the recipient is sent back to |
| | the OpCo. |
| Step 6. | a) The OpCo produces a version intermediate between |
| | its own and the version supported by the recipient, and |
| | returns an error message containing this information to |
| | the sender. |
| | b) The OpCo sends the normal response back to the |
| | sender. |
| | c) Re-sending: the payment component sends the IMPP |
| | request again, employing the highest common version, |
| | or stops with an error. |

From the perspective of an IMPP participant, IMPP flows occur in pairs. Each message transmitted by a participant as a request elicits a response from an answering participant. The error flow (in contrast to other flows) is determined with respect to the requester and the responder, because it is used when the responder cannot reliably identify the incoming message. An error response indicates that a responder rejects a message because there is a format error on it has failed content-checking tests. The responder sends an error response (or rather, a negative response code) when the responder cannot trust any one of the fields in the incoming message. Ordinarily an error response is used to answer a sender of a message directly, when it is impossible to specify the error unequivocally in terms of the erroneous value in a field. The error message is not used to indicate results experienced in normal exchanges, such as a rejected authentication. Transaction results are announced by explicit codes in standardized response messages.

Errors in the IMPP system can derive from a number of different sources. For example, IMPP messages can be grammatically interpretable (parsable) but malformed, in that they do not conform to the requirements of the protocol. Values can be wrong, or messages can be damaged, ordinarily as a result of transmission errors.

With regard to duplicate messages, sufficient information appears in the clear text of the message wrapper so that it can be determined whether a message is a new transfer or not. The recipient's response to a duplicate message depends on the idempotency property (described in detail below) of the message type, the number of duplicated messages, the source of the duplicated messages and the observed frequency between sequential duplicate messages. If there is reason to suspect that a system has been exposed to spamming or junk advertising, duplicate messages can be ignored.

A damaged message is a message that cannot be parsed. Ordinarily a potentially damaged message should not be received, because the information-transport mechanisms will cause damaged data to be returned. If a damaged message is nevertheless received, a corresponding error message is sent back, indicating receipt of the damaged message and providing a request/response-pair identifier of the message, if available. It is acceptable to ignore the message entirely if insufficient data could be extracted to enable a response. With regard to malformed messages, a corresponding error message is returned by the sender if a message is parsable but in other respects is erroneous because it contains out-of-range values or inconsistent options.

An application generates no error message as response to another error message. All IMPP components send an error message when a low-level processing error is encountered by an IMPP response message. Every message that is not recognized as IMPP message is ignored. The IMPP components ordinarily avoid the transmission of error messages on the same channel as request messages.

The following fields are established for error.
ErrorCode: numerical code that defines the error condition.
ErrorDescription: a free description of the cause of the error.
ErrorObjectID: the object identifier of a critical extension that is not supported and thus triggered the error.

ErrorMessage: the message that generated the error.

| Error code | Description |
|---|---|
| BadMessageHeader | The message header cannot be processed. |
| MessageNotSupported | This valid message type is not supported by |
| | the recipient. |
| MessageTooBig | The message is too large to be processed by |
| | the recipient. |
| MessageTooNew | The date of the message is too recent to be |
| | processed by the recipient. |
| MessageTooOld | The date of the message is too long ago to be |
| | processed by the recipient. |
| ParsingXMLFailure | An error occurred during parsing of the XML |
| | structure of the message. |
| UnknownETxID | An unknown EtxID was received. |
| UnknownMSG | An unknown message was received. |
| UnknownMSID | An unknown payment-server ID was received. |
| UnknownOID | An unknown offer ID was received. |
| UnknownWSID | An unknown wallet-server ID was received. |
| UnrecognizedExtension | The message contains a critical extension that |
| | cannot be processed by the recipient. The |
| | ErrorObjectID field recognizes the extension. |
| UnspecifiedFailure | The reason for the error does not appear |
| | anywhere in this list. |
| VersionTooNew | The version number of the message is too new |
| | to be processed by the recipient. |
| VersionTooOld | The version number of the message is too old |
| | to be processed by the recipient. |
| WrapperMsgMismatch | The contents of the message wrapper are |
| | inconsistent with the interior content of the |
| | message. |

The IMPP protocol is based on request/response pairs throughout the entire protocol. The error message does not conform to this paradigm, because it can be a response to either a request or a response. In the former case, there is no difficulty, but in the latter case problems can arise if the underlying transport is based on a request/response paradigm, as is a World Wide Web Browser. In this case the error message can be sent as a request message and the protocol will not demand any response message (the underlying protocol can be put into time-out mode). For an error message sent as result of the operational limitations of a World Wide Web Browser, it may be necessary to have a user permit.

The HTTP message header contains a state code that indicates the processing state of the corresponding message unit as a whole. Every business error is indicated by the components, regardless of the message status. The following state codes are defined as a particular message, which the 5xx state-code regions of the HTTP standard use to display application-specific errors.

| Error Code | Description |
|---|---|
| 200 OK | Is set in the case of successful processing of |
| | a message as a whole, regardless of whether |
| | a business error has occurred (i.e., “Credit |
| | Card expired”). |
| 501 Routing error | Is returned in case of an unknown target |
| | address in the request. |
| 502 Version not | Is returned in case the request uses an |
| supported | unsupported protocol version. When OpCo |
| | receives this from the ultimate recipient of the |
| | message, this is also reported back to the |
| | sender. |
| 503 Content type not | Is returned in case the HTTP request contains |
| supported | an unsupported content type. |
| 504 Content coding not | Is returned in case the HTTP request contains |
| supported | an unsupported content coding. |
| 505 Transfer error, try | For repeated sending in case of a problem with |
| again later | the transfer technology. |
| 506 Message | Is set when the idempotency check of a |
| idempotency infraction | particular message fails because of altered |
| | request content, in the case of a request that is |
| | already stored in the idempotency database. |
| 507 Invalid message | Is set when the body of the message could not |
| | be parsed, the idempotency was checked and |
| | transmitted to the processing system on the |
| | basis of erroneous formatting of the body (e.g., |
| | XML parse error). |
| 508 Unspecified | Is set when the body of the message could not |
| processing error | be parsed, the idempotency was checked and |
| | transmitted to the processing system on the |
| | basis of any error other than 501-507 (e.g., |
| | XML rate error). |

In the case of a state code different from 200, the XML body of the HTTP response is omitted. In addition, the application-independent state codes such as are specified by HTTP are used for all HTTP-specific outputs (e.g., 400 Bad request).

When an operation can be carried out arbitrarily often without any damage resulting, it is termed idempotent. From the perspective of the IMPP idempotency is a property of how a recipient responds to a message. Every request in the IMPP that does not receive a response is sent again, because the sender does not know whether the request or the response has been lost. The transferred message is identical in terms of bits to the original request message. Ordinarily a duplicate message is not an error condition.

The IMPP protocol operates in environments in which delivery of a message is not guaranteed. When an IMPP application does not receive a response in a reasonable period of time (determined by the application or possibly by a user's inquiry), it sends the message again. When the receiving IMPP application determines that it has previously processed the same message, it calls up the previous response and sends the previous response again.

When the sender of a message does not receive the response, it is ordinarily not possible to determine whether the request or the response has gone astray. Further complicating the situation is the fact that the original request can simply be delayed somewhere in the network, and then possibly will be processed shortly before the re-transferred request arrives. Therefore the protocol enables the sender to repeat the request with the guarantee that the result will be the same regardless of whether the request or the response has been lost. Not all IMPP messages demand idempotency. The IMPP contains messages so configured that they can be sent at any time, so that it is not necessary for a recipient to store every request in order to determine whether a duplicate was received. The IMPP products guarantee idempotency of the protocol by checking a transaction identification key and generating a time stamp in the message header. For instance, a payment server rejects attempts to repeat PayAuthorization requests from a wallet server. The payment server recognizes such attempts by checking the message header of the PayAuthorization request. When an IMPP component detects that it is being exposed to malicious spamming or junk advertising, which incorporate none or more idempotent IMPP message types, it is not necessary to respond to these messages in this situation.

The IMPP component can utilize every procedure to identify idempotent requests. One possible procedure consists in storing the SHA-1 hash in the message header of all messages. When a duplicate is detected, the hash of the message header can be generated and used to find out a stored idempotency entry. When proceeding in this way the IMPP component must retain a complete copy of each arriving request, but can generate a bit-wise identical response. A bit-wise response is here generated as a new response with the same information. When several responses are received to an idempotent request, the recipient can ignore all such responses after the first one.

An IMPP component is not required to answer messages if it detects that it is being exposed to malicious spamming or junk advertising associated with one or more IMPP message types. The IMPP components can set up their own criteria for detecting such attacks.

In the following, description or similar scenarios that include idempotent message flows are treated. These scenarios describe two transfers of the same request, but depending on the conditions at the time of the failure the requests can be repeated several times. Combinations of these scenarios are also possible.

Delayed request or response: An idempotent request is sent, but the delivery of either the request or the response is delayed, so that the recipient does not receive an answer on time. The request is transmitted again; the receiving IMPP component processes the first request and sends the response back when it receives the second response.

Lost requests: An idempotent request is sent, but the message is not delivered because of a network failure. The request is sent again.

Lost response: An idempotent request is sent and is answered, but the response is not delivered because of a network failure. The response is sent again. The receiving IMPP component processes the first request and sends the response back when it receives the second request.

It is necessary to make available a mechanism that extends IMPP payment messages. Because there is no place provided for these items of information in the IMPP message, a protocol extension is used. The mechanism employed to extend IMPP messages resembles the way in which X.509 certificates are extended. In particular, an extension field is made available that contains a sequence of extension data. The extension data indicate the type of extension and the criticality of the extension.

An extension comprises three components. In particular there is an object key, which unambiguously identifies the extension. This key allows IMPP components to recognize an extension and process data. A criticality identifier indicates whether the recipient understands the extension for processing the message that contains the extension. The data make available the additional business information that make it necessary to determine the extension. The layout of the data is determined by the organization that has set up the extension.

The criticality identifier is a Boolean value. An extension is classified as critical if this value is True. Otherwise the extension is classified as uncritical. The default value is False. If an extension is critical, recipients of the message recognize and process the extension. If an extension is uncritical, recipients that cannot process the extension are sure that the data can be ignored.

A set of information objects is produced for each data structure that can contain an extension. These sets specify the extensions that are allowed in the data structure for processing.

IMPP applications fit into one of two categories: in particular, an application that does not support any message extensions, and an application that supports certain selected sets of message extensions. An IMPP component that supports no message extensions detects the presence of an extension in a message and checks the criticality identifier. If the extension is critical, the IMPP component does not process the message and returns it with an error code UnrecognizedExtension. If the extension is uncritical, the application can ignore the data in the extension and proceed to process the rest of the message. An application that does support message extensions detects the presence of an extension in a message and processes the extension as follows.

1. If the application supports the object key for this message, the data in the extension are processed.

2. If the application does not support the object key for this message and the extension is critical, the application does not process the message and returns it with an error code UnrecognizedExtension.

3. If the application does not support the object key for this message and the extension is uncritical, the application can ignore the data in the extension and proceed to process the rest of the message.

The OpCo is the ultimate element in the decision whether a given data element is encoded within a message. The OpCo can refuse to employ any kind of extension containing data that could impair the integrity of the IMPP. Every extension is identified by its extension name, proprietor name and an unambiguous extension key. An IMPP component can decide to employ a critical extension for transferring additional information as part of the normal IMPP message flow. If the receiving IMPP component does not understand the data without the extension and therefore cannot process these data, the message should be rejected.

With regard to the transactions, their management is distributed, i.e. a wallet server and payment server involved in a transaction communicate by using IMPP messages. Both servers contain a state mechanism, e.g. waiting for responses, checking for time-outs and sending request and restoration messages in the case of errors. The CPP likewise maintains state information, because IMPP messages are routed through the CPP. The “proprietor in a transaction is the party responsible for the primary state transitions for the duration of a particular transaction. The synchronization mechanism that is used depends on the technical proprietorship of the transaction. There exist various possible proprietorships for various IMPP-supported payment models, as described below.

| Payment model | Proprietor of the transaction state |
|---|---|
| Direct macropayment | Payment server |
| Delayed macropayment | Payment server |
| Balance macropayment | Payment server |
| Direct micropayment | Wallet server |
| Delayed micropayment | Wallet server |
| Credit micropayment | Wallet server |

The IMPP makes available the messages or message sequences that are appropriate to support the payment model. There exist at least two different possibilities for synchronizing transactions by way of IMPP.

1. Notify/Acknowledge: the distribution of items of information by way of a state transition is triggered by the proprietor of the transaction.

2. Synchronize: the distribution of items of information by way of a state transition is triggered by a remote participant in the transaction.

Notify/Acknowledge is available if it is supported in the relevant protocol flow. If it is available, only one notification is carried out per transition. As a result, unacknowledged notifications are ignored by the proprietor. Synchronization is available to remote participants for multiple inquiries about a final state. The states and their transitions are described precisely from the protocol perspective, which means an abstraction of the implementation in the payment components. If a component requires the “history” of a state, i.e. the transition that has led to this state, the component can alternatively maintain a “composite state”. Furthermore, every payment component establishes its own path for deleting transactions, i.e. in order to convert an ultimate business state into an ultimate technical state. This is performed asynchronously and is not covered by IMPP protocol messages. The transition phases are described further below.

| | |
|---|---|
| TX phase | Initiation and distribution mechanisms for state |
| | transitions |
| Set | If the state transition is carried out at the |
| | proprietor of the transaction by processing of |
| | an IMPP message of the associated protocol |
| | message |
| Notify | The IMPP message used by the proprietor to |
| | notify the remote participant of the transition |
| Acknowledge | The IMPP message used by the remote |
| | participant to acknowledge the state transition |
| Synchronize | The IMPP message used by the remote |
| | participant to resynchronize the state transition |

Payment Processing

There follows a detailed description of processes that are carried out by the exemplary embodiment of the CPP. In particular, the customary processing is described along with the processing associated with OfferIDs, negative files, currency conversion, transaction protocols, micropayment clearing and settlement, and fee management.

For mobile payments all requests and responses are routed between the wallet-server and payment-server stages. Other CPP components that carry out centralized tasks, such as the OfferID generator, the look-up service and the TX server, are used by the routing engine to support the payment process. Transaction-protocol entries are generated in order to comply with legal requirements and to enable off-line-mode processes such as fee billing. Address-change requests, age-check requests and requests for changing the payment instrument are supported in just the same way, together with regular payment inquiries. Quality identifiers are transferred together with these requests/responses and indicate the degree of quality of the underlying data.

The routing engine receives external notifications of macropayment authentications and captures, and completes the transaction protocols and exchange notifications regarding state changes between the other involved parties, in order to keep the transaction protocols of WS, MS and CPP consistent with one another.

In the case of micropayments, the authentication is carried out between WI and the offerer of the micropayment instrument. Therefore authentication tokens are transferred to the payment server as part of the payment message flow. For transactions currently in progress, the routing engine maintains transaction data sets in which all the information about a transaction is stored together with an unambiguous transaction ID (TX_ID).

In redirection scenarios the routing engine makes available a redirection component that processes the instruction “Redirects”; as a result, the customer's browser is redirected from the merchant URL to its home-wallet URL by way of a CPP-URL and directly back to the merchant URL after the transaction has been concluded. The redirection component makes available a central redirection URL, which merchants can customarily use to display the OfferID. Furthermore, the buyer can input MSISDN/alias in a trusted environment, in order to enable push or fall-back scenarios (in case MSISDN cannot be recognized). To support forward scenarios, the redirection component routes the buyer's alias to the wallet server. The WS then triggers an IVR call or WAP push to the buyer. The redirection component should not be used for non-mobile customer notification (Web-Web scenario), e.g. with alias PIN, because customer authentication is the responsibility of the wallet server.

In WAP-WAP scenarios the routing engine supports “Redirects” in which the customers browser is redirected from the merchant URL to its home-wallet URL by way of an OpCo URL and directly back to the merchant URL after the transaction has been concluded. The CPP makes available a central URL in order to display the OfferID. Therefore the merchant does not need to integrate the display of the OfferID into the shopping flow. Furthermore, this URL makes available input fields for MSISDN/alias, in order to initiate a push.

Transactions between merchants and customers that belong to the same firm, e.g. MNO, are termed “on us” transactions, to which special rules can be applied. When “on us” transactions are implemented between a wallet server and an MA server and both of these are operated by the same firm in a single country, these transactions can be processed by the OpCo without routing.

The CPP identifies an “on us” scenario and sends an appropriate response back to the WS. When the authentication phase has been completed, the CPP is notified by the PS, in order to remove the OfferID and to store the “on us” relationships between the WS and PS stages (applies to both variants). Every transaction going through the CPP is checked to determine whether the transaction is of the “on us” type, in which case the “on us” identifier is set within the transaction data set (applies to both variants). When an “on us” transaction has been detected, the payment flow that has been initiated is terminated by sending the PS search information to the WS.

All requests that derive originally from either the wallet server or payment servers are protocolled together with the ID of the relevant wallet server or payment server. This protocolling of “on us” transactions is actuated in the same way as for scheme transactions, but the “on us” identifier is set.

The search service on request carries out searches for the wallet server and the payment server. On the basis of an OfferID the search service seeks out the relevant payment server by examining the OfferID repository. In the reverse direction, the home wallet server can be called up by accessing the participant list.

The search for the PS and merchants involved in a transaction is actuated on the basis of the OfferID or RangeID. When the search is based on an OfferID, the BasketID is analyzed and transferred to the MC together with the OID, in order to obtain information about the shopping basket. The merchant then decides whether the OID or the BasketID should be used to identify the shopping basket. When the search is based on a range ID, the combination of range ID and merchant catalogue number is transferred to the MC in order to obtain information about the shopping basket.

The list of participants contains all MSISDNs and aliases of the buyer who has been listed for mobile payment. For each MSISDN/alias the home wallet server ID is likewise stored. The MSISDNs/aliases that are not listed can also be rejected by the CPP at an early point in this process.

The wallet-server elements utilize on-line requests or generate a flat file containing all new or altered participants, and transfer the file to the OpCo in order to update the list of participants. Aliases are generated at the WS in agreement with the alias-generation rules (3 numerals identify the WI, 8 numerals serve as buyer ID and there is one check-sum number).

OfferIDs The OfferID-server component of the CPP comprises the OfferID generator, which generates an OfferID on request, and the OfferID repository, which stores generated OfferIDs together with additional data for searching purposes, and oversees their duration. The OfferID-numbering system ensures that, however many OfferIDs are in use at a given time, the number of digits in use can vary to ensure that as few as possible are in use at any time. For some mobile payment scenarios (e.g., bank notes) the size of the OfferID is not at all critical. The minimal length of an OfferID depends on the requested duration, as follows:
<=1 hour, shortest available (minimum 4 digits)
1 hour-1 day [shortest available (minimum 4 digits)]+2
>1 day [shortest available (minimum 4 digits)]+4
redirection 16 digits

The length of the OfferIDs (see above) is configurable. Depending on the contract with a merchant, particular ranges of OfferIDs can be reserved for a merchant. The merchant pays a use fee for the range and can make use of every (catalogue) number according to the range identifier to represent the ID for his offer. By using this mechanism the merchant can re-use existing catalogue numbers by simply adding to each of them his specific merchant prefix.

Check-sum tests enable the wallet server to check an OfferID immediately and request additional user inputs, with no need to communicate with the CPP. The probability of mistakenly identifying another active shopping basket by erroneously inputting a false OfferID should be low enough to make the risk tolerable. At least one single wrong numeral, extra or absent numerals and interchanged numerals can be detected. The check-sum number is not available for RangeIDs.

OfferID/RangeID Structure

Prefix n digit content
Check-sum
Prefix n digits RangeID M digits merchant content

The prefix (not necessarily a whole number) conveys certain items of control information, for which it is important to call them up directly, without accessing the OID repository. Ordinarily no MerchantID exists that is coded with the OID. The sole exception is RangeIDs, for which the OID consists of a range identifier and a merchant-specific extension.

For installations in various regionals the CPP_ID is encoded in the OfferID prefix, so as to enable OID routing. The OfferID generator generates OfferIDs on request. Both static and dynamic OfferIDs can be generated. OfferIDs are issued only once. The same OfferID can also be employed for subsequent payment transactions (e.g., VM, TV shopping). Static OfferIDs are “rented” on a monthly or yearly basis by the merchants. When the rental contract expires, the OID switches to the “black-out” state, from which the OID can be reactivated if the merchant continues the rental agreement. The merchant must manage the parallel use of the static OID.

OfferIDs characterize a temporary offer with a specified duration and are used exclusively by a single customer. An OfferID is automatically deleted as soon as a transaction is ended or the maximal duration is exceeded. Bank-note scenarios, for instance, use a dynamic OfferID with a prolonged duration. If a customer breaks off a transaction after entering the OfferID, the OID is not deleted. However, all OfferIDs can be explicitly deleted upon request.

With regard to dynamic OfferIDs, an OfferID is specified as such upon the merchant's request. After its duration has elapsed, the state is set to “black-out”. The maximal duration amounts to one month. While the black-out is in force, OIDs cannot be issued again. The black-out duration is configurable and depends on the duration of validity of the OID:
Terminated, 1 hour
0 to 10 minutes, 1 hour
10 to 16 minutes, 6 hours
1 hour to 24 hours, 1 day
1 day to7days, 1 week
1 week minus 4 weeks, 2 weeks
1 month to 12 months, 1 month

When analyzing an OID the merchant can set particular attributes in order to indicate the type of request (payment, age check, address transfer, transfer of PI details). With a request for an OID the merchant can hand out a list of brands to support brand matching with PI-detail transfers. The shopping BasketID can be connected to the OfferID.

To generate static OfferIDs, the OfferID is determined by the merchant upon request for a static OfferID. After the rental duration has elapsed, the OfferID state is switched to “black-out”. The minimal rental duration is 1 month. The rental duration begins with generation of the OID, not with its activation. The request for a single OID can be carried out by the MC Oust as for dynamic OID). Because the shopping BasketID is transferred along with the request, the static OID is automatically activated after the request. The merchant can analyze the generation of a batch of OfferIDs according to the CPP numbering scheme. This request is implemented by a merchant's own actions and not directly by the merchant component. As a result, the merchant receives a file containing all the generated OIDs and the date on which the rental duration elapses. With the RangeIDs the merchant acquires the possibility of re-using existing catalogue numbers with the mobile payment scheme. Upon request for a RangeID the merchant specifies the number of SubIDs that are desired. During the search the merchant is identified. The combination of RangeID and catalogue number is routed to the merchant, in order to is obtain the shopping basket.

The OfferID repository contains all items of information about ascertained OfferIDs. When age checking, address exchange or PI data transfer is asked for, the relevant flags are set in the OfferID-repository data set. The OfferID repository monitors the OfferIDs that have been issued and sets states to “black-out” as soon as an associated duration has been reached. The OfferID repository also supports the manual deletion of requests. The search service utilizes the OfferID repository to obtain information from the associated payment servers.

In order to connect the static OID with another basket or to alter the request types, the OfferID repository supports the inactivation of OIDs. The MC allows inactivation only for individual OIDs. This feature can also be used when an article is temporarily not obtainable or the merchant would like to extend the duration of the black-out. The rental duration is not prolonged by the inactivation. When several OIDs must be inactivated, the MSS is used.

The repository supports the alteration of static OIDs (i.e., coupling to other BasketIDs, types of alteration requests or prolonging the rental duration). The repository supports the batch modification of static OIDs (i.e., coupling to other BasketIDs, types of alteration requests or prolonging the rental duration). This request is carried out by the MSS.

An individual OID can be activated. It is also possible to activate several OIDs by way of the MSS. In order to undertake such activation, the merchant loads a list of BasketIDs together with all other request parameters. After the OID block has been generated, the merchant receives a location file.

The OfferID repository automatically deletes OIDs when their duration has elapsed or when a transaction has been ended. An interruption on the buyers side does not result in deletion of the OID. The OID repository also allows for the deletion of OIDs in single and batch mode. Deletion of dynamic OIDs results in their immediate elimination, whereas in the case of static OIDs deletion sets the OID state to black-out.

By way of the MSS the merchant can reinstate an OID that is in the black-out state. Static OIDs must be blacked out when the rental contract expires. While the black-out lasts, the merchant is able to reactivate the OID by extending the rental duration by way of the MSS.

Negative Files

The negative-file service makes available a central and consolidated database with which to black out merchants as well as customers. The wallet-server and payment-server stages can check a request against the databank as well as synchronize their local negative-file indexes with the negative-file service at the processing platform.

By way of the CPP an individual merchant can be added to the negative file together with a time entry. In addition, the negative file can be checked in order to determine whether a data set regarding an individual merchant exists. A merchant acquirer can initiate this check externally. Furthermore, an individual merchant can be removed from the negative file. A list of merchants can also be imported into a negative file. If a merchant is already included in the negative file, the associated data set is skipped. Merchant data sets in the file can also be marked for removal. During the importing process these merchants are removed from the negative file. A merchant negative file can also be exported. For instance, a file can be downloaded or transferred to a merchant acquirer in order to update a local negative file.

An individual buyer can be added to the negative file together with a time entry in the data set. The negative file can be checked in order to determine whether it includes a data set regarding an individual buyer. A wallet issuer can initiate this check externally. The CPP can also check every transaction against the internal negative file. An individual buyer can be removed from the negative file. A list of buyers can also be imported into a negative file. If a buyer is already included in the negative file, the associated data set can be skipped. Buyer data sets in the file can also be marked for removal. During the importing process these buyers are removed from the negative file. A file containing all negative-file data sets that were generated after a certain time can be exported. This file can then be downloaded or transferred to a wallet issuer in order to update a local negative file.

All actions to modify the negative file are protocolled. The historical negative-file data are s stored and a state (e.g., listed, blocked, inactive, deleted) is retained. After a certain period, (i.e., three years) deleted entries are physically removed from the negative-file data sets.

Currency Conversion

The system supports three different currencies: the currency underlying the transaction; the registered currency of the buyer at the WI; and the currency with which the MA settles the account with the CPP. For international micropayments the amount of a transaction is converted from the transaction currency to the WI settlement currency (the buyers inland currency) before the authentication of the customer and deduction from the SVA. Because both currencies are indicated to the customer and the SVA is debited on the basis of the underlying exchange rate, currency risks can exist; these are covered by additional exchange-rate charges.

The OpCo is subject to a currency risk when authenticating a μPI, if clearing with the MA cannot be completed on the same day. In these cases the OpCo can make an additional charge on top of the exchange rate.

The currency-conversion table stores exchange rates. A data set is generated for each pair of currencies (EUR/GBP) and (GBP/EUR). The time mark stores the information about the last updating of the data set. Additional state information (e.g., expired, valid) can be stored in the “state” field. The currency-conversion table is updated on a prespecified, regular basis by making contact with an appropriate service provider, from which the present exchange rates can be obtained and imported into the conversion tables to update them. The time stamp and state are likewise updated.

The state field in the currency-conversion table is switched to “expired” when the currency pair was updated a specified number of days previously (i.e., one day, configurable). Expired currency pairs have no influence on the currency conversion.

The conversion table can be exported into a file that is downloadable by the wallet offerer or the OpCo finance department. The exchange rates include the OpCo surcharge. An exemplary table is given below.
Currency code merchant (ISO)
Currency code customer (ISO)
Format (decimals)
Conversion factor
Time stamp
State (current, expired)

With regard to the surcharge tables, additional OpCo surcharges are stored in an extra table (i.e., a surcharge table). One data set is generated for each currency pair (EUR/GBP and GBP/EUR). The time stamp stores the information regarding the last update of the data set. Additional state information can be stored in the “state” field (e.g., expired or valid). Administrators can update surcharge percentages for currency pairs by transferring a flat file is to the FX server, the values in which are then imported into the surcharge table. An example of a surcharge table is as follows:
Currency code merchant (ISO)
Currency code customer (ISO)
Surcharge percentage
Surcharge amount

Ordinarily the CPP converts amounts on the basis of exchange rates and CPP surcharge, and transfers the results to the categories TX currency, converted currency and exchange rate. This process allows synchronization of the exchange rate to be omitted, because the most recent exchange rate is used. The currency conversion is done according to the rules of the European Central Bank (ECB). When units of a national currency are expressed as EUR, the amount comprises six numbers before and/or after the decimal point. When amounts are converted into EUR, intermediate results are calculated to a minimum of 3 decimal places (after the decimal point). Currency amounts issued in EUR are rounded up or down to the nearest euro cent.

An interface to an offerer of international currency exchange rates (i.e., Reuters, Bloomberg, Bridge or Telerate) is introduced. The finance department of the WIs or OpCo's can download an exported exchange-rate file.

Administration arrangements are made available to OpCo administrators and the finance or securities department of the OpCo. These arrangements comprise, e.g., management of the flow for obtaining exchange rates by way of the fixed interface to the exchange-rate offerer, the establishment of rules for updating the state, viewing and manually editing exchange rates, viewing and manual editing of exchange-rate surcharges, and viewing the exchange protocol and the history data. In order to ensure that the responsible administrator is notified immediately, the administrator is alarmed by certain event triggers. For instance, the following event triggers cause messages to be sent to the administrator:
Error: Import of exchange rates failed
Error: Export of files failed
Warning: Exchange rate expired
Warning: Conversion carried out with expired exchange rate after presetting

The administrator receives alarms as a message in the administrator GUI, and can additionally choose also to receive them by e-mail or SMS. The administrator uses the administrator-service GUI to access more detailed error lists/reports. More detailed error messages are not transferred with a notification.

Furthermore, all changes in the currency exchange rate are protocolled. Historical data are stored for legal purposes (10 years). For refunds the FX is determined from the TX protocol and not taken from the file for historical data. The transaction protocol serves as the basis for fee calculations and resolving disputes. Several protocol levels are supported on a request basis. For instance:
Protocolling all events with all attributes
Protocolling the events only with key attributes
Protocolling of only the events
Protocolling of only the errors.

The protocol data are stored for processing for up to three months. Thereafter the transaction protocols are archived for 10 years. In all operational processes the legal requirements are met, e.g. the data-protection law. A NewCo data-protection strategy should be established and made binding on all NewCo participants, in order to increase buyers confidence.

Micropayment Clearing and Settlement

The CPP clearing and settlement (C&S) service processes clearance inquiries initiated by merchant acquirers, and aggregates the amounts to be settled by the MA and cleared with the μPI offerer. Additional settlement data sets and statements are generated in order to make settlement details available to all μPI offerers (WI and MM). The transfer of funds is initiated at a main booking system. For merchant acquirers the C&S service supports settlements in both single and multiple currencies. For multiple-currency settlements the MA is calculated in various TX currencies. For each MA the main-data data set displays all settlement currencies of the MA and shows whether the MA was selected for single-currency or multiple-currency settlements.

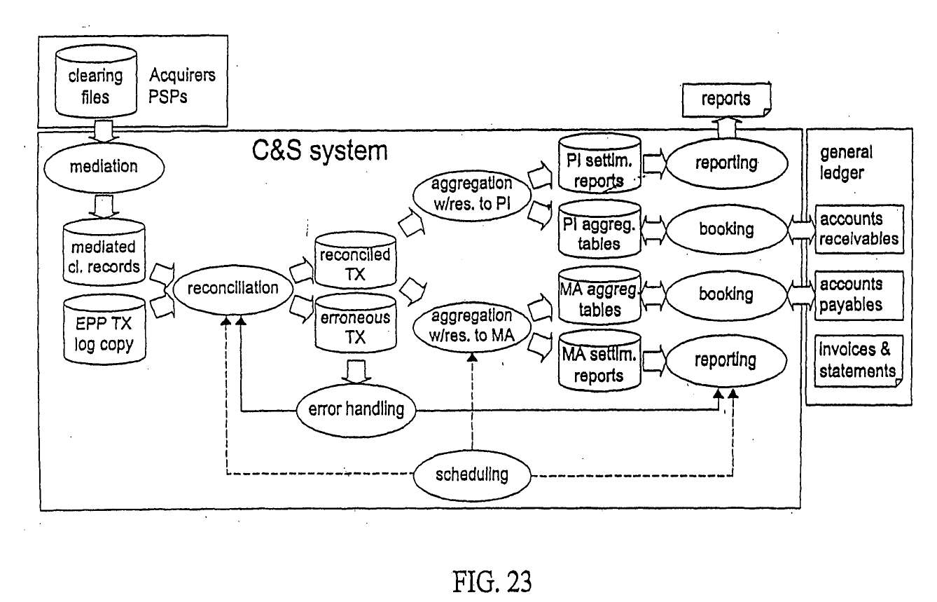

The task of clearing and settlement can be subdivided into the following steps, as shown in FIG. 23 and described below:
5 1. Preprocessing (mediation and reconciliation)
2. Clearing with MA (aggregation with respect to MA)
3. Clearing with μPI offerer (aggregation with respect to μPI offerer)
4. Booking (initiation of settlement)
5. Rejection and returning process (error handling)
6. Dispute handling
7. Fraud detection
8. Management

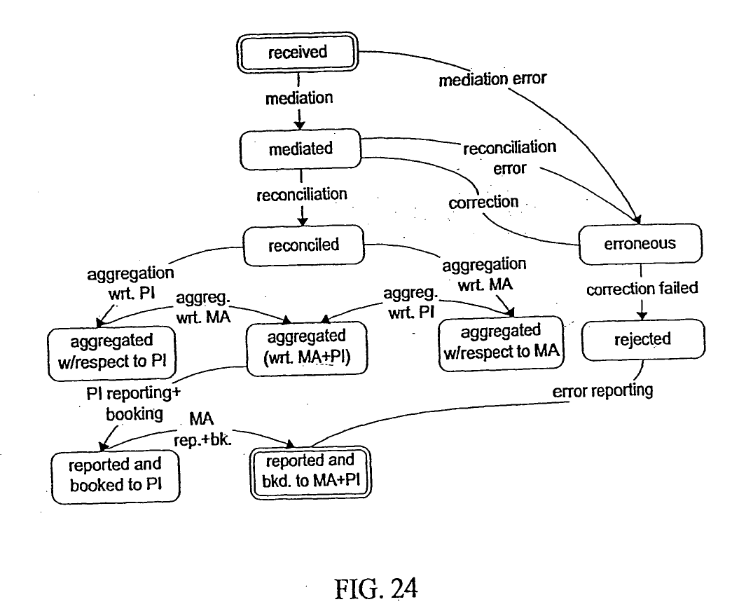

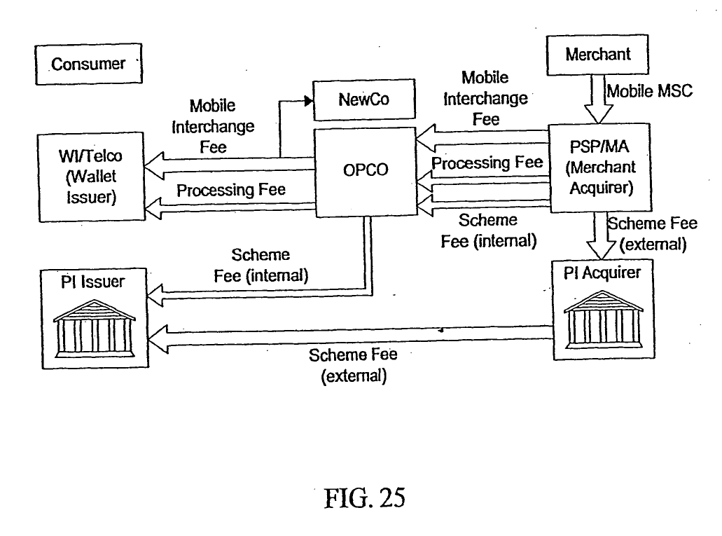

When a clearing data set passes through the C&R process, it assumes various states as shown in FIG. 24. Preprocessing (mediation and reconciliation) is a linear process. Aggregation with respect to the PIs and MAs can be done in parallel. The result of the process is documented in a settlement report (including error codes) and an aggregation table that is used for booking in the general ledger.

The merchant acquirer initiates C&S by sending the clearing file, including a capture/authentication token, to the CPP-C&S service. According to the clearing sequence, the C&S service makes the MA clearing file consistent with the internally assembled transaction protocols. A “settlement report” is generated to inform the merchant about all transactions that are being settled as well as all rejected transactions.

A TX clearing data set contains the acquirer ID, payment-instrument ID, transaction ID, amounts and the processing state, as described below:
MA_ID
μPI_ID
TX_ID
Authentication time and date
Authentication (capture) token
Capture time and date
Transaction currency
Amount (in TX currency)
Buyer's currency
Amount (in buyers currency)
FX rate
Flag “clearing file received”+time stamp
Flag “reconciliation completed”+time stamp
Reconciliation state (accepted/rejected), error code
Flag “aggregated with respect to MA”+time stamp
Flag “aggregated with respect to PI”+time stamp
Flag “booked for MA settlement”+time stamp
Flag “booked for PI settlement”+time stamp
Flag “report to MA”+time stamp
Flag “report to PI”÷time stamp

Transaction data from the MAs are compared, in order to check their validity, with the internal CPP-TX protocols associated with the same time span. Data sets that are not consistent are collected in an error file. The error file serves as the basis for error detection and the parts attributable to a special MA are copied into the settlement report of that MA. Four classes of consistent results are possible.

TX Agreement

TX incompatibility: incompatibility between data belonging to the same TX in the settlement file and in the EPP TX protocol.

Extra TX: the MA's settlement file contains a capture for which there is no counterpart in the EPP TX protocol.

Missing TX: the EPP TX protocol contains a capture with no counterpart in the MA's settlement file. (The protocol data set is marked “missing TX” when no capture has been entered for clearance within a certain time, e.g. one week; “garbage collection”.)

Clearing with the MA offerer occurs according to the MA clearing sequence. Transaction data sets that have been reconciled during preprocessing are aggregated with respect to each merchant acquirer. The aggregation process results in an MA settlement report and forms the basis for the MA settlement (aggregation table).

Transactions that have been successfully reconciled are aggregated with respect to each MA and each settlement (transaction) currency. The aggregation table stores amounts collected over a particular settlement period. The format of the aggregation table is as follows:
MA_ID
Beginning of settlement period (date and time)
End of settlement period (date and time)
Table-generation time stamp
Settlement currency
Total number of aggregated transactions
Absolute settlement amount (in TX currency)
μPI_ID 1
Number of transactions for μPI_ID 1
Settlement amount for μPI_ID 1
μPI_ID 2
Number of transactions for μPI_ID 2
Settlement amount for μPI_ID 2
. . .
Flag “booked for MA settlement”+time stamp
Flag “reported to MA”+time stamp

For every settlement currency a separate aggregation table is calculated. The aggregation table forms the basis for booking (initiating the settlement) and part of the settlement report is sent to the MA. The settlement report contains results of the reconciliation and aggregation steps (including error messages) with respect to a particular merchant acquirer. According to the report sequence the settlement report is stored in the appropriate MA directory (presumably daily).

Clearing with the μPI offerer occurs according to the PI-clearance sequence. Transaction data sets that have been reconciled during preprocessing are aggregated with respect to each payment-instrument provider. The aggregation process results in PI settlement reports and forms the basis for the PI settlement (aggregation table). Reconciled data sets are aggregated with respect to each MA and each settlement (transaction) currency. The aggregation table stores amounts collected over a particular settlement period.
μPI_ID
Beginning of settlement period (date and time)
End of settlement period (date and time)
Table-generation time stamp
Total number of aggregated transactions
Total settlement amount (in TX currency)
Flag “booked for PI settlement”+time stamp
Flag “reported to PI”+time stamp

The aggregation table forms the basis for booking (initiating the settlement) and part of the settlement report is sent to the PI offerer. The settlement report contains results of the reconciliation and aggregation steps (including error messages) with respect to a payment-instrument offerer. According to the report sequence the settlement report is stored in the appropriate PI directory (presumably daily). The CPP-C&S service triggers the G/L system in such a way as to initiate the physical transfers of funds to the MA and from the PI offerer. The OpCo settles gross amounts with the PI offerer (autopayment). Fees are settled separately. For PI booking the CPP looks through the PI aggregation table and generates a flat file with booking data sets (e.g., direct debit requests) for input of a batch to a G/L system (e.g., SAP FI) and sets the flag for the associated protocol data sets and the aggregation table. For MA booking, the CPP looks through the MA aggregation table and generates a flat file with booking data sets for input of a batch to a G/L system (e.g., SAP FI) and sets the flag for the associated protocol data sets and the aggregation table. In the case in which MA desires a multiple-currency settlement, a separate payment sequence is initiated for each settlement currency.

The G/L prints invoices and instructions and initiates transfers of funds. The fund transfer can follow another sequence than does the booking, e.g. may depend on the amount to be settled. The reconciliation step identifies erroneous transactions, which are stored in an error-TX file. An attempt is made to correct errors manually. Results of this error-correction step (e.g., “corrected” or “rejected”) are included in the relevant MA settlement report. Rejected data sets are identified by error codes.

In order to detect insider frauds reports are generated so that the correct processing of settlement-related data can be monitored and suspect behavior identified (e.g., deletion of aggregation tables, manual bookings, protocol-file manipulation). At a later stage intelligent fraud-detection algorithms can be employed in order to update negative files, e.g. user-profile checks (detection of unusual user behavior, questionable increases in a users turnover), and payment-site checks (checking whether payments from far distant sites went out within a short time).

A flow mechanism triggers the mediation, the reconciliation and MA/μPI clearance. The booking step can be planned for each MA or μPI, depending on a threshold for a minimal settlement amount. The booking sequence and the threshold for the minimal settlement amount are stored in the general-ledger data set. The administrator monitors the correct flow and manually initiates processing steps whenever necessary.

All mobile payment transactions are routed through the CPP, which results in a protocol entry in the protocol file. This protocol file forms the basis for the generation of transaction-fee billing and reports. The resulting billing reports are then booked in an account-management system in order to initiate the settlement. Fees are charged for various events, such as an OfferID request, authentication at the PI or a capture. The merchant pays a mobile merchant service-provider charge (mobile MSC) to the merchant acquirer. The mobile MSC, with deduction of an MA fee, is claimed by the CPP and further subdivided among the joint proprietors. FIG. shows the fee distribution.

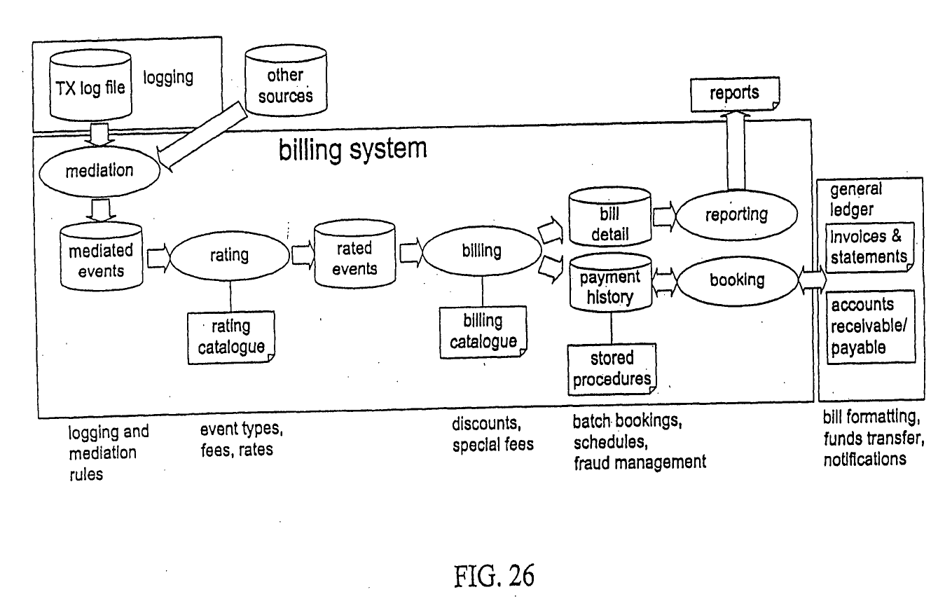

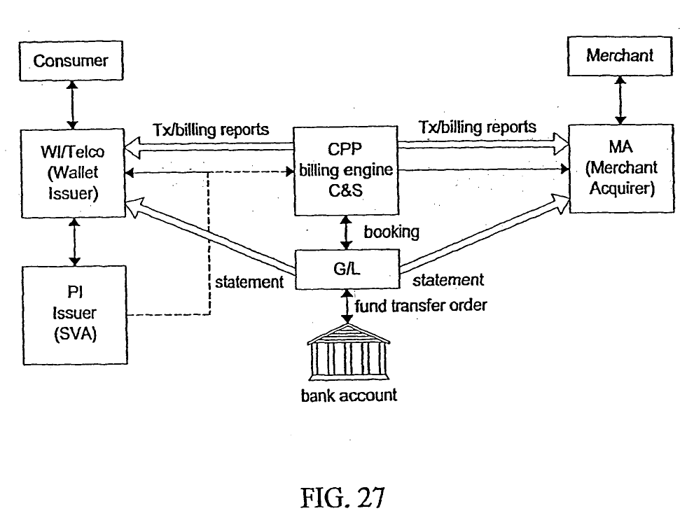

A batch process (e.g., daily, weekly, monthly) is used for billing transaction fees, because the number of transactions can be very large, i.e. in the region of several million per day. he task of fee processing can be split into the following steps, as shown in FIG. 26.
1. Mediation
2. Rating
3. Billing
4. Reporting (exporting files that contain invoice details)
5. Booking (initiating settlements, sending out statements/invoices)
6. Rejection and return processes (error handling)
7. Dispute handling
8. Fraud detection
9. Management

At each step data are kept in a special storage area and identified as “plain”, “mediated”, “rated” or “billed”. The rating catalogue contains event definitions and pricing/rating information. In the billing catalogue are stored rules for special fees (e.g., monthly contribution fees) and discounts. Stored procedures determine processing and billing periods and trigger the various processing steps. The invoice-detail repository contains the completed events and forms the basis for more detailed reports such as EPA (electronic payment advice). Invoices are sent to the G/L in order to initiate the settlement (course of payment).

A mediation module keeps track of the protocol files received from various protocol-file sources. The main input consists of the daily protocol files from the routing module of the processing platform. Other sources deliver data that could not yet be processed, e.g. corrected data sets from the rejected and returned processes. The data are filtered and possibly reformatted.

The term “rating” means assigning a price to each event. A rating table is used to determine the prices for each class of events. The rating table is generated before the rating process is begun, and remains unchanged during at least one billing period.

For each recipient of an invoice or statement an individual rating table can be used, depending on the individual business agreements between OpCo, NewCo, the MAs, PI offerers and WIs.

The fee structure is designed so that it in general suffices to cover all fees that ordinarily appear in the transaction invoice. The transaction price can depend on the actual number of transactions and the average value of the merchant or merchant-acquirer payment transactions. a general approach for accommodating such a fee structure consists of a price table in matrix form.

Parameters that determine the price table are:
Event type (OfferID request, address check, capture etc.)
Payment channel (WAP, IVR, SMS)
Shopping channel (Web, WAP, IVR, TV, vending machine etc.)
Payment instrument (μPI, Visa, MasterCard, direct debit etc.)
Regional class (customer and merchant in the same or different regions): “on-us” (intra30 operator), domestic (national), intraregional (e.g., America, EMEA, ASPA), supraregional
Risk class of the merchant or merchants

The settlement currency (a separate price table can be used for each currency if an MA for multiple-currency settlement is selected)

Events that are rated comprise:
Static/dynamic OfferID generation (allocate OfferID, initOfferID)
Information requests (addressREQ, agecheckREQ, PIDetaiIREQ)
Payment authorization (AuthorizePaymentRequest)
Micropayment capture
Micropayment refund
Micropayment credit
IMPP extension messages (volume-related, e.g. per message or per kilobyte)
Other central services (tbd.)
(Payment initiation, i.e. PayPurchase request)
(Currency conversion)
(WS and PS search)
(error messages)

The process for issuing invoices collects all the rated events with respect to one account (receivable or payable) in a single invoicing data set. Repeated participation fees or special fees are added up and discounts subtracted. Special fees and deductions can vary for each statement recipient. The rated events are combined by calculation (accounts receivable or payable) and the fees are aggregated. An event containing several sub-fees forms part of several invoices. Deductions or other fees (e.g. participation fees) are added to each invoice. The invoices contain the total amount to be billed (credited or collected).

The bill-detail reports contain the data sets used to calculate an invoice for a particular recipient. The files of the bill-detail reports are sent to the participant on request. The billing statements contain the collected positions in an invoice. The formatting and delivery of statements is the responsibility of the main booking system.

The booking process initiates the collection of fees and their distribution by way of the general-ledger system. Invoices are identified as “booked” as soon as booking has begun. At the end of the invoice-issuing cycle all invoices are transferred to the general ledger (payment course).

As soon as bill details have been “delivered” or invoices identified as “booked”, the data are archived in a mass-storage area. Archived transaction protocols and billing files provide the basis for settling cases in dispute. The CPP makes available an interface for access to the protocolled transaction details and bill details by the authority handling the dispute, e.g. a customer-care center. Disputes concerning fee collection and distribution (funds transfers) are managed by back-office services. Fraud-detection reports should also be generated, in order to monitor the correct processing of bill-related data and to reveal questionable behavior (e.g., deletion of bill files, manual bookings, protocol-file manipulations).

The securities department employs a general-ledger (G/L) system in order to manage bookings for the collection and distribution of fees and for settling micropayments. The clearing and settlement service and the billing engine initiate bookings in the G/L system. Entries can be booked to recipient customers and payment customers of the OpCo, NewCo, all WIs, PI offerers and MM. Repeated bookings are actuated for every micropayment-settlement cycle and for every invoicing period (daily, weekly or monthly). For every booking (microbooking settlement or fee invoicing), a statement is printed and sent to every recipient. Physical funds transfers to/from MA, to/from WI and to NewCo bank accounts are initiated. The micropayment settlement with MAs should not occur before the payment from the μPIs has been received. Irregularities in the flow of funds are monitored and reported, and wakeups are generated automatically when funds transfers are delayed. The G/L operator can request reports about cash flow and outstanding cash transfers (for the cash management). Return transfers can be initiated manually in case of incorrect bookings, e.g. owing to incorrect fee calculations.

All operational activities are protocolled (in order to enable independent checking of the calculation and detection of fraud). Items of information about joint proprietors (merchant acquirers, wallet issuers, payment-instrument offerers, NewCo and OpCo) are stored centrally in the CPP. Various components request data in order to carry out their processing tasks. The administrator generates and alters main-data entries and alters the status of the data (active/inactive).

MA Main Data
Name
Connection data (address, telephone, e-mail etc.)
ID
Payment-server address (URL)
Internal G/L booking account number
Bank account number
Invoicing and settlement sequences
Billing currencies (possibly several of them)
State (registered, active, inactive, deleted)

WI Main Data
Name
Connection data (address, telephone, e-mail etc.)
ID
Wallet-server address (URL)
Internal G/L booking account number
Bank account number
Invoicing and settlement sequences
Billing currency
State (registered, active, inactive, deleted)

PI-Offerer Main Data
Name
Connection data (address, telephone, e-mail etc.)
ID
Server address (URL)
Internal G/L booking account number
Bank account number
Invoicing and settlement sequences
Billing currency
State (registered, active, inactive, deleted)

NewCo Main Data
Name
Connection data (address, telephone, e-mail etc.)
Internal G/L booking account number
Bank account number
Invoicing and settlement sequences
Billing currencies (possibly several of them)
State (registered, active, inactive, deleted)

OpCo Main Data
Name
Connection data (address, telephone, e-mail etc.)
Internal G/L booking account number
Bank account number
Invoicing and settlement sequences
Billing currencies (possibly several of them)
State (registered, active, inactive, deleted)

The administration service encapsulates the diverse administration arrangements of the various components, and makes available a single sign-on for the administration users and protocols of all user activities. The following administration tasks are carried out centrally, because they are valid for all CPP components:
Software updating, system restarts, hardware and network apparatus
Determining roles and rights, installations of users (administrators, operators), assigning roles to users
The security manager has exclusive access to security and system protocols, in order to check the operations of the system and detect insider frauds
The main-data administrator generates and alters main-data entries and changes the state of the joint proprietors (e.g., active/inactive),
The role of customer care is associated with rights of access to the main data, transaction protocols, invoicing details and progress reports.

The customer and merchant validity check is carried out centrally during the registration process. For each customer the WS sends a check request to the CPP. The CPP carries out the validity check by checking information such as name, address and age. After completion, the result of the check is sent to the WS together with a quality key that indicates the service employed for the validity check (this can be based on agreements between CPP and WI/MA).

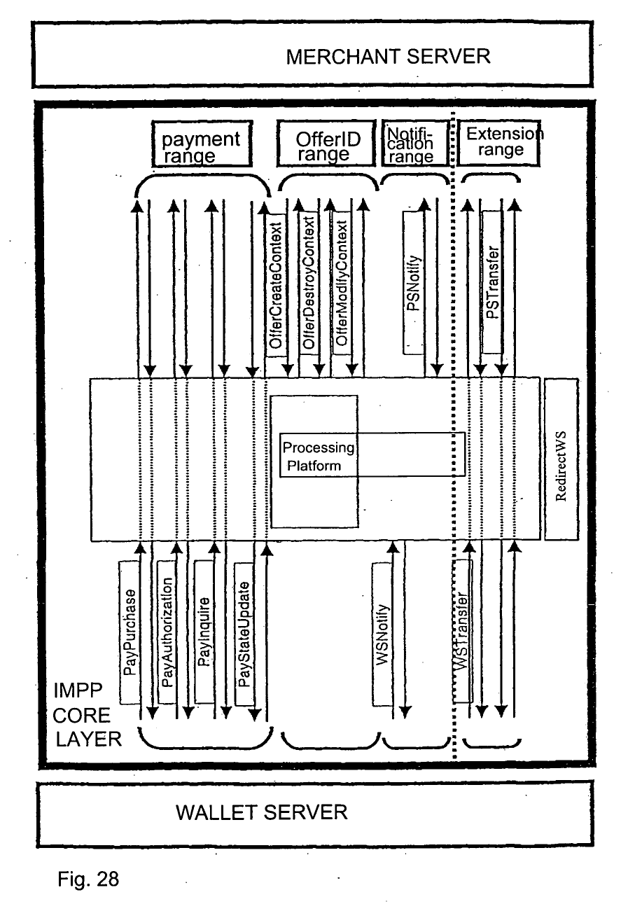

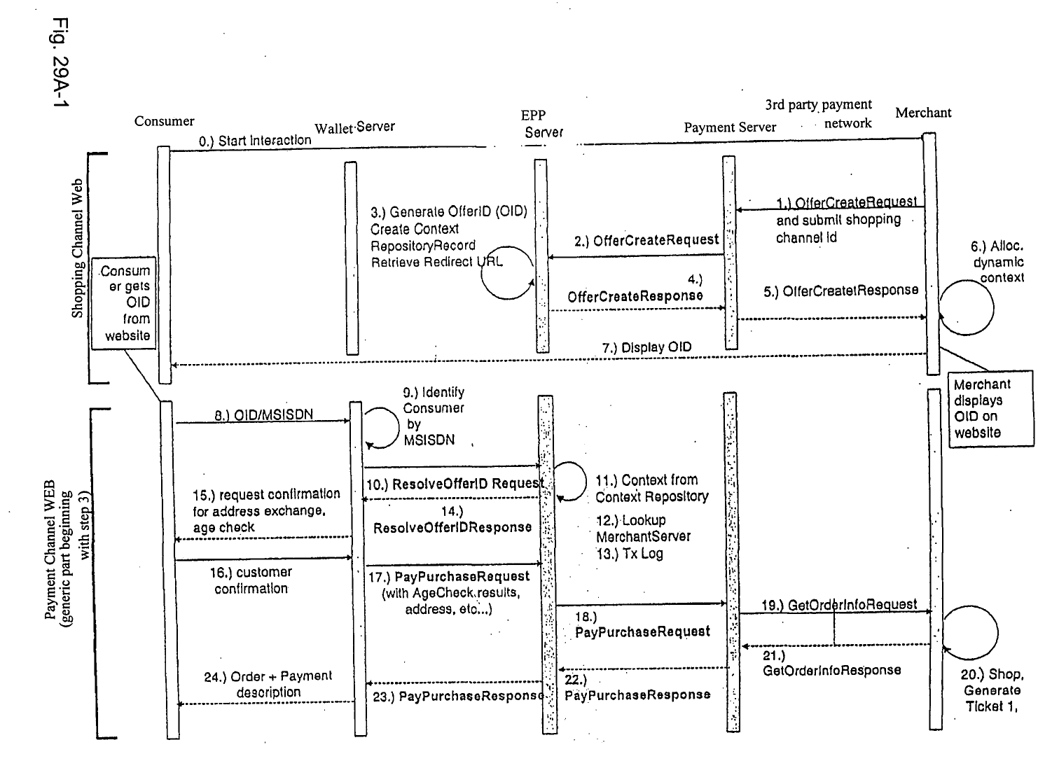

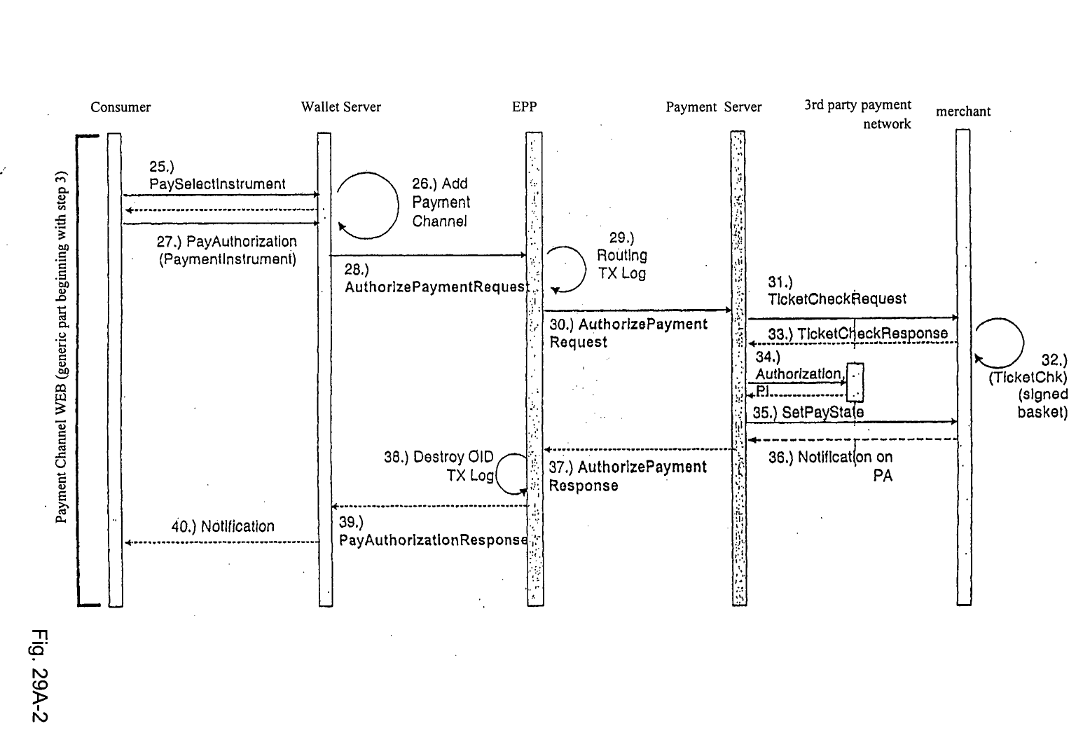

FIG. 28 shows schematically the various layers of an interoperable mobile payment protocol (IMPP), which operates between a merchant server and a wallet server on a processing platform. The protocol consists fundamentally of a basic layer (IMPP core layer) and an extension layer. The former incorporates the actual payment range, the OfferID range and the notification range. The extension layer comprises optional requests and responses between the wallet-server and merchant-server stages. It also enables connection for communication between third-party wallet servers. The communication between purchaser and wallet server on the one hand, and offer and merchant server on the other hand, is not included in this protocol.

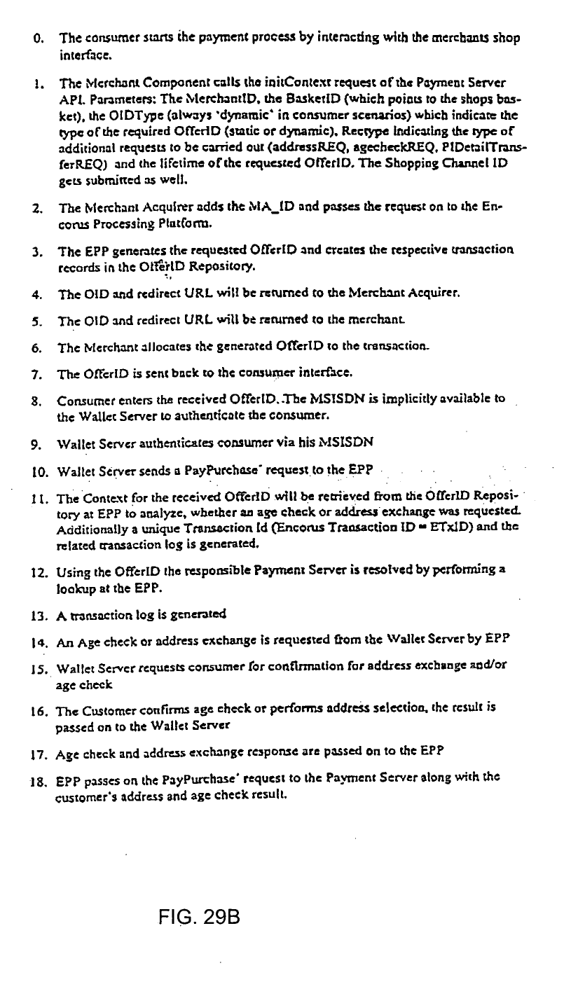

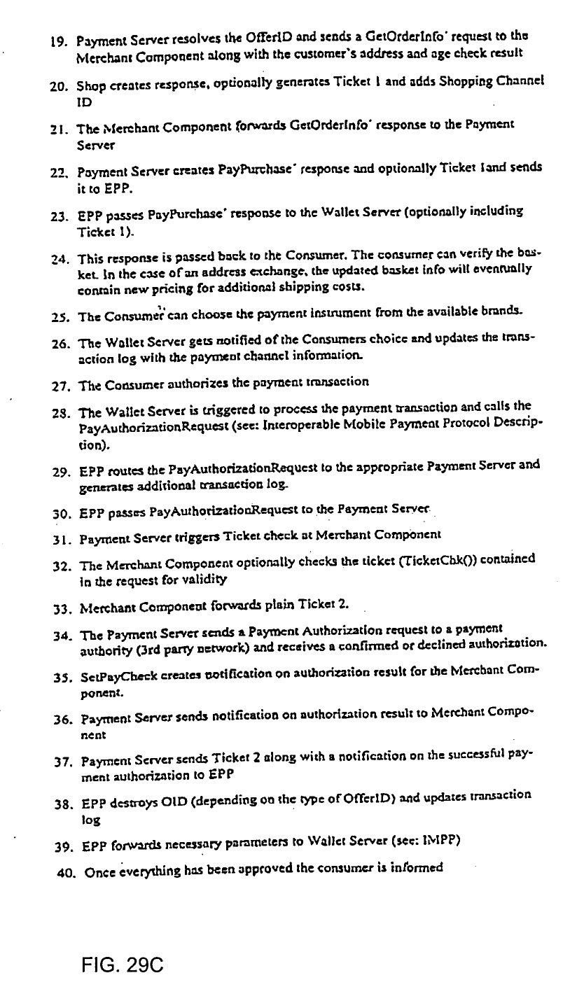

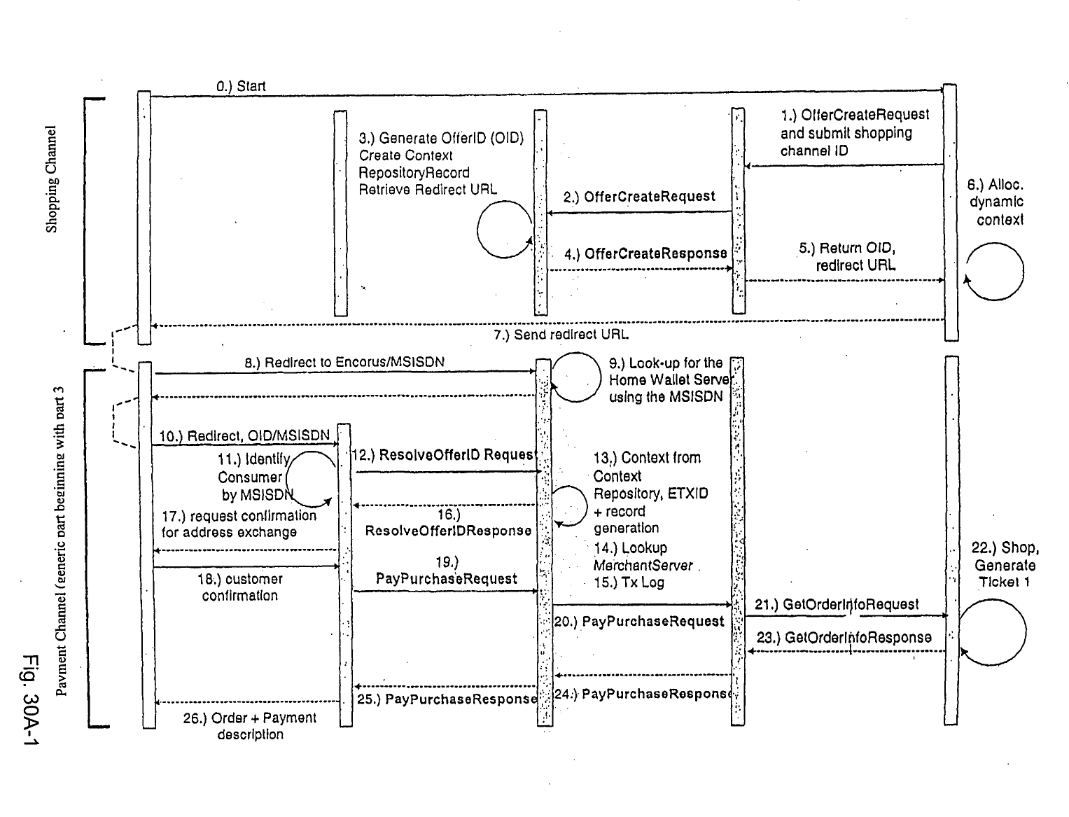

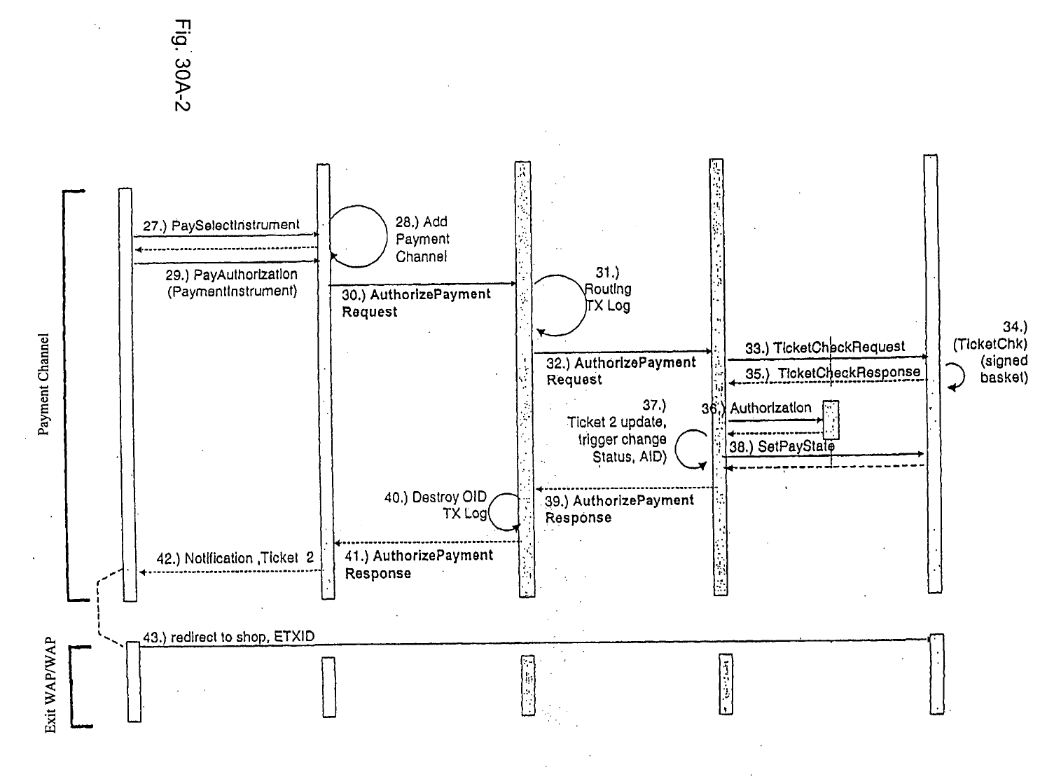

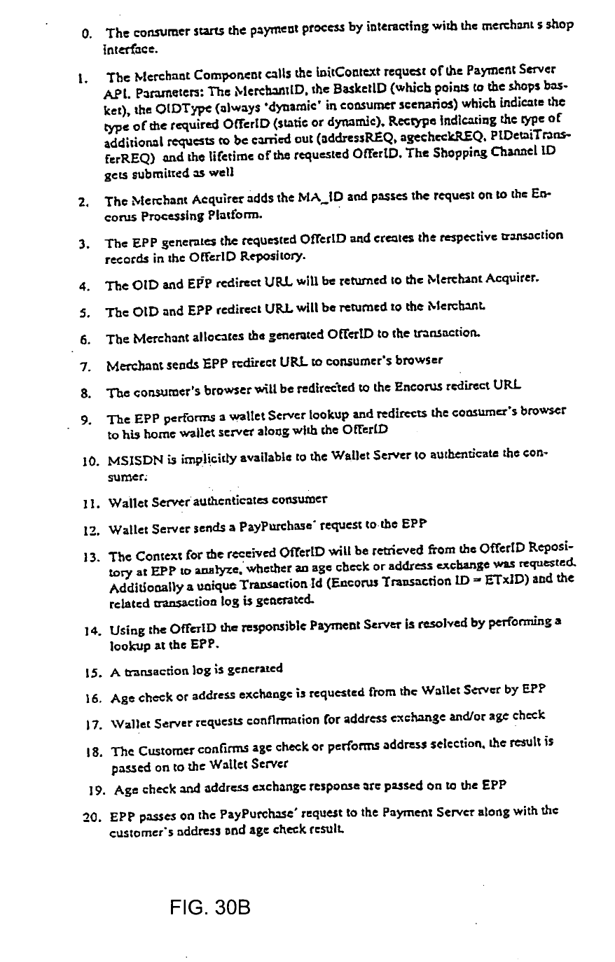

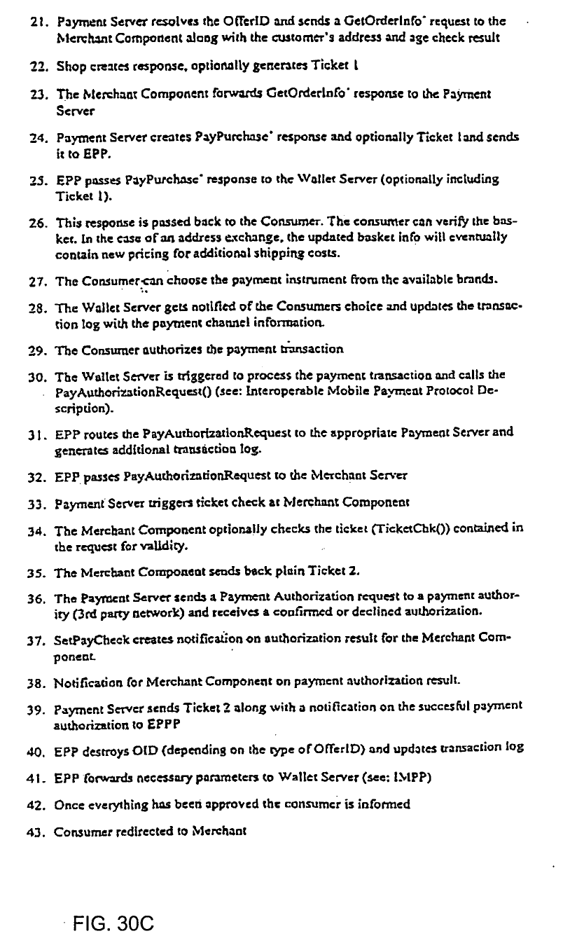

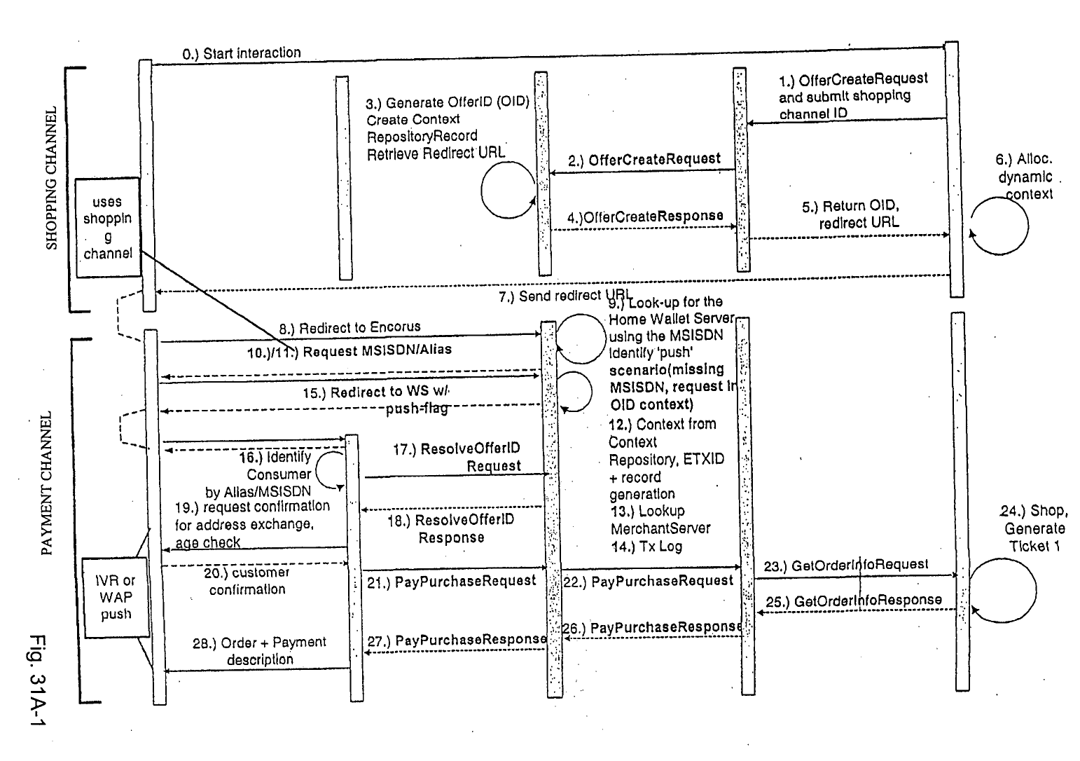

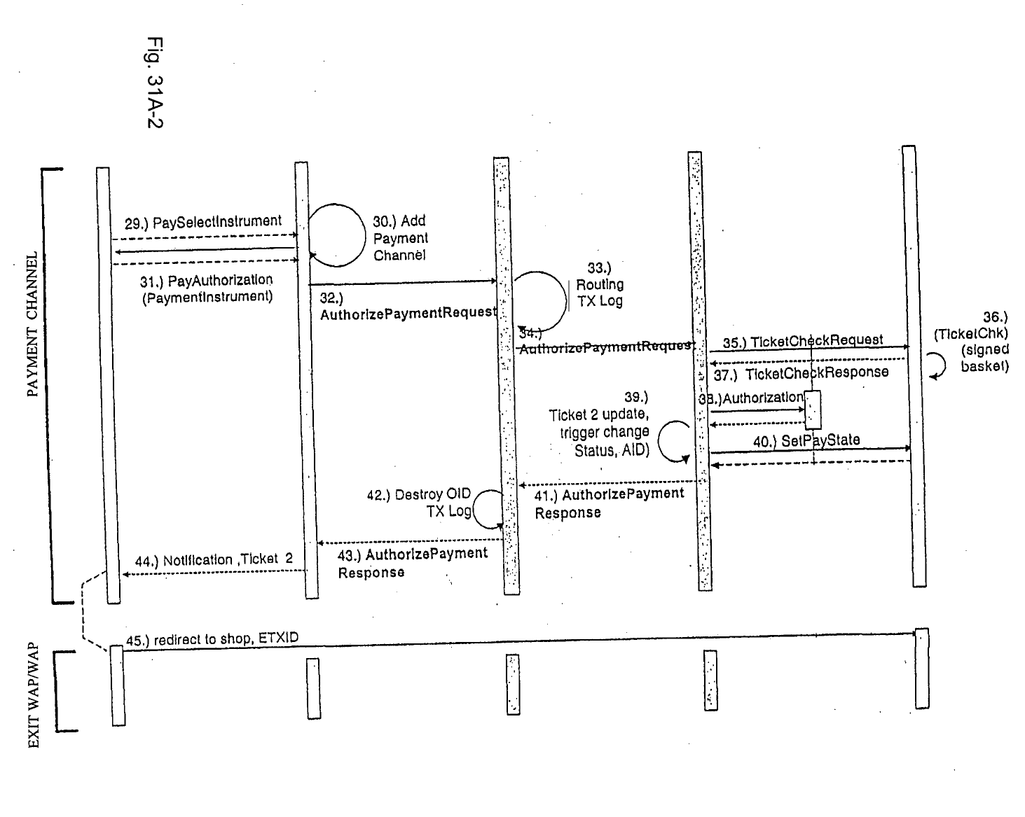

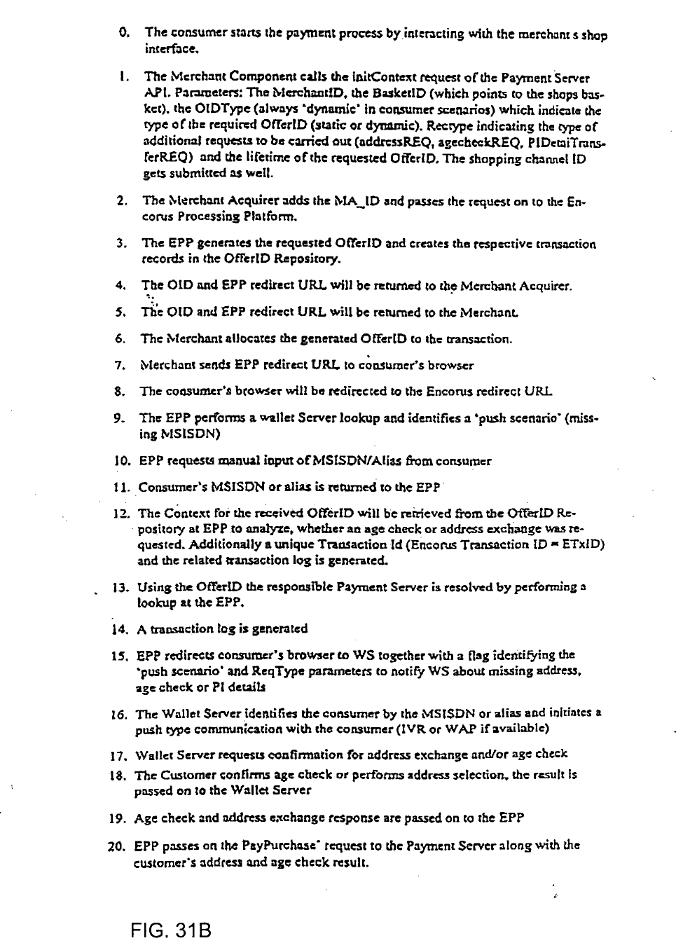

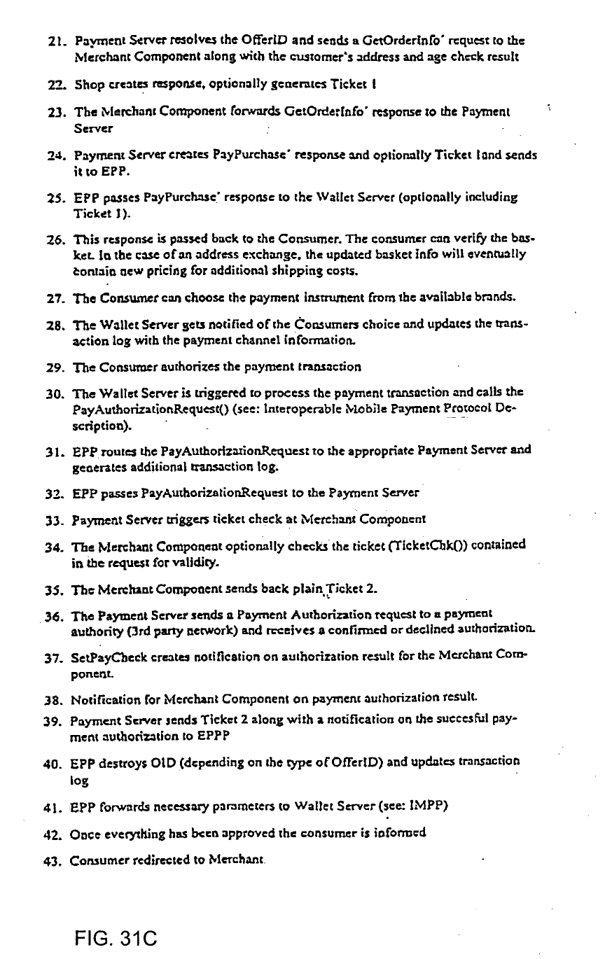

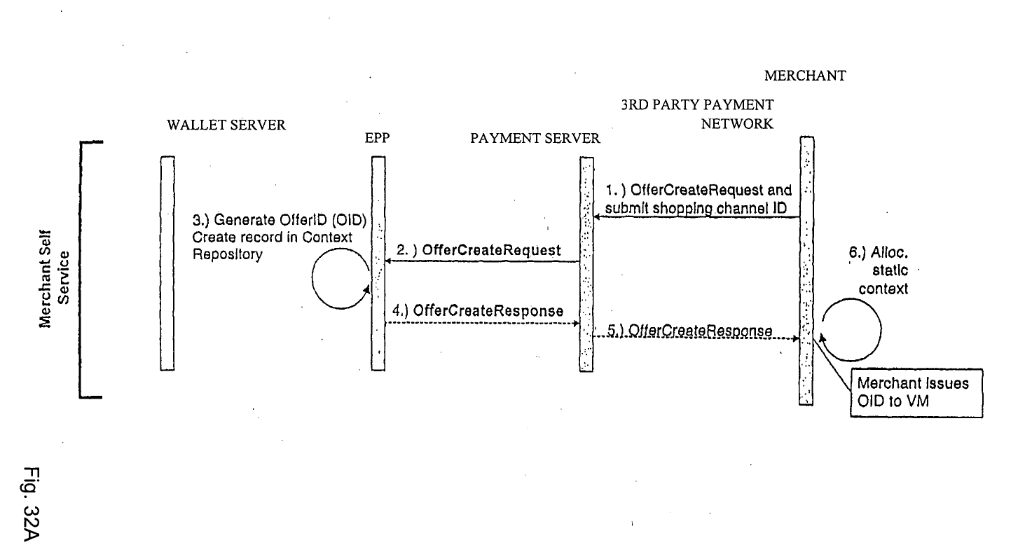

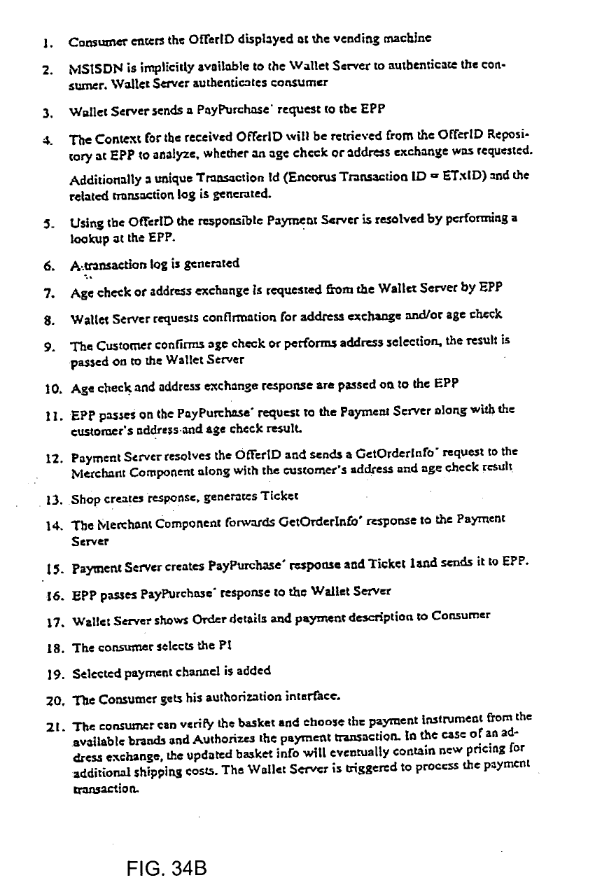

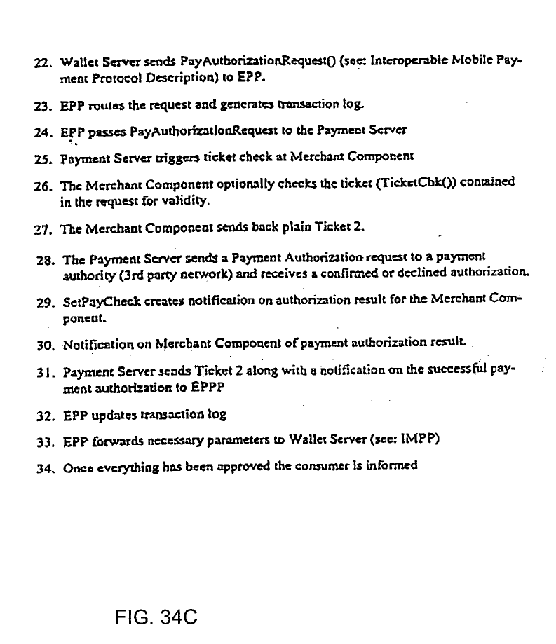

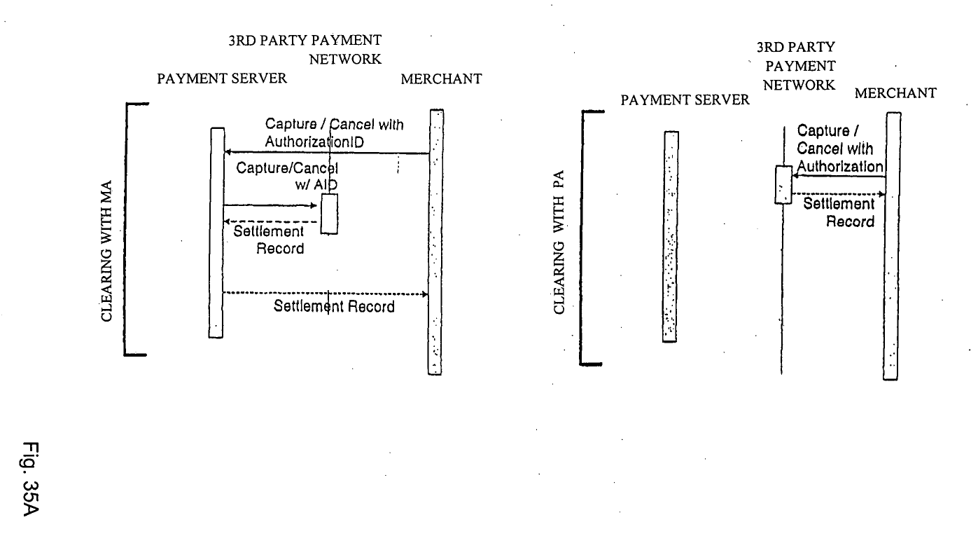

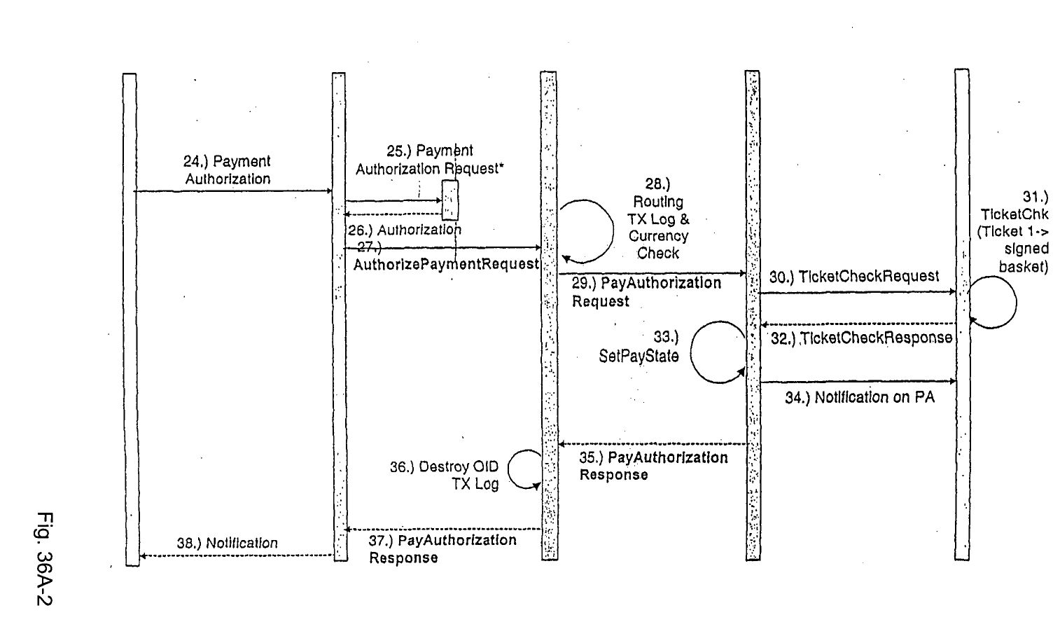

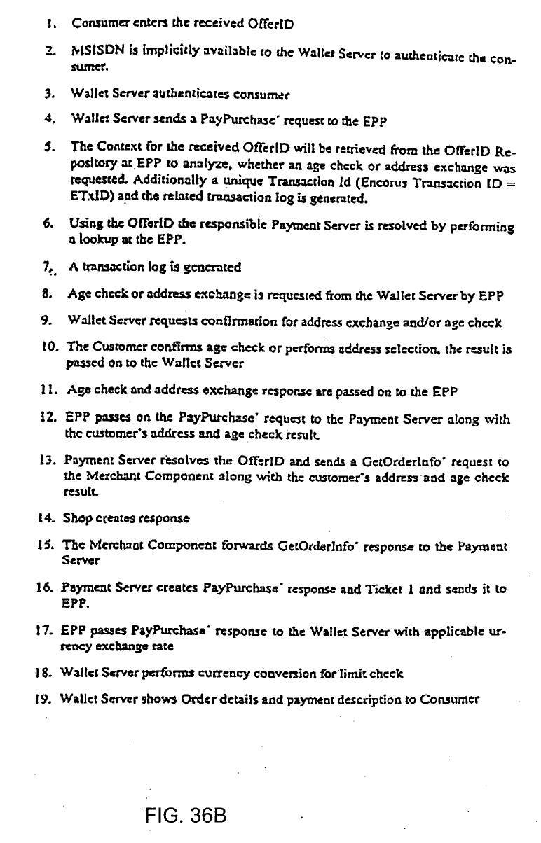

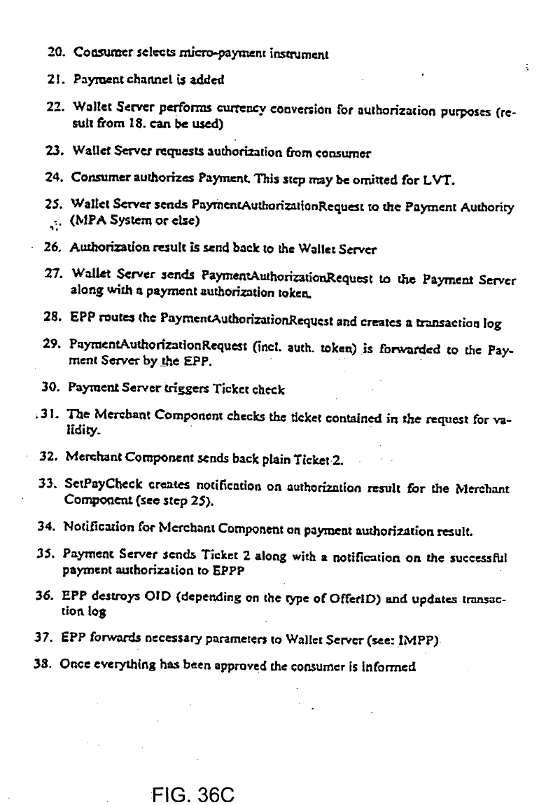

The flow diagrams and lists of procedural steps shown in FIGS. 29A to 29C, 30A to 30C, 31A to 31C, 34A to 34C, and 36A to 36C for the most important types of transactions or payment events are self-explanatory.

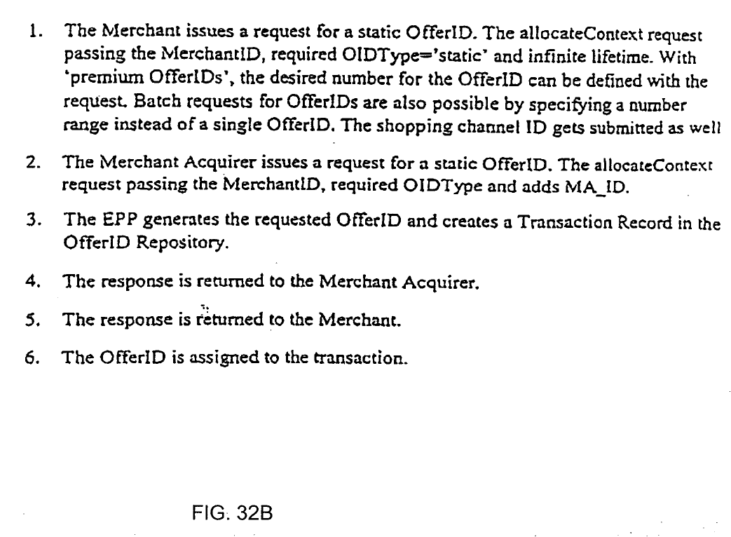

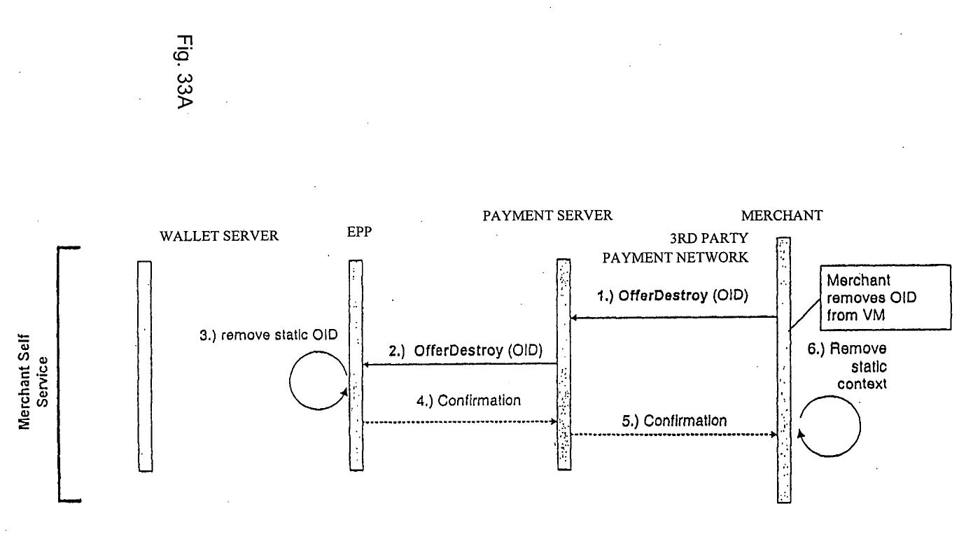

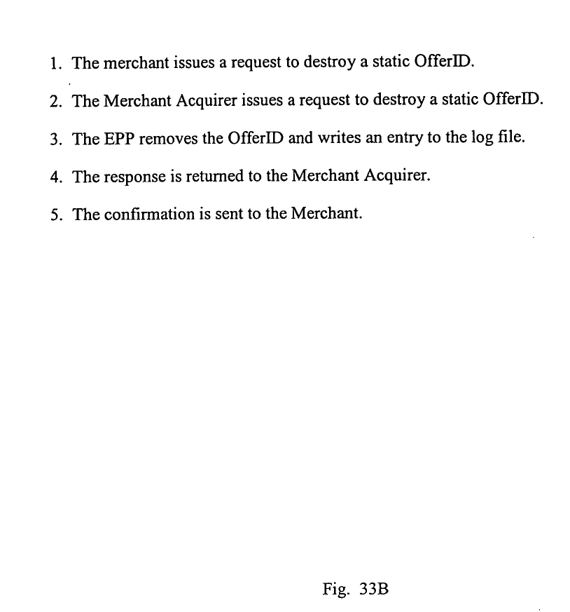

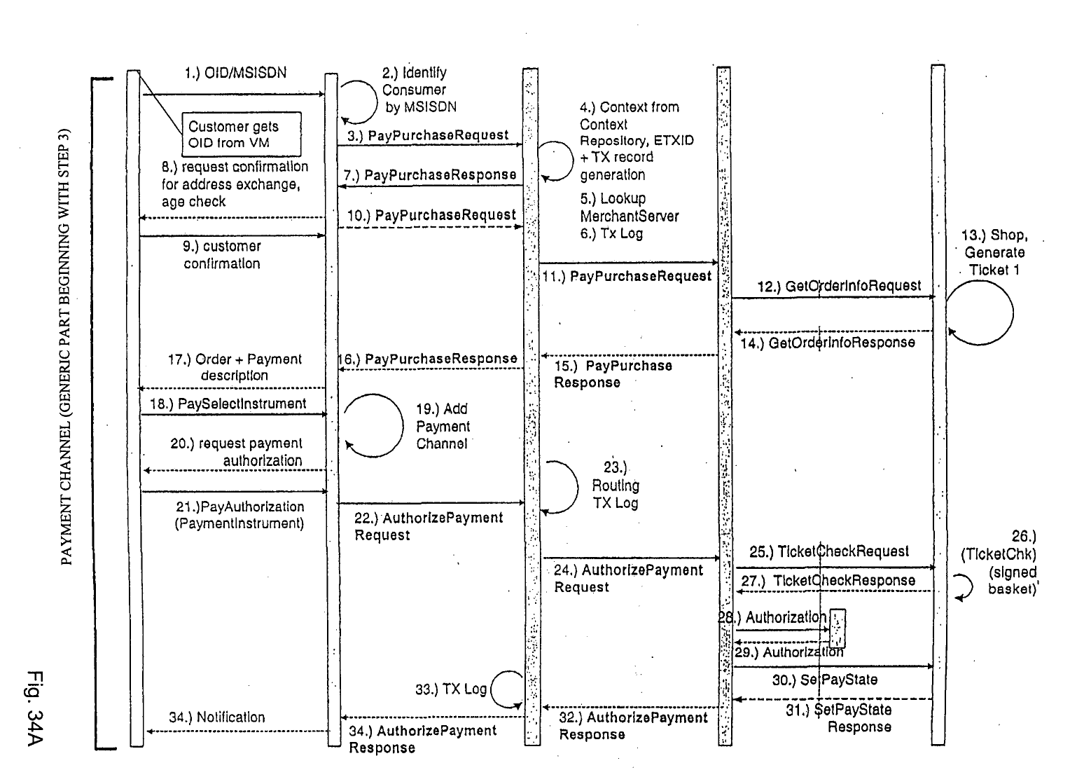

This also applies to the sequences for generation and deletion or destruction of a static OfferID shown in FIGS. 32A and 32B, as well as 33A and 33B. In this regard reference is made in particular to the general explanation of use of the offer identifier given above.

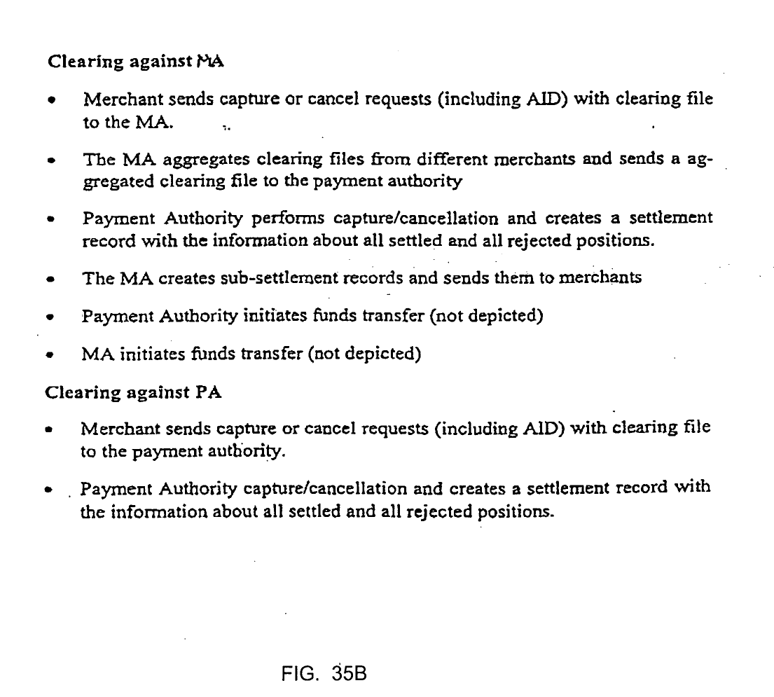

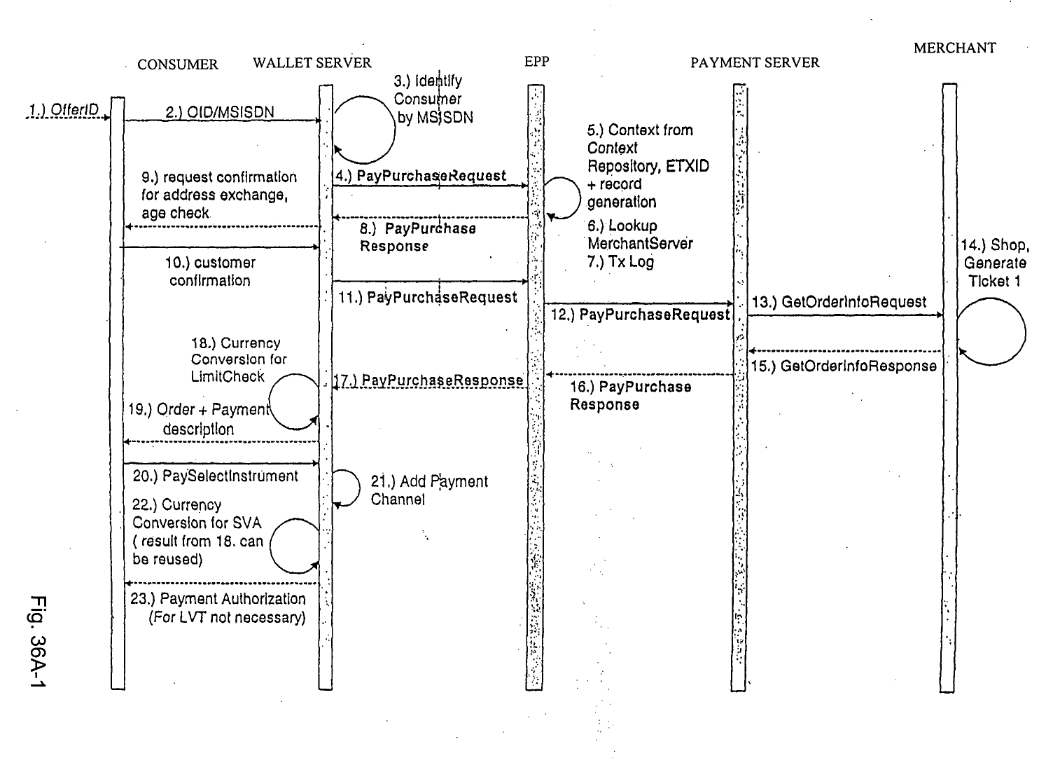

The steps and aspects of a clearing sequence represented in FIG. 35A and 35B are dependent upon whether a so-called merchant acquirer is involved or not. They conform to the organizational precedents set by established clearing procedures in conventional commercial transactions.

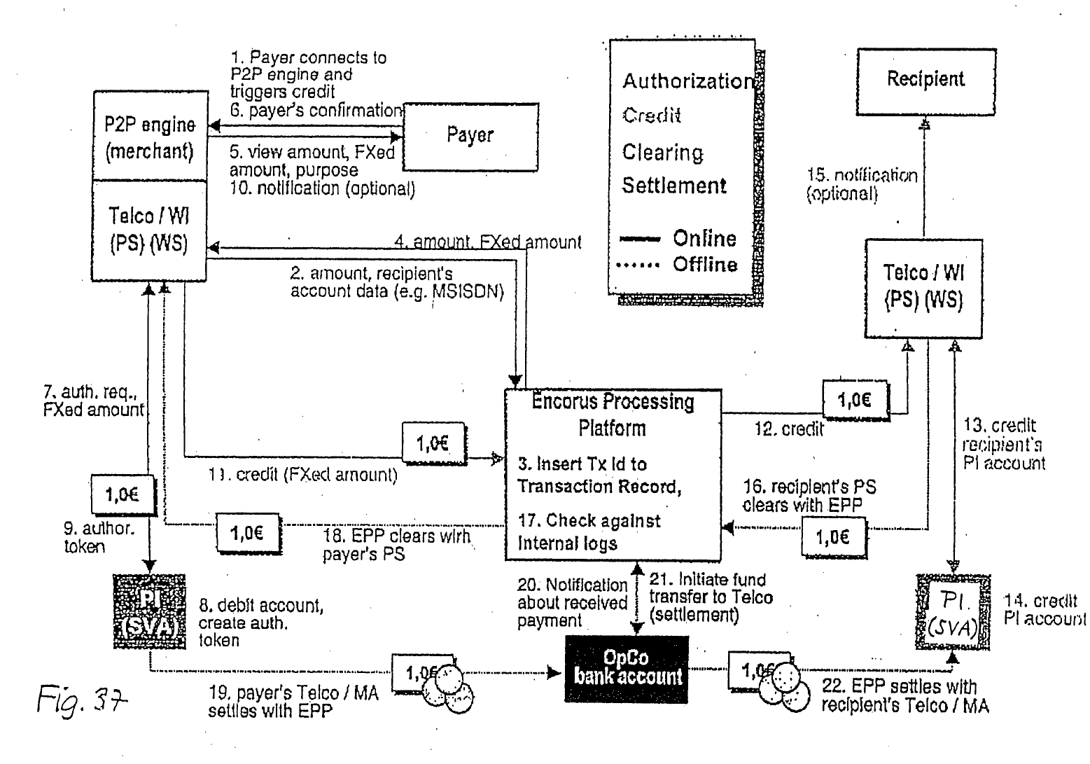

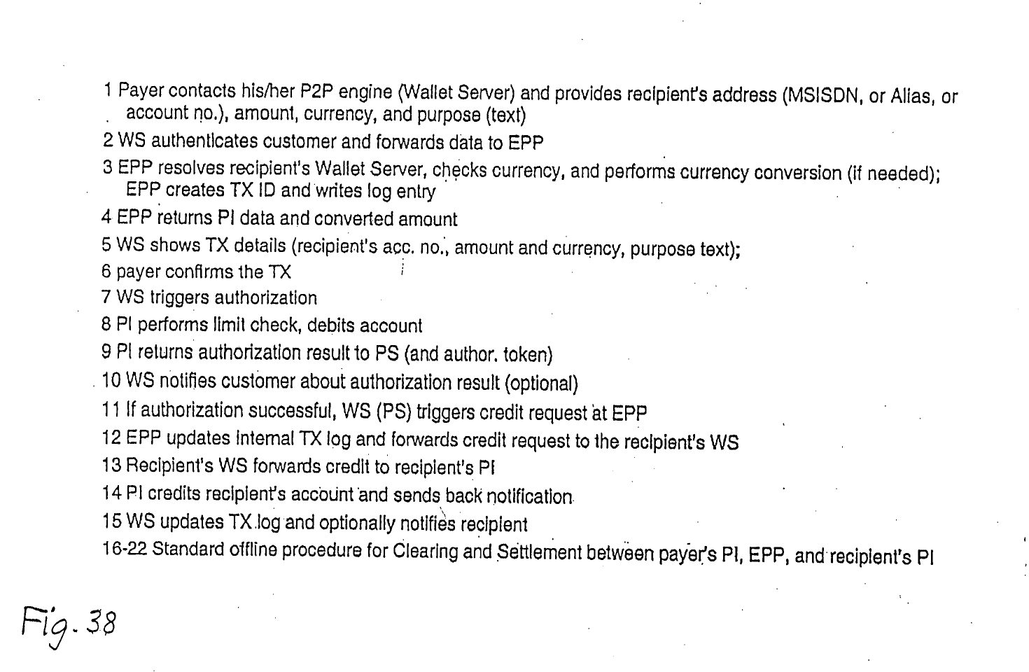

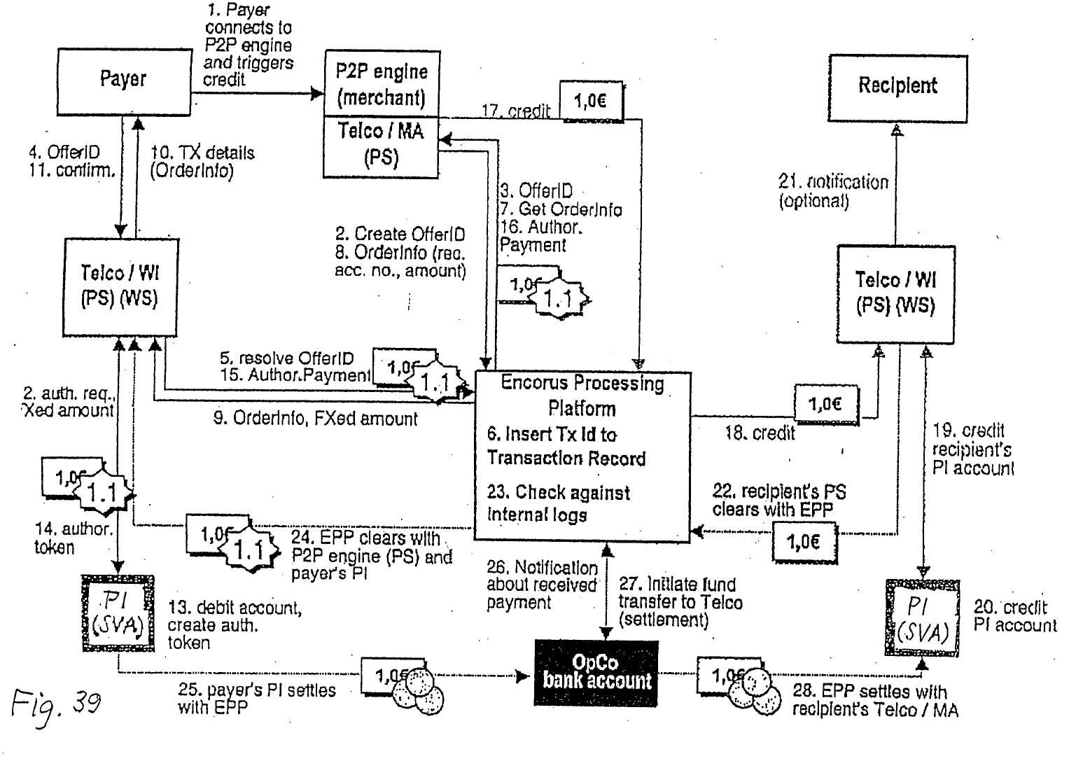

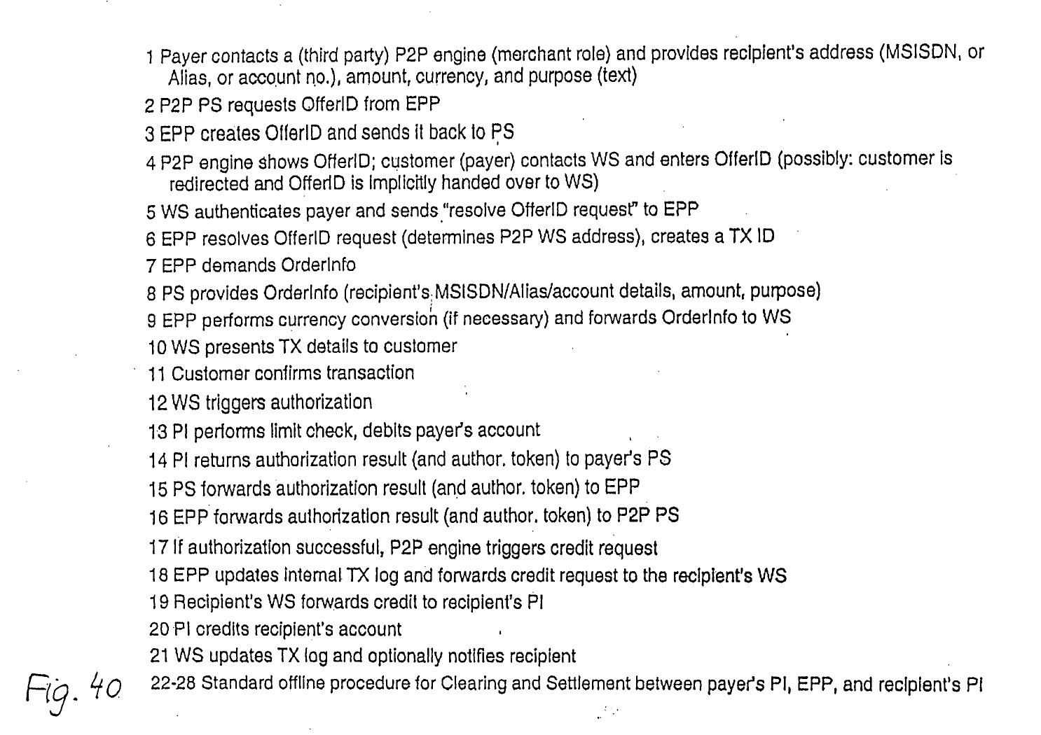

FIGS. 37 to 40 are labeled so as to be substantially self-explanatory, so that an additional verbal description is not required. Here the following abbreviations are used:
EPP Encorus Processing Platform (system-management server)
EX Foreign Exchange
MA Merchant Acquirer (a service provider)
OpCo System operator
P1 Payment Instrument
PS Payment Server (associated with transaction server)
P2P Person-to-Person
SVA Stored value account
Telco Telecommunications operator
TX Transfer
WI Wallet Issuer (a service provider)
WS Wallet Server (a transaction server)

Although the invention has been described with reference to various embodiments, a person skilled in the art will recognize that the invention can be converted by modifications within the sense and extent of the claims.

1. Method of carrying out a transaction on a system comprising at least one central processor platform, at least one issuer server and at least one acquirer server, wherein the central processor platform comprises a routing engine which, by way of a communication connection, is coupled to the issuer server and to the acquirer server, said method consisting of these steps:
receiving a transaction inquiry at the acquirer server or at the server, issuer server;
routing the inquiry from the acquirer server or from the issuer server to the central processor and platform; and
operating the central processor platform, in order to implement the transaction:

2. Method according to claim 1, wherein the transaction inquiry is received at the acquirer server or at the issuer server by either at least one mobile device or at least one non-mobile device.

3. Method according to claim 1, wherein communications between the central processor platform and at least either the acquirer server or the issuer server take place according to a protocol.

4. Method according to claim 3, wherein the protocol comprises an interoperable mobile payment protocol.

5. Method according to claim 4, wherein the interoperable mobile payment protocol is used in association with the issuance of at least either one direct macropayment, macropayment credit, delayed macropayment, partial macropayment, direct micropayment, delayed micropayment or micropayment credit.

6. Method according to claim 1, wherein the central processor platform performs at least one of either a currency conversion, or a payment calculation and a settlement of the payment, or a processing of fees and issuance of an invoice, or a distribution of funds.

7. Method according to claim 1, wherein the issuer server comprises at least either authentication data payment data or data on the progress of transactions.

8. Method according to claim 1, wherein the acquirer server comprises at least either merchant data or data on the progress of transactions.

9. Data-transfer method for transmitting information relevant to payment transactions for merchandise or services sold by an offerer to a purchaser, in which there is access to a purchaser account managed electronically by an account manager, by employing a telecommunications network, in particular mobile wireless network, to which the purchaser is connected by way of a telecommunications terminal, in particular in order to implement the method according to claim 1, wherein that from the offerer an inquiry about a unique offer identifier, suitable for multiple transactions, for temporary or permanent identification of an item of merchandise or a service on offer, in particular a plurality of merchandise and/or services, is transmitted to a system-management server, from the system-management server an offer identifier or an acknowledgment of an externally produced offer identifier is generated and sent to the inquiring offerer, the offer identifier is transmitted to the purchaser and from the purchaser, by way of the telecommunications network, in association with the offer identifier authorization data for authorizing the payment to the account manager is transmitted.

10. Data-transfer method according to claim 9, wherein that when the offer identifier is generated, no duration of validity is specified, so that it is potentially valid for an unlimited period.

11. Data-transfer method according to claim 9, wherein that when the offer identifier is generated, a duration of validity is specified, and when this period has ended, the identifier automatically becomes invalid.

12. Data-transfer method according to claim 9, wherein that in order to invalidate the offer identifier when it expires or on demand of the offerer, an elimination signal is sent to the offerer.

13. Data-transfer method according to claim 9, wherein that the offer identifier is communicated to potential purchasers as an invariant optical display, in particular in written form as part of a window display or vending machine or printed on a prospectus or catalogue or the like.

14. Data-transfer method according to claim 9, wherein that the offer identifier is communicated to potential purchasers as a variable optical display, on an electro-optical display device or by spoken output or an acoustic signal.

15. Data-transfer method according to claim 9, wherein that the offer identifier is communicated to a large number of potential purchasers by a broadcast method apart from the telecommunications network, in particular by radio or television transmission or by the sending or distribution of printed material or e-mail broadcasting, for the duration of its validity.

16. Data-transfer method according to claim 9, wherein that the offer identifier is transmitted, in particular by a broadcast method, as a short message or by WAP, over the telecommunications network to the telecommunications terminal of the purchaser and is displayed there.

17. Data-transfer method according to claim 9, wherein that the sequence of steps involved in the offerers inquiry about an offer identifier and the delivery thereof to the offerer is performed as substantially automated data transfers between the system-management server and a merchant server or offerer data terminal by way of a data and/or telecommunications network, in particular the internet.

18. Data-transfer method according to claim 9, wherein that after the step in which the offer identifier is communicated to the purchaser, the offer identifier is transmitted by the purchaser through the telecommunications network to a customer server belonging to the network operator or a service provider in the telecommunications network, an inquiry report is sent by way of the customer server, service-provider server or merchant server to the offerer, in order to obtain a binding offer, by way of the offerer an offer data set is sent to the customer server and then transmitted from the customer server to the telecommunications terminal of the potential purchaser, where it is displayed under the guidance of a menu in order to confirm the transaction.

19. Data-transfer method according to claim 18, wherein that the data transfer is carried out in the following steps:
inquiring about a binding and offer; and
sending the offer data by way of the system-management server, which in particular is responsible for search and routing functions between network operator or service provider and offerer.

20. Data-transfer method according to claim 9, wherein that the offer identifier is generated entirely externally, and in the course of the inquiry is transmitted by the offerer to the system-management server for confirmation.

21. Data-transfer method according to claim 9, wherein that the offer identifier comprises a first and a second section, such that the first section is an offerer identifier generated by the system-management server or by the management, whereas the second section is generated by the offerer or by the management and identifies the merchandise or group of merchandise concerned, and the method comprises transmission of the second section to the system-management server, the linkage of first and second sections in the system-management server, and the sending of the entire offer identifier to the purchaser or confirming it to the purchaser.

22. Data-transfer method according to claim 18, wherein that the offer identifier is converted from an optical or acoustic signal into an electrical signal in or at a telecommunications terminal belonging to the purchaser, in particular by way of a camera or scanner connected thereto.

23. Arrangement for implementing the method according to claim 1, with a system-management server, which is configured for generating and transmitting the offer identifier in response to an inquiry, an offerer terminal connected to the system-management server by a data and/or telecommunications network, in particular the internet, to perform input and transmission of the request for an offer identifier and output of a transmitted offer identifier, display means to display the offer identifier to the purchaser or purchasers and a telecommunications terminal, in particular mobile wireless terminal, by way of which the purchaser is connected to a telecommunications network in order to access his purchaser account.

24. Arrangement according to claim 23, comprising a customer server that creates a connection between the telecommunications terminal of the purchaser and the offerer terminal in order to transmit a binding offer, in particular by way of the system-management server.

25. Arrangement according to claim 23, wherein that the display means constitute a printed document or writing on a carrier object.

26. Arrangement according to claim 23, wherein that the display means are constructed as an electro-optical display device, in particular the display of a telecommunications device or data terminal.

27. Arrangement according to claim 23, wherein that the display means take the form of a device for spoken output or acoustic signaling.

28. Arrangement according to claim 23, wherein that the display means are constructed as television or radio receivers.

29. Arrangement according to claim 23, wherein that a camera or scanner is associated with the purchaser's telecommunications terminal so that an optically displayed offer identifier can be independently observed, or that the terminal is so constructed that it can evaluate an acoustic signal that represents an offer identifier.

30. Arrangement according to claim 23, wherein that the system-management server comprises a code-generating unit to generate, in response to a received inquiry, an offer identifier for the temporary or permanent identification, uniquely and without limitation to a single transaction, of merchandise or services offered by the offerer, in particular in each case a plurality of merchandise and/or services, as well as a code-transmitting device to transmit the generated offer identifier directly or indirectly to the inquiring offerer terminal.

31. Arrangement according to claim 30, wherein that the system-management server comprises timer and duration-storing means associated with the code-generating unit, which assign a duration of validity to each offer identifier and store it in memory, as well as a duration comparator unit connected to the timer and duration-storing means, to monitor progress through the predetermined validity period and, when this period expires, to send out an elimination signal that invalidates the offer identifier.

32. Arrangement according to claim 23, wherein that there is associated with the system-management server a data repository system to store and manage all valid offer identifiers as well as items of information assigned thereto in the system, in particular data relevant to payment transactions and reference numbers for data-transfer events that have occurred.

33. Data-transfer arrangement for transmitting information relevant to payment transactions for merchandise or services sold by offerers to purchasers, in which there is access to purchaser accounts managed electronically by at least one account manager, with at least one telecommunications network, in particular mobile wireless network, to which each of the purchasers is connected by way of a telecommunications terminal, with offerer terminals that are or can be connected to the telecommunications network, at least one account-management server to manage the purchaser accounts, at least one customer server belonging to the operator of the telecommunications network or to a customer-server proprietor, such that the customer server is designed to manage identification data of the purchaser as well as to implement the transmission of data to the offerers terminals and also to the or each account-management server, and a system-management server that is or can be directly connected, by way of a bi-directional data connection, to the or each customer server as well as to the offerer terminals or at least one intermediate merchant server belonging to a merchant service provider, and storage means for the storage of identification and address data of the offerer terminals or the or each merchant server as well as data-traffic conductors for the routing of data-transfer processes between the or each customer server and the offerer terminals and/or the or each merchant server.

34. Data-transfer arrangement according to claim 33, wherein that the system-management server is substantially permanently connected to a plurality of customer servers in several telecommunications networks, in particular mobile wireless is networks.

35. Data-transfer arrangement according to claim 33, wherein that the system-management server and/or the merchant server is disposed in a telecommunications network, in particular mobile wireless network, and together with the customer server forms a functional unit.

36. Data-transfer arrangement according to claim 33, wherein that the system-management server can be connected to a plurality of merchant servers, and each merchant server is connected or connectable to a plurality of offerer terminals and comprises a merchant memory area to store the identification and address data of the attached offerers.

37. Data-transfer arrangement according to claim 33, wherein that the system-management server comprises a code-production unit to generate an offer identifier for the temporary or permanent identification, uniquely and without limitation to a single transaction, of merchandise or services offered by the offerer, in particular in each case a plurality of merchandise and/or services, in response to a received inquiry, as well as a code-transmitting device to transmit the generated offer identifier directly or indirectly to the inquiring offerer terminal.

38. Data-transfer arrangement according to claim 37, wherein that the system-management server comprises timer means and duration-storage means associated with the code-production unit, which assign a duration of validity to each offer identifier and store it in memory, as well as a duration comparator unit connected to the timer and duration-storing means, to monitor progress through the predetermined validity period and, when this period has expired, to send out an elimination signal that invalidates the offer identifier.

39. Data-transfer arrangement according to claim 33, wherein that the or at least one account-management server is directly associated with the or one telecommunications network and cooperates with the system-management server and/or with the customer server to implement a payment, in particular with access to a prepaid balance.

40. Data-transfer arrangement according to claim 33, wherein that the or at least one account-management server is disposed outside the control region internal to the or each telecommunications network, and in particular can be connected directly to the telecommunications terminal of the purchaser.

41. Data-transfer arrangement according to claim 33, wherein that the system-management server comprises a flow-program memory to store at least one transaction-flow program related to the data communication between the or each customer server and the offerer terminals and/or the or each merchant server.

42. Data-transfer arrangement according to claim 33, wherein that there is associated with the system-management server a data repository system to 30 store and manage all valid offer identifiers as well as items of information assigned thereto in the system, in particular data relevant to payment transactions and reference numbers for data-transfer events that have occurred.

43. Data-transfer method for transmitting information relevant to payment for merchandise or services sold by offerers to purchasers, in which there is access to purchaser accounts managed electronically by at least one account manager, by way of at least one telecommunications network, in particular mobile wireless network, to which the purchasers are each connected by way of a telecommunications terminal, in particular in order to operate a data-transfer arrangement according to claim 33, wherein that a system-management server is used to construct data connections, in particular several data connections in parallel, between at least one customer server and a plurality of offerer terminals or at least one intervening merchant server, on the basis of identification and address data regarding the offerer terminals or the or each merchant server and the or each customer server that are stored in a database of the system-management server, and to control steps for data communication between these units that are stored in a transaction-flow program.

44. Data-transfer method according to claim 43, wherein that from the offerer an inquiry about a unique offer identifier, suitable for multiple transactions, for temporary or permanent identification of an item of merchandise or a service supplied, in particular a plurality of goods and/or services, is directed to a system-management server, from the system-management server an offer identifier or acknowledgment of an externally produced offer identifier is generated and sent to the inquiring offerer, the offer identifier is communicated to the purchaser and from the purchaser, by way of the telecommunications network in association with the offer identifier, authorization data for authorizing the payment to the account manager is transmitted.

45. Data-transfer method according to claim 43, wherein that the offer identifier is communicated to a large number of potential purchasers by a broadcast method apart from the telecommunications network, in particular by radio or television transmission or by the sending or distribution of printed material or e-mail broadcasting, for the duration of its validity.

46. Data-transfer method according to claim 43, wherein that the offer identifier, in particular by a broadcast method, as a short message or by WAP, is transmitted over the telecommunications network to the telecommunications terminal of the purchaser and is displayed there.

47. Data-transfer method according to claim 43, wherein that the sequence of steps involved in the offerers inquiry about an offer identifier and the delivery thereof to the offerer is performed as a substantially automated data transmission between the system-management server and a merchant server or offerer data terminal by way of a data and/or telecommunication network, in particular the internet.

48. Data-transfer method according to claim 43, wherein that, in particular for transactions with a monetary value above a predetermined threshold, after the step in which the offer identifier is communicated to the purchaser, the offer identifier is transmitted by the purchaser through the telecommunications network to a customer server belonging to the network operator or a service provider in the telecommunications network, an inquiry report is sent by way of the customer server to the offerer, in order to obtain a binding offer, an offer data set is sent by the offerer to the customer server and then transmitted from the customer server to the telecommunications terminal of the potential purchaser, where it is displayed under the guidance of a menu in order to confirm the transaction.

49. Data-transfer method according to claim 48, wherein that by way of the customer server a request for transmission of the offer identifier and associated payment information is sent to the purchaser.

50. Data-transfer method according to claim 48, wherein that in the following step, a confirmation of payment is sent by the purchaser through his telecommunications terminal directly or indirectly to the account-management server.

51. Data-transfer method according to claim 50, wherein that receipt of the payment confirmation by the account-management server triggers the electronic debiting or reservation of a prepaid partial balance.

52. Data-transfer method according to claim 50, wherein that receipt of the payment-confirmation signal by the account-management server initiates an electronic clearing procedure of the kind customary in banks, between the account-management server of the purchaser and an account-management server of the offerer carrying out the transaction as well as the offerer terminal, or the merchant server of the associated merchant or service provider.

53. Data-transfer method according to claim 52, wherein t the clearing procedure is implemented externally to the data-transfer arrangement according to claim 1.

54. Data-transfer method for transmitting information relevant to payment transactions in order to accomplish payment by a payer to a payee, in which there is access to a payers account managed electronically by a first account-management server, by way of a telecommunications network, in particular mobile wireless network, to which the payer is connected by way of a telecommunications terminal, in particular in order to implement the method according to claim 1, wherein
from the telecommunications terminal of the payer a connection is made to a first transaction server of a system operator or service provider, and a first payment-order data set, comprising at least information about the amount and the address of the payee, is transmitted to the first transaction server,
by way of the first transaction server from the address information an account identifier is obtained for a payee account managed electronically by the first or another account-management server and
by way of the first transaction server a credit to the payee account is issued to the account-management server of the payee account, by transmission of a second payment-order data set comprising at least the amount information and the account identifier of the payee account.

55. Data-transfer method for transmitting information relevant to payment transactions in order to accomplish payment by a payer to a payee, in which there is access to a payer's account managed electronically by a first account-management server, by way of a data network, in particular the internet, to which the payer is connected by way of a data terminal, as well as a telecommunications network, in particular mobile wireless network, to which the payer is connected by way of a telecommunications terminal, in particular in order to implement the method according to claim 1, wherein
from the data terminal of the payer a connection is made to a first transaction server of a system operator or service provider, and a first payment-order data set, comprising at least information about the amount and the address of the payee, is transmitted to the first transaction server,
by way of the first transaction server a connection is made to the telecommunications terminal of the payer and a data or speech communication process is initiated to authenticate the payer by way of the telecommunications network,
in response to a successful authentication by the first transaction server, from the address information an account identifier is obtained for a payee account managed electronically by the first or another account-management server and
by way of the first transaction server the payment into the payee account is issued to the account-management server of the payee account, by transmission of a second payment-order data set comprising at least the amount information and the account identifier of the payee account.

56. Data-transfer method according to claim 54, wherein that
the first transaction server is used to obtain from the address information a server address of a second account-management server, by way of which the payee account is managed electronically,
the first transaction server is used to send an inquiry for an account identifier for the payee account to the second account-management server, by communication of the address information of the payee, and
by way of the second account-management server the account identifier of the payee account is obtained and sent to the first transaction server.

57. Data-transfer method for transmitting information relevant to payment transactions in order to accomplish payment by a payer to a payee, in which there is access to a payer's account managed electronically by a first account-management server, by way of a telecommunications network, in particular mobile wireless network, to which the payer is connected by way of a telecommunications terminal, in particular in order to implement the method according to claim 1, wherein
from the telecommunications terminal of the payer a connection is made to a first transaction server of a system operator or service provider, and a first payment-order data set, comprising at least information about the amount and the address of the payee, is transmitted to the first transaction server,
the first payment-order data set is transmitted by the first transaction server to a second transaction server, which has been identified by reference to part of the payee's address information,
by way of the second transaction server, from the address information an account identifier is obtained for a payee account managed electronically by the first or another account-management server and
by way of the second transaction server a credit to the payee account is issued to the account-management server of the payee account, by transmission of a second payment-order data set comprising at least the amount information and the account identifier of the payee account.

58. Data-transfer method for transmitting information relevant to payment transactions in order to accomplish payment by a payer to a payee, in which there is access to a payers account managed electronically by a first account-management server, by way of a data network, in particular the internet, to which the payer is connected by way of a data terminal, as well as a telecommunications network, in particular mobile wireless network, to which the payer is connected by way of a telecommunications terminal, in particular in order to implement the method according to claim 1, wherein
from the data terminal of the payer a connection is made to a first transaction server of a system operator or service provider, and a first payment-order data set, comprising at least information about the amount and the address of the payee, is transmitted to the first transaction server,
by way of the first transaction server a connection is made to the telecommunications terminal of the payer and a data or speech communication process is initiated to authenticate the payer by way of the telecommunications network,
in response to a successful authentication by the first transaction server, the first payment-order data set is transmitted by the first transaction server to a second transaction server, identified by reference to part of the payee's address information,
by way of the second transaction server, from the address information an account identifier is obtained for a payee account managed electronically by the first or another account-management server and
by way of the second transaction server a credit to the payee account is issued to the account-management server of the payee account, by transmission of a second payment-order data set comprising at least the amount information and the account identifier of the payee account.

59. Data-transfer method according to claim 57, characterized in wherein that
the second transaction server is used to obtain from the address information a server address of a second account-management server, by way of which the payee account is managed electronically,
the second transaction server is used to send an inquiry for an account identifier of the payee account to the second account-management server, by communication of the address information of the payee, and
by way of the second account-management server the account identifier of the payee account is obtained and sent to the second transaction server.

60. Data-transfer method according to claim 54, wherein that by way of the first or second transaction server, prior to issuance of the payment and after the payee's account identifier has been obtained, the first or second payment-order data set together with a request for acknowledgment is transmitted to the payers telecommunications terminal, and the payment is issued only in response to the receipt of an acknowledgment signal from the telecommunications terminal of the payer.

61. Data-transfer method according to claim 54, wherein that the first payment-order data set comprises a first currency code and the second payment-order data set comprises a second currency code that differs from the first currency code, and during preparation of the second payment-order data set the amount information in the first payment-order data set is converted on the basis of a previously stored exchange rate into the amount information in the second payment-order data set.

62. Data-transfer method according to claim 61, wherein that the conversion of the amount information is performed in the first or second account-management server by utilizing an exchange rate transmitted from the transaction server of the system operator.

63. Data-transfer method according to claim 61, wherein that the conversion of the amount information by the transaction server is performed on the basis of an exchange rate stored in an associated database.

64. Data-transfer method according to claim 54, wherein that the first and/or second payment-order data set comprises text information related to the payment, which in particular is substantially identical in both payment-order data sets.

65. Data-transfer method according to claim 54, wherein that the data transmission from and to the payers telecommunications terminal for a payment is performed entirely by short message according to SMS, data-file transfer according to WAP, or by way of IVR speech communication.

66. Data-transfer method according to claim 65, wherein that a payment of an amount below a predetermined threshold value is initiated by transmission of a first payment-order data set by SMS without return-acknowledgment data transfer to the telecommunications terminal.

67. Data-transfer method according to claim 54, wherein that by way of the first account-management server the payers authorization is checked and/or by way of the second account-management server the payee's authorization is checked, in each case on the basis of stored user data.

68. Data-transfer method according claim 54, wherein that by way of the first or second transaction server the authorization of the payer and/or payee is checked on the basis of stored user data.

69. Data-transfer method according to claim 54, wherein that the address information of the payee in the first payment-order data set has the form of MSISDN, network address of an IP network, alias or account identifier.

70. Data-transfer method according to claim 54, wherein that for every credit instruction settlement-fee information is generated and added to the second payment-order data set, together with a prespecified identification code to show whether the fee is to be charged to the payer's account or the payee's account or split between them.

71. Data-transfer method according to claim 61, wherein that during the conversion of the amount information in the first payment-order data set to that in the second payment-order data set, the calculation takes into account spread information, which is stored in particular in an associated database of the transaction server or system-management server.

72. Data-transfer arrangement for transmitting information relevant to payment transactions in order to accomplish payment by a payer to a payee, in which there is access to an electronically managed payers account, with at least one telecommunications network, in particular mobile wireless network, to which the payer is connected by way of a telecommunications terminal, a first account-management server to manage the payers account, which can optionally be connected to the telecommunications terminal by way of the telecommunications network, a first transaction server of the operator of the telecommunications network or a service provider, such that the first transaction server can be connected to the telecommunications terminal in particular by way of the telecommunications network, a second account-management server to manage a payee's account, which can be connected directly or indirectly to the first transaction server and can be identical to the first account-management server, wherein the first transaction server is designed to convert a first payment-order data set, which comprises at least one item of amount information and one item of address information of the payee, into a second payment-order data set, which comprises at least the amount information and an account identifier for the payee's account.

73. Data-transfer arrangement for transmitting information relevant to payment transactions in order to accomplish payment by a payer to a payee, in which there is access to an electronically managed payers account, with at least one telecommunications network, in particular mobile wireless network, to which the payer is connected by way of a telecommunications terminal, a first account-management server to manage a payers account, which can optionally be connected to the telecommunications terminal by way of the telecommunications network, a first transaction server of the operator of the telecommunications network or a service provider, such that the first transaction server can be connected to the telecommunications terminal in particular by way of the telecommunications network, a second account-management server to manage a payee's account, which can be connected directly or indirectly to the first transaction server and can be identical to the first account-management server, a second transaction server, which can be connected to the first transaction server and the second account-management server and is designed to convert a first payment-order data set, which comprises at least one item of amount information and one item of address information of the payee, into a second payment-order data set, which comprises at least the amount information and an account identifier for the payee's account.

74. Data-transfer arrangement according to claim 72, comprising a data terminal, by way of which the payer is connected to a data network, in particular the Internet, and that can be connected to the first transaction server.

75. Data-transfer arrangement according to claim 72, wherein that a system-management server with a plurality of first and/or second transaction servers is substantially permanently connected in several telecommunications networks, in particular mobile wireless networks.

76. Data-transfer arrangement according to claim 75, wherein that the system-management server is disposed in a telecommunications network, in particular mobile wireless network, and forms a functional unit with a transaction server.

77. Data-transfer arrangement according to claim 72, wherein that the or at least one account-management server is directly associated with the or a telecommunications network and cooperates with the system-management server and/or with the transaction server to implement a payment, in particular with access to a prepaid balance.

78. Data-transfer arrangement according to claim 72, wherein that the or at least one account-management server is disposed outside the control region of the or each telecommunication network that is internal to the network, and in particular can be connected directly to the payers telecommunications terminal.

79. Data-transfer arrangement according to claim 72, wherein that the system-management server comprises a flow-program memory to store at least one transaction-flow program involved in the data communication between the telecommunications terminal of a payer and the account-management server or the transaction server or transaction servers.

80. Data-transfer arrangement according to claim 72, wherein that with the system-management server there is associated a data-repository system for the storage and management of all valid user data and, in particular, data relevant to payment transactions and identification codes for data transfers that have taken place.
